(19) United States
(12) Patent Application Publication
(10) Pub. No.: US 2008/0201159 A1
(43) Pub. Date: Aug. 21, 2008

(54) System for Automating and Managing an Enterprise IP Environment

(76) Inventors: John J. Gabrick, Pittsburgh, PA (US); Cassius A. Elston, Redmond, WA (US)

Correspondence Address: THE LAW OFFICE OF RICHARD W. JAMES, 25 CHURCHILL ROAD, CHURCHILL, PA, 15235, US

(21) Appl. No.: 11/834,795

(22) Filed: Aug. 7, 2007

Related U.S. Application Data
(62) Division of application No. 09/709,900, filed on Nov. 10, 2000, now abandoned.
Application No. 09/709,900 is a continuation-in-part of application No. 09/687,510, filed on Oct. 12, 2000, now abandoned.
Application No. 09/709,900 is a continuation-in-part of application No. 09/706,513, filed on Nov. 3, 2000, now abandoned.
(60) Provisional application No. 60/159,129, filed on Oct. 12, 1999.
(60) Provisional application No. 60/163,877, filed on Nov. 5, 1999.
(60) Provisional application No. 60/165,140, filed on Nov. 12, 1999.

(51) Int. Cl. G06Q 10/00; G06F 17/30

(52) U.S. Cl. 705/1; 707/104.1; 707/E17.009

(57) ABSTRACT

A system and method for tracking an innovation. The system and method determine one or more actions requested by a user with respect to stored information associated with the innovation, determine an identification of the user, and log the one or more actions and the identification of the user.

This application is a division of U.S. patent application Ser. No. 09/709,900, filed Nov. 10, 2000. U.S. patent application Ser. No. 09/709,900 is a continuation-in-part of U.S. patent application Ser. No. 09/687,510, filed Oct. 12, 2000, which claimed priority to U.S. Provisional Patent Application Ser. No. 60/159,129 filed Oct. 12, 1999; a continuation-in-part of U.S. patent application Ser. No. 09/706,513 filed Nov. 3, 2000, which claimed priority to U.S. Provisional Patent Application Ser. No. 60/163,877 filed Nov. 5, 1999; and also claims priority to U.S. Provisional Patent Application Ser. No. 60/165,140 filed Nov. 12, 1999.

### TECHNICAL FIELD

The invention relates to knowledge management systems; more particularly it relates to systems for automating and managing an enterprise IP environment, with global communications network capabilities.

### BACKGROUND OF THE INVENTION

The significance of intellectual property (IP) is growing daily. More and more, corporations realize the importance of preserving and protecting these vital assets, and a select few even appreciate how to capitalize on them. However, the real underlying issue that has not been addressed, up until now, is that in today's digital enterprise there is a tremendous need for a reliable, real-time system for creating, preserving and building value from corporate IP assets. This model must be in synch with today's digital world and enterprise environment and operate on a continuous, real time basis. It must work transparently with the way in which employees work and innovate. It must be a useful productivity tool for IP attorneys and corporate counselors. And it must safeguard and protect the most valuable assets a company owns, its intellectual capital.

Many companies are only recently recognizing the rise in significance of IP as a core asset. However, even with heightened awareness, most continue to operate in antiquated ways, relying on “defensive mechanisms,” such as legalistic paperwork and cumbersome procedures. These techniques are expensive, time-intensive, and inadequately suited for today's digital environment, since they fail to operate in real time.

Today, very few companies use the potential of information technology to streamline processes, promote new innovation, and document and protect their assets. Often, their employees at just about every level are undereducated and unaware of the risks of inadvertent disclosure or competitive loss—setting the stage for future disputes and often leading to litigation, or even worse, the permanent loss of valuable trade secrets.

Most significantly, virtually all corporations underestimate the strategic value of their IP, and therefore, fail to capitalize on the full potential of it. And even while recognizing the growing significance of IP assets, there are essentially no companies that do an effective job at providing the Knowledge-Connectivity™ and incentive for new innovations.

In today's job market, employees are more mobile than ever before. Mergers, acquisitions, and downsizing are just a few of the reasons. The result is a constantly changing workforce, and the constant creation, disclosure, and turnover of corporate intellectual property. And whereas it is perfectly legal for a highly skilled employee to leave and go to work with a competitor, taking with him or her his own skills and experience, it is not lawful to leave with proprietary company information.

These trends of higher worker mobility and the increasing value of digital assets have converged to create a tremendous opportunity for a new solution. Companies certainly want to avoid additional litigation nightmares, when even a single trade secret dispute or patent infringement suit can cost well over $1 million in legal fees. Douglas Brotz, principle scientist at Adobe Systems, commenting on a patent infringement suit described how it had cost the company more than $4.5 million in legal fees and expenses alone, not to mention over 3,500 hours of his time—the equivalent of two, full years of working time. Most remarkably, this was a case that Adobe had won, initially and on appeal. Clearly, an effective means for mitigating the risk of a costly lawsuit would be of great benefit to many leading technology companies.

For the most part, individual employees don't want or intend to break trade secret laws, steal proprietary assets or misappropriate secret files. They just want to pursue the opportunities afforded to them in the free marketplace. In many cases, the core issue, the one that becomes highly volatile, is that it is nearly impossible to discern between company IP assets and individual skills and knowledge. Coupled with the fact that companies do a very poor job of identifying their IP assets in the first place—62% of companies have no procedures for reporting information loss. This tension becomes the catalyst for another wasteful lawsuit, pitting the company against ex-employee. The company, quite self-righteously, stakes a claim to a broad range of trade secrets; and the employee, defends by pleading that the information is in the public domain, or part of his general skills and knowledge. Just recently, in another high profile suit that illustrates this growing problem, Motorola, Inc. sued Intel for hiring away a number of its key employees. An Intel spokesperson said the action was taken solely to protect Motorola's intellectual property, which it characterized as its “lifeblood.”

As a further example of the seriousness of this issue, in 1998 the American Society for Industrial Security (ASIS) reported that IP losses for U.S. companies might exceed $250 billion annually. Furthermore, five times more companies feel the issue of intellectual property loss is increasing. With the nation's competitiveness riding on our ability to maintain technological superiority, losing trade secrets can be devastating. What makes matters worse is that most companies don't know, nor have they taken action to find out what their specific trade secrets are, and whether or not they are legally protected. This only adds to the potential of a future lawsuit, since only a lengthy hearing of the facts can ultimately determine the “right and wrong.”

Slow, expensive and outmoded legal precautions, and time-consuming audits are not the answer in this day and age of rapid product development. To keep their competitive edge, and to promote innovation and capitalize on knowledge assets, there is a need for a new solution—an innovative way of managing IP property.

In the past, intellectual property was not as pressing an issue as it has now become. The connection between an idea and the creation of wealth was less direct, and the road from the one to the other was traveled at a more leisurely pace. By contrast, in today's information-intensive economy, that connection is immediate and intense. Knowledge is now the driving force behind innovation and the creation of new wealth.

Within many of today's companies, innovation fuels high market caps, not tangible assets as in the past. The trends of higher worker mobility and widespread litigation, coupled with the increasing value of digital assets have converged to create a tremendous opportunity for a new solution.

### Need for an Innovation Management System

The preponderance of adjectives such as “monitoring,” “protection,” “litigation,” and “security” immediately conjures up images of “Big Brother.” And while proper oversight cannot and should not be ignored, this functionality in and of itself fails to address an even more important issue: How effectively do companies promote innovation? After all, if you accept the fact that IP is becoming more and more critical, then shouldn't companies treat it like their corporate lives depend upon it?

Most companies do very little to tap into the vast resources of knowledge that exist inside their own organizations. One Fortune 100 Company offers a $100 dinner-for-two award for new ideas submitted by email to the corporate counselor. That's not much of an incentive, when you consider the other options available to today's employees, especially those with an entrepreneurial drive, and the ready supply of venture capital that exists.

Many of these companies rely on a perceived underlying expectation that their employees will automatically produce new innovations, as if obligated merely by the fact that they receive a paycheck and benefits. And most companies employ legal covenants that dictate the assignment of new ideas to the company, if developed on company time, with company resources, or which relate to the company's business. That mind set may have worked a generation ago, but it doesn't meet today's needs, or work for today's dynamic job market. After all, who gets to decide where one idea starts and ends? Who owns an idea that may not have been reduced to practice by the employee while he worked for the company? Ownership issues can destroy the potential of a new concept before it gets off the blocks.

It just does not appear that legal pressure is the best way to promote the creation of new ideas. Nor does it appear that employees, particularly the most savvy ones, will naively turn over their best and brightest ideas without some reasonable incentive or recognition, especially as they become more aware of the potential value. Considering that the ideas that gave birth to over 70% of the country's 100 fastest growing companies came from previous employment, it is easy to appreciate the significance of this issue. Today, most companies fail to recognize this, and consequently, they wonder why some of their best talent leaves to pursue other opportunities—including business ideas that they originated while working for their previous employer.

A recent survey published in the Harvard Business Review reported that “71% of entrepreneurs responsible for starting the country's 100 fastest growing companies developed their ideas through their former employment—either by recognizing an opportunity that the former employer didn't appreciate or even know about, or by improving upon some aspect of the company's products or services.”

Overall, the existing corporate infrastructure and antiquated operating methods are poorly designed to deal with today's climate. In this fiercely competitive world just providing a job doesn't do nearly enough to promote innovation—the ultimate goal for progressive companies. What is needed is an Innovation Management System.

### Existing Technology in the Knowledge Management Field

The Knowledge Management industry is quickly consuming the myriad fragmented and disparate niche industries that have evolved over the past two decades, including document management, search and retrieval, repositories, object technology, workflow, and most recently the intranet. According to Delphi Consulting Group, buying trends for IT will revolve around this central theme for the next decade.

The most significant aspect of this industry is the growing awareness of the increasing amount of useless data—in other words, no information—in a typical company. Strategically, companies are realizing that knowledge is the key driving force in the next decade, and systems which help manage documents, search, and aid collaboration are desperately needed. In a recent survey, nearly half (43%) of the survey population regarded knowledge management as an opportunity to add value to information inside and outside the organization. But nearly as many respondents (37%) viewed knowledge management in a very different light—as a “major new strategic initiative for staying competitive.” Overall, 80% view knowledge management as providing an important contribution to business practice, and 46% of that group views knowledge management as strategic. This same group was asked the primary repositories of corporate knowledge and the biggest obstacles to creating knowledge-based organizations; the results are shown in the charts in FIG. 1.

The data however clearly show that while employees are the primary sources of information in the company, all of the current solutions have focused on the remaining items: paper documents, electronic documents, and databases.

The data also reveals that the biggest obstacle is culture. The current business climate simply does not address the needs and wants of the typical knowledge “gold-collar” worker. These employees typically don't trust the “system.” Highly skilled workers know they can leave the corporate environment and get better returns, higher salaries, stock options, and greater opportunities than by simply handing over important innovations. Employees are even heard to say “why should I give ABC company my ideas, I'm going to start my own company.”

Accounting and valuation begin with documentation. A company with an expensive piece of capital equipment is sure to be aware of it. But most companies have valuable intellectual capital that they do not fully recognize. Many technology companies, for example, with dozens, hundreds or thousands of patents do not have a coherent catalogue of their patents, let alone an analysis of how their patents might be useful and how they might be exploited for economic and competitive gain.

These trends don't just apply to a limited number of high technology companies. Even companies not directly involved in high tech must realize that a substantial portion of their overall assets relate to intellectual property or capital. For instance, a small manufacturer may possess unique mechanical know-how, process knowledge, or techniques that create competitive space. Service companies use proprietary calculations and customer lists to their advantage. The implications of managing IP reach just about every industry classification and category.

The following needs can be identified among companies that produce IP. They need to organize intellectual property so that it can be quickly retrieved, filtered, and sorted by multiple criteria; they need to create an environment conducive to innovation by inspiring IP creation, sharing IP across the corporation, and promoting the intellectual output of individuals within the firm; they need to increase the value of corporate IP assets; they need to slow employee turnover and keep key employees from moving outside the company to start new enterprises; they need to communicate to employees, joint venture partners, and others that it is serious about protecting it's IP, and want to be sure that these same people have acknowledged this; and they need efficient and centralized access to disparate IP-related information, such as legal contracts, signed documents, IP, and usage patterns for making decisions about departing personnel, potential patent infringement, or partnership negotiations.

A brief look at the trade secret laws in the context of a buyer of IP assets provides further illustration of the need for an Innovation Management System. Today, there is no effective way for companies to accomplish this level of analysis, cost-effectively and efficiently.

### Previous Attempts to Meet Customer Needs

### Patent/IP Software

This category focuses on IP products. In general, the products are complex, patent-centric databases that best serve companies with large and extensive patent and trademark portfolios, and who are very serious about the strategic management of their patents. Many of the systems also include other software modules such as PTO filing, law case management, docket generation, and billing. They either target corporations, law firms, or patent practitioners. This niche has been fairly small, so most companies range in size from 60 to about 250 employees and have deployed in the neighborhood of 100's of customers. Prices range from $5,000 to $30,000 not including customization or installation. Examples in this category include Aurigin's IP Asset Management System, Computer Package's Patent and Trademark Management System, Master Data Center's PC Master, Maxim Technology's InProma, and OP Solution's PATTSY.

### ERP/Knowledge Management Software

Almost every software company in existence today can claim some share of the Knowledge Management marketplace. This category of competitors is so numerous it's difficult to find any clear distinguishing differences between them. Most of the products are “enhanced” tools such as database searching, document management, groupware, and personal web page publishing. A recent KM publication listed 36 different software groups as part of the KM marketplace, including Application Development Products, Business & Competitive Intelligence, CAD, CD-related technologies, Collaborative & Work Management, Compound Document Management Software, Data Mining, Data Warehousing, Database Management Systems, Document Conferencing, Document Design/Publishing, Document Management Software, DVD-related technologies, Electronic Commerce, Engineering Document Management Systems, ERP Systems, Forms Processing, Groupware, Image Compression, Image Manipulation, Image Processing, Imaging Application Systems, Input Capture Systems, Intellectual Asset Management, Internet/Intranet Development, Knowledge Management Software/Tools, Micrographics, Multimedia Systems Software, Networking Systems Software, OCR/ICR/OMR Bar coding, On-Demand Print Systems, Portable Document Viewing, Records Retention/Archiving, Storage Management Systems, Text Retrieval & Management Software, and Workflow.

Clearly, this list contains everything imaginable related to documents and is a highly fragmented conglomeration of companies.

### Knowledge Management Consulting

Since this is a complex concept to understand, it is a sure bet that every consulting firm that can claim any relevant expertise is involved. Arthur Andersen seems to be leading the pack in this area by performing IP audits, analyzing workflow processes, and then installing document management and groupware solutions. Most of the consulting firms are focusing on a holistic, and we believe overly broad, approach by examining all aspects of the organization's knowledge base: systems, processes, departments, and technologies. Their angle is that by correctly leveraging knowledge, a company can improve productivity, customer service, quality, speed to market, and other performance improvements. By helping organizations improve how they create, capture, share and apply the knowledge that exists within the company, they can more fully capitalize on it. Web-Based solutions

At present this category only contains one competitor, yet2.com. It appears to be focused on using the Internet as a business-to-business tool targeted at the license of IP for large corporations. Yet2.com has moved quickly to create associations with several premier companies, although the details of these relationships are unknown at this time.

### DISCLOSURE OF THE INVENTION

A three-tiered, scalable, web-based architecture (“the system”) is disclosed to dynamically and cost-effectively promote innovation, foster learning, encourage preservation, and allow the management and maximization of corporate IP assets; a solution for automating and managing the modern-day enterprise IP environment. This system works efficiently within the legal parameters of any company environment, regardless of industry, and works in cooperation with In-house Counsel. With real-time access to key information, IP Counsel can focus on higher level, strategic issues, and not mundane documentation tasks.

A reliable, real-time system for creating, preserving and building value from corporate IP assets is disclosed. The system is in synch with today's digital world and enterprise environment and operates on a continuous, real time basis. It works transparently with the way in which employees work and innovate, it is a useful productivity tool for IP attorneys and corporate counselors, and it safeguards and protects the most valuable assets a company owns, its intellectual capital. It uses the potential of information technology to streamline processes, promote new innovation, and document and protect a company's assets. It does a very effective job of providing the Knowledge-connectivity™ and incentive for new innovations.

The system meets all of the needs identified above. Using the system, companies can organize intellectual property so that it can be quickly retrieved, filtered, and sorted by multiple criteria; create an environment conducive to innovation by inspiring IP creation, sharing IP across the corporation, and promoting the intellectual output of individuals within the firm; increase the value of corporate IP assets; slow employee turnover and motivate key employees from moving outside the company to start new enterprises; communicate to employees, joint venture partners, and others that they are serious about protecting their IP, with assurance that these same people have acknowledged this serious view; and achieve efficient and centralized access to disparate IP-related information, such as legal contracts, signed documents, IP, and usage patterns for making decisions about departing personnel, potential patent infringement, or partnership negotiations. With the system companies can accomplish a cost effective and efficient level of analysis as to their trade secrets or any other IP assets.

The System also delivers three key benefits: Value Creation, Awareness, and Accountability.

### Value Creation

One of the goals of the system is to inspire and promote new innovation within corporations. We don't believe that the innovation process is optimized for either companies or employees. Our systems help to foster an environment where creativity is recognized and rewarded in direct alignment with the goals of the company. A company that recognizes the contributions of its employees will certainly create a more stable employment environment—and attract talented people—sharpen its competitive edge, and ultimately become more successful. The system employs system-level tools that inspire the creation and sharing of new ideas and knowledge, which ultimately contributes to the increased valuation of any company.

### Awareness

By making employees more aware and sensitive to the treatment of proprietary information, companies will be better protected from the risk of detrimental loss. Most employers do not realize that the two greatest risks to IP are employees stealing secrets or divulging secrets at a future job. Employees need to recognize the significance of a company's IP assets and understand their responsibility for preserving them. Even a single unprotected disclosure can mean the permanent loss of a valuable trade secret. The system increases the threshold of awareness in a company's working environment, and at the same time demonstrates the company's proactive concern for safeguarding its valuable assets.

### Accountability

Among all the assets that a business owns, its IP may be the most important and valuable. To substantiate this, the Brookings Institution in Washington surveyed U.S. manufacturers in 1982 and determined that physical assets such as factories, property, and equipment made up 62% of the companies' total market value, with the rest of the value represented by proprietary knowledge. Ten years later, the researchers determined that physical assets accounted for only 38%, with the remainder consisting of the firms' intangible knowledge assets.

Xerox actually invented the Windows concept of computer software perhaps two decades ago, long before Apple and Microsoft locked in their currently well-known legal dispute. But for all of its size and resources, Xerox failed to seek a patent and never gained a foothold in the market Apple eventually dominated.

A sustainable competitive advantage depends on how effectively a company can manage, protect and exploit IP-corporate survival depends on it. The last thing that a company needs is for lax oversight to put these assets at risk. Corporate leaders have a baseline responsibility to preserve corporate assets and work to capitalize on them. The System provides the information that a company needs to ensure that it is responsibly doing its very best to preserve assets, answering such questions as, “What specific trade secrets exist in the business today? Are they being properly and consistently maintained? Who has direct access to them?”

### User/System Benefits

Discussed below are departments and individuals within the typical corporate environment who will benefit from using the System. For each example, the user's needs and the ultimate system benefits are shown.

Marketing needs to be able to determine competitive strengths and weaknesses, new areas of market growth. The System automatically summarizes company innovations. The System performs detailed searches on the Internet to find competing or encroaching ideas; reports are available which list potential competitive strengths or weaknesses. These searches are performed automatically and routinely using intelligent agents, giving market analysts a jump-start on which areas to investigate.

Executive Management needs to get an accurate picture of the level of innovation in the company. Are employees building corporate value? Are we recognizing our key contributors? Are we properly protecting and preserving our assets? The System produces graphic presentations and detailed reporting of the number of innovations per month, year, or quarter give senior managers a firm understanding of their level of innovation. Further stratification of the data by department or job function can help develop future strategic direction. Summary reports display access to protected information by class, type, date, user, etc. Management can quickly assess the level of protection, and if needed, can globally change security levels to reflect changing environments.

Corporate IP has to have a “handle” on the specific IP being created; it owns responsibility for oversight. What is being created, what is its value, who is creating it, what means of protection should be employed? The system creates an instant snapshot of the current state of all IP in the company. It's like getting an instantaneous IP audit at the touch of a button.

Technical Employee wants recognition for new ideas and innovations. Innovation Management System™ allows the user to “certify” the idea with immediate supervisor, corporate IP, and posting for company-wide viewing on the corporate intranet. Corporate IP has to have a “handle” on the specific IP being created-owns responsibility for oversight. What is being created, what is its value, who is creating it, what means of protection should be employed? The system creates an instant snapshot of the current state of all IP in the company. It's like getting an instantaneous IP audit at the touch of a button.

Human Resources needs to inform departing employees that they have an on-going obligation to keep corporate trade secrets and intellectual property confidential. By allowing instant access to the usage pattern for any individual who has viewed corporate secrets, HR can quickly generate and show departing employees a listing of all confidential materials accessed and printed. Furthermore, HR can quickly print out scanned images of the departing employee's signed confidentiality agreements, non-disclosure statements, and policy acknowledgments.

Human Resources also needs to provide more meaningful data to the employee review process. In addition to all of the usual employee review data, HR can query the System and determine all of the ideas that an individual has submitted over the past year. How can the productivity of a “business development manager” be measured without it?

Finance wants to know, “What is the value of the company's goodwill?” It needs to try to determine the costs of a new product launch, the total corporate value of IP or trade secrets. Because idea submitters enter hours spent, along with other resources that contributed to the innovation, assets can be assigned tangible values and tracked on the company's balance sheet.

The System streamlines the process of creating, preserving and protecting proprietary assets. The System identifies, classifies, compiles, tracks and routes real-time data automatically on a continuous basis. It provides instant access to stored database information, such as trade secret archives, patent filings, computed valuations, user information and a variety of detailed reports. A client has instant access to their latest innovations and proprietary materials, and constant supervision over them. They know precisely the status of their property, and can quickly view summary reports and valuation data. This information is extremely beneficial in linking IP to the company's strategic objectives. See FIG. 2.

The System is highly configurable and creates a wide range of user-selectable classifications of assets, allowing the system to be customized in alignment with individual business needs. For example, a software development company can selectively designate individual network folders as “CLASS 1” Trade Secrets. A number of parameters can be associated with this CLASS 1 status or mode. In this scenario, CLASS 1 provides the ultimate level of protection. Every access to these trade secrets will be monitored and logged by the System. If necessary, and depending on the protective features enabled, every user action such as viewing, printing, copying, and modifying can be transparently logged and sent to the main Server. See FIG. 5.

You instantly know who has accessed your key IP files, and who has downloaded them, viewed or copied them. This level of data acquisition can be invaluable in the case of employee ownership disputes, determining level of disclosure, or commercial licensing negotiations. And even more importantly, all of this data is essential to proving that your company took the necessary preventative precautions to protect the secrecy of your trade secrets—invaluable in the face of future litigation.

### Innovation Management System

As stated earlier, the existing corporate infrastructure and antiquated operating methods are poorly designed to deal with today's climate. The Innovation Management System™ is needed.

An Innovation Management System (IMS) is disclosed. This preferably web-based GUI encourages innovation, providing valuable benefits to both employees and employers. It allows employees to enter their intellectual creations (documents, ideas, schematics, etc.) and receive an immediate, time/date certification. In many instances, one of the greatest reservations employees have against providing ideas to upper management or other departments is the lack of control, authorship, and credit they associate with typical corporate environments. At one time or another, we have all been victims of intellectual theft—perhaps a design sketch given to your boss concerning a product improvement that appears months later in a corporate document without your name on it. In addition to certification and registration, the system can provide automatic e-mail notifications to an immediate supervisor and the corporate IP department (all configurable), as well as entry and logging into the company-wide recognition database. Others in your company, with appropriate privilege levels, can search (by key words, project descriptions, PTO classifications, author, date, etc.) and instantly access archived innovations, increasing the level of inter-company collaboration. The company can create more effective incentives and “innovation awards” tightly coupled to strategic goals.

Users of the IMS can link to more details on each submission, email comments and suggestions directly to the author (for improved collaboration and knowledge management), or even submit their own improvements as a new or supplemental innovation. See FIG. 13.

The IMS database becomes an efficient tool for HR departments, and can be used for evaluating employee performance, measuring overall corporate innovation levels, and identifying qualified and motivated employees to join a special R&D team.

The Corporate Legal Department will benefit because the IMS provides extensive documentation in a wide-range of beneficial areas. For instance, IP Counsel can monitor for new patentable ideas in real time, since they are directly linked into the system. This efficiency can reduce the time necessary to prepare and prosecute new patents. It also frees up Patent Attorneys to higher-level activities, instead of mundane data collection work. The IMS will enable attorneys to provide improved oversight for new trade secrets before they are lost through inadvertent disclosure. The system archives the documentation trail from the outset, invaluable for assignment issues and establishing firm priority dates.

### IMS Web Site

The IMS also provides an interface to the external Internet (optional and configurable). Ideas and submissions can be published and linked to an external (i.e. MindMatters.com) web site. The site serves as an innovation access link to companies all over the world. It is possible for interested buyers and sellers to initiate exploratory communications via embedded links, as well as conduct negotiations on available licensable technologies. There is an appropriate legal framework to streamline the exchange of information for the site, assuming that at a certain level, the materials may contain proprietary information.

The site also provides an optimum way for companies to initially view “unsolicited ideas” without the threat of legal reprisal or the burden of lengthy, internal approval processes. Today, many companies are extremely cautious about looking at unsolicited ideas, even potentially valuable ones, because of the potential threat of future litigation. There have been a multitude of cases in recent years involving the purported misappropriation of inventions and ideas resulting from even casual discussions. In response, many companies have established cumbersome, paper-intensive procedures to deal with unsolicited ideas. Some have prohibited them altogether. Needless to say, this constricts the flow of innovation. The site solves this problem as well by building in a protective legal barrier and managing the information exchange. The site acts as a safe and efficient conduit between the parties.

The IMS identifies innovations by key words, categories, PTO Classifications, dates, industries (SIC Codes), and identification/tracking numbers. Interested parties search the web site for innovations applicable to their own businesses or use “search agents” which automatically notify them if something meets their criteria. If they find ideas that merit further investigation, clicking on an e-mail link automatically connects them to the author or representative. By aggregating innovations at the web site, we are actively promoting innovation and knowledge sharing on a broader scale, while simultaneously building a meaningful intellectual property resource. This site becomes the first link in establishing meaningful relationships for future licensing and royalty agreements. See FIG. 3.

A nominal fee is charged for creating the direct link between subscribers and new ideas. When a subscriber chooses to contact the source of the innovation, i.e., by email, a different small fee will be charged. This fee may be negligible in the early stages, in an attempt to drive usage and minimize nuisance requests (such as $0.33). A membership subscription is also contemplated. Other interaction, including submitting ideas, searching for ideas, or configuring “search agents” are free of charge.

### Simple Installation

Today's MIS manager has less time than ever to fiddle with finicky programs or configure endless mazes of menus. The system is designed to plug quickly into the network and instantly begin collecting information in its basic configuration. The system simply needs to have an IP (xxx.xxx.xxx.xxx Internet Protocol) address for the network, and a physical connection to the network. IT managers can remotely configure the system via a web interface, and independent systems can be hierarchically managed, along with reporting, back to a central monitor. Communication takes places in encrypted channels. Installation of web components is even simpler as the applications/date are easily installed into an existing web server.

The system is a scalable, modular system that can be implemented incrementally over time. Network solutions are implemented and designed around standard Microsoft DNA components.

Improvements over Existing Knowledge Management Technology

An important benchmark industry to compare disclosed products and services with is the field of Knowledge Management. As stated above, there is growing awareness of the increasing amount of useless data—in other words, no information—in a typical company.

Increasing the value of corporate information is important; however, rather than just designing tools to plod through piles of data, the system is an accounting framework that values (using legal standards as a model), helps protect, and most importantly creates information. But where the Knowledge Management industry has focused on only paper documents, electronic documents, and databases, not employees. The system focuses on all four elements, realizing that employees are the most critical, through the Innovation Management System (IMS). IMS makes itself the employee's “best friend,” as this is the key starting point in the innovation process. If employees trust and use the IMS to help them accomplish their personal goals (while simultaneously satisfying the corporate goals), then the flow of new innovations will be substantial.

The data also reveals that the biggest obstacle is culture. The system addresses the needs and wants of the typical knowledge “gold-collar” worker. The IMS overcomes the cultural disinclination of such workers by allowing innovators to share in the glory and financial success of their ideas. The System will also set the bar for what is required for companies to prove that they did in fact take reasonable measures to protect their assets.

The system is designed to provide an appropriate interface to previous systems that attempt to meet customer needs, such as patent/IP software, and knowledge management software.

The disclosed system is a comprehensive, supervisory system that functions seamlessly on top of existing architectures, and which efficiently monitors and promotes innovation. Innovation is the core focus. The system is unique in that it is designed from the bottom up to be extremely easy to install and integrate with existing systems. Administrators will be able to install it incrementally in a modular fashion, as the needs and demands of the system grow over time. IP and Innovation managers will be able to progressively configure the system for customized applications, producing additional revenue streams from added licenses and services.

The disclosed system is superior to existing knowledge management consulting approaches, with or without Web enablement, at least in the critical area of IP tracking and management. The innovation content that a company provides under the disclosed system offers a much more compelling site to its users, both company users and the internet population. For example the system includes not only a web-trading interface, but also a mechanism for capturing innovation directly from the sources, transferring it through the organization, and protecting it from inadvertent loss. One of the key factors for success will be making it easy for participants in the web experience to upload information on a continuous basis. This keeps the information fresh and frees corporations from the laborious task of entering data repeatedly.

It is a further objective of the Enterprise Innovation Management System (EIMS) to provide a system that promotes and tracks innovations, fosters learning about intellectual assets, encourages preservation of intellectual assets, and monitors and tracks these assets from inception through analysis/ranking and licensing until the asset is retired or completely depreciated. A global environmental model for the EIMS is presented

The term “Innovation” is used to represent any contribution by an individual or team that seeks to positively enhance some product/process/system within an organization. The term “Idea” is sometimes used interchangeably with Innovation.

The EIMS (or System) consists of four independent applications that function together in an enterprise-wide solution. Together the System streamlines the process of fostering idea creation, educating and rewarding employees who create valuable intellectual property (IP), analyzing and prioritizing IP according to company-defined rating factors, sharing information both externally (if desired) and internally to facilitate licensing and increased productivity, and preserving and protecting proprietary assets. See FIG. 33.

### A. Innovation Management System™

The EIMS is a web-based GUI that encourages innovation, providing valuable benefits to both employees and employers. It allows employees to enter their intellectual creations (documents, ideas, schematics, etc.) and receive an immediate, time/date certification to discourage “borrowing” by unethical employees. In addition to certification and registration, the System can provide automatic e-mail notifications to an immediate supervisor and the corporate IP department (all configurable), as well as entry and logging into the company-wide intranet. Others in a user company, with appropriate privilege levels, can search (by key words, project descriptions, PTO classifications, author, date, etc.) and instantly access archived innovations, increasing the level of inter-company collaboration. The company can create more effective incentives and “innovation awards” tightly coupled to strategic goals.

### B. Analysis/Ranking Module

This set of tools allows peer groups, IP counsel, or other trusted sources to rank and prioritize innovations that are entered (either through the Innovator or manually) into the system. The power of these tools is highlighted in their ability to quantify both objective and subjective measurement criteria. The rankings are aggregated and weighed relative to the company's strategic objectives, that is, a company can decide that financial factors such as development expense or ROI are more/less important than customer-relationship factors such as new product introductions or quality. Once ranked, innovations can then be compared against each other and scientific judgments can be made regarding level of investment.

### C. Licensing Web Site & Intra-Organization Sharing

The System also provides an interface to both the corporate intranet and/or external Internet (optional and configurable). Tools provided through this application allow the company to quickly publish innovations that the company either does not want or would like to co-license to other companies. In addition, ideas and submissions can be published and linked to the MMT web site. The MMT site serves as an innovation access link to companies all over the world. There are numerous benefits, including the potential to create licensing agreements, streamline product development, find strategic partners, etc. MMT also explores full scale licensing opportunities, i.e., business-to-business eCommerce, via the website. It is possible for interested buyers and sellers to initiate exploratory communications via embedded links, as well as conduct negotiations on available licensable technologies. MMT creates the appropriate legal framework to streamline the exchange of information, assuming that at a certain level, the materials may contain proprietary information.

### D. Network Monitoring & Protection System (NMPS)

NMPS identifies, classifies, compiles, tracks and routes real-time data automatically on a continuous basis. It provides instant access to stored database information, such as trade secret archives, patent filings, computed valuations, user information and a variety of detailed reports. A client has instant access to their latest innovations and proprietary materials, and constant supervision over them as the monitoring process can start as soon as the ideas are submitted into the System through the Innovator. They know precisely the status of their property, and can quickly view summary reports and valuation data. This information is extremely beneficial in linking IP to the company's strategic objectives.

You instantly know who has accessed your key IP files, and who has downloaded them, viewed or copied them. This level of data acquisition can be invaluable in the case of employee ownership disputes, determining level of disclosure, or commercial licensing negotiations. And even more importantly, all of this data is essential to proving that your company took the necessary preventative precautions to protect the secrecy of your trade secrets-invaluable in the face of future litigation.

### Scope

The EIMS preferably has external interfaces to other third-party software and services. These may include any of the following:

Independent Market Makers: These are services/companies that take finished, licensable intellectual property, i.e., software for license, patents, technologies, and make them available to either general or specific groups of potential customers. They require detailed information about the property for sale and provide leads from interested parties to the EIMS.

Time/Date Authority: This service provides a legal time and date stamp for submitted intellectual property. The certificate is capable of withstanding legal scrutiny and is stored with the idea's descriptive information in the EIMS.

Marketing Leads Databases: Based on the potential applications of the property and the technologies employed, these services provide qualified leads for marketing back into the EIMS. Many of these services are based on industry segments.

Independent Search Agents: This service is composed of two different components: MMT services and independent services. The MMT services provides specific competitive information to MMT users based on search criteria for a particular idea. Independent services scan the Internet or other proprietary databases for relevant information. In both cases, the EIMS sends search criteria, verifies access and then returns results back to the user for review.

Docket System: This is an interface to a docket management system for patents, trademarks, copyrights and other property. Once an idea is determined to be patentable, the docket system handles all of the legal, date, and filing requirements. The EIMS sends the packet of information to the docket system and the docket system communicates with the EIMS via status reports. These status reports are available to be shown to the users.

Third Party Analysis Reviewer: This is an interface to a trusted third-party for the purposes of soliciting feedback on a particular idea. The reviewer has basic information about the idea and provides feedback in the areas designated by the EIMS. The EIMS verifies that the information came from the correct source and then collects and aggregates the data. See FIG. 34.

An apparatus is disclosed for registering access to data (paper, electronic, formulae, etc) recorded on storage media as a means to determine history of use whereby a Client/User requests data from a server, the server wraps it with a protection agent and sends it to a Client/User. The protection agent is attached to the specific data (paper, electronic, formulae, etc.) which determines the degree of use allowed by user (reading, deleting, modifying, printing, etc), and is based on type of data, file type, date/time, location, etc., and also on user level, group, etc., and optionally on pre-determined method for establishing rules used to register access to data recorded on storage media. The server records access to the data, and managers get reports that detail accesses to the data.

An apparatus is disclosed for registering access to data (paper, electronic, formulae, etc) recorded on storage media as a means to determine history of use where registration means the recording of file block system read/writes/updates, recording file name read/writes/updates, or the recording of physical data segment read/writes/updates.

An apparatus is disclosed for wrapping designated trade secret(s) with rules for access into an binary form executable only by the intended recipient(s).

A method is disclosed for determining the relative protection level of an entity's intellectual property (trade secrets, patents, trademarks, copyrights) using Spider graph and associated questions, etc. A method of pair-wise comparison is used for determining relative priority of key factors (accountability, awareness, secrecy, and security), and also using benchmark comparisons against the data entity.

An intelligent IP Accumulator/Agent Monitoring System is disclosed having methodology for searching, finding, identifying, wrapping, safeguarding, classifying/declassifying, shredding and deleting, and encrypting potential IP assets on a continuous, real time basis. This system charts IP assets from origination onward. Other embodiments disclosed are:

Auto-protect Assets: Methods for automatically generating an appropriate class of confidentiality marking/wrapper based on preset configuration parameters. Self-generate internal icon set to coincide with protection level. S/W agents that auto-report and track key assets.

MMT System-level functionality: Defines specifically what data is considered secret; the relative class of the secrets; the software protection methods utilized to actively protect (i.e. encryption), and the imputed value of creating the secrets (based upon accumulated man-hours, market studies, projected earnings, etc.)

IP Event Trigger: Based upon preset parameters, the system automatically monitors for specific behavior on the network that indicates a possible IP event. Ex: large data transfers or downloads. Increase in access rates of identified TS's. Extensive access beyond/outside pertinent class. Time-based events: employee departures; audits, etc.

IP Database: Methodology for collecting specific IP data on a unique server, updated periodically or continuously based upon preset parameters; with the capability to request status inputs from individual IP wrappers or objects.

IP Audit/Due Diligence: Computer methodology for triggering an instantaneous IP audit-dynamic update on all priority IP assets. Accumulate most current asset information, usage, risk exposure, licensing status, etc. (Departing employee situation). Generate reports based on access, usage, class, employee, type, etc.

IP Incentive: Automated methodology for promoting and tracking innovation based upon pre-selected configuration parameters. (See IMS)

IP Access: Methodology for tracking the usage/distribution of IP assets. Relate to risk exposure and safeguarding proprietary information policies. Auto-generate warnings prior to use of trade secrets.

In addition the following are also claimed:

An online registration ‘engine’ for ideas, innovations where the engine comprises one or more computer terminals with access to a storage device and connected to at least on other terminal by a networking protocol, either Internet TCP/IP or local or wide area network. The engine also comprises a database resident on the storage device with software operable to receive into the database details of the idea and details identifying the submitting user, and creating a relationship therebetween that together comprise the registration. A certified time stamp is optionally applied to the registration. The idea registration is then made available, according to selectable permissions and rules, to selected other users on the network.

Optionally, the same or different storage device accommodates a database for documents relating to the registered ideas etc (where documents can be anything stored electronically and/or digitally), and the database is the same as the idea registration database or is a different but operably connected database that provides an associative, recallable, and searchable relationship between the registration and any document that refers to it or is developed from it.

Optionally, a tracking engine is provided for the docs to track them and record access to them and improvements to them and derivatives from them, the engine also recording such ‘set’ relationships among the various docs as may be generated by common denominators such as identity of author or other major contributor, same or similar or related idea, keywords, and the like.

Also provided is an intelligent means to drive routing of docs and ideas to colleagues, selected peers, and selected or selectably automatically identified experts in the same area as the idea, for evaluation and/or analysis of docs and their ideas and for possible mutual collaboration. Optional automatic valuation and business prioritization of ideas is contemplated as well.

Optionally, means is provided by which parties made aware of the idea and or docs and any resource needs expressly contained therein may respond with commitments toward meeting all or part of the expressed resource needs, optionally joining in the enterprise which is the furtherance of the idea.

As an alternate and further disclosure the following is provided:

A system for web based development and exploitation of IP, with an innovator attraction module, a developer attraction module, a registration module, and a match module is disclosed. The registration module is adapted to accept and store dated related to an innovator and the innovator's innovation in an innovation database, and the match module is adapted to match a registered innovation and innovator with a developer having stated requirements and resources for development.

A method of web based development and exploitation of IP with the following steps is disclosed:
a. attracting a plurality of innovators, each having at least one innovation;
b. attracting at least one developer, the developer having stated requirements and verifiable resources for development of IP;
c. registering innovation data related to an innovation in a database on a storage medium connected to an information network;
d. registering developer data related to the developer's stated requirements and verifiable resources for development of IP in a database on a storage medium connected to the information network;
e. making innovation data available to a developer and developer data available to at least one innovator.

A number of different kinds of users are contemplated for the system and methods disclosed. Users may be innovators or developers; users may also belong to the general public, or specific demographic segment of the public such as youth under 18, or seniors over 55.

In preferred embodiments of the invention a web site is contemplated for housing the user interface aspects of the modules disclosed as part of the system, and for effecting the steps of the disclosed methods. This web site, or a plurality of such sites, are anticipated to be owned and/or operated by a variety of interested parties. For example a company develops such a site to foster and encourage and track and reward innovation amongst its own employees and contractors; or an industry segment jointly effects such a site to encourage innovation within the segment; or a public body such as local, state or federal government, or agencies or departments of such bodies, or institutions of such bodies (libraries and universities) effects an innovation site such as that disclosed. Special interest groups such as environmentalists, global health or ecological concerns, or more local community concerns will also sponsor or operate such sites. Any given site may be an intranet and relatively closed to access by general public users; or it may be an extranet, or it may be fully open to the entire internet, or anywhere in between, limited only by its owners to effectuate its particular purposes.

Innovators can be attracted to such a site for a number of reasons and in a number of ways. Some desire to be validated in an evaluation and/or reward process; others wish to learn more about their craft of innovation and about how to more effectively and profitably exploit the fruits of their creativity; still others wish to see and perhaps compare their innovations with the innovations of others, and all come to be encouraged. The preferred site offers evaluation, prize and other financial reward opportunities, invited professional expertise in innovation and exploitation skills and resources, a database of other innovations, categorized into industries and fields of creative endeavor, and the like, and by keyword, and such other indicia as will be appreciated by those skilled in the art. But especially, the preferred site offers encouragement to all users who visit.

Developers (which is to say all those individuals and companies that bring commitment and resources to the task of perfecting, marketing and otherwise exploiting IP to mutual profit and global benefit) can also be attracted to such a site for a number of reasons and in a number of ways. Some will be attracted to a pool of raw innovation (‘raw’ in the sense that, depending on the origin and sponsorship of the particular site of course, most innovators will typically not be pre-tied to a research institution or corporate research apparatus—except in sites run by just such organizations, but as to those innovators, they are typically not pre-tied to any outside interests); others to the intrinsic and extrinsic of sponsorship, desiring to build goodwill in the community, especially in Community Corner and Kids Corner type sites or subsites, as well as to the more tangible benefits of branding and brand identification to the innovator pool and other users and visitors to the site; others will be attracted by the opportunity to run infomercial and other marketing on the site, and still others will be eager to have a finger on a grass roots technology pulse.

The preferred site offers the pool of raw innovation and eager innovators; it provides a variety of opportunities for highly visible sponsorship, from banner ads to contest prizes; it provides a platform for infomercialization that is a true win/win by educating users as it also markets to them; and the pulse of innovation available by searches of the site database will provide valuable background to other data more usually watched by technology development executives.

The site provides a ready vehicle and means to get ideas registered and transformed into searchable and trackable data. Ideas and innovations and their related data can preferably be tracked both before and after any match ups with developers, and innovation data updates and developer resources and match outcome updates can be tracked as well. All innovator users have the option of specifying levels of permission for the dissemination and/or sharing of their innovation data. Recurrent innovator input is encouraged, as is recurrent follow up by developers with their innovator prospects, generating in preferred embodiments a kind of interactive and iterative feedback between the develop and innovator, all to the positive in further developing the innovation and bringing it to successful exploitation. This extra- or post-match interaction is preferably tracked as well, and all data tracked is preferably stored in a database for retrieval and analysis.

Throughout the disclosure, where single databases are referred to, or multiple or connected databases are referred to, it is intended that each shall optionally have the meaning of the other, so that one database may be the equivalent of several others and a network of databases may be the equivalent, for disclosure purposes, of a single database. All matches referred to in the disclosure may be understood to refer to one to one matches, or one to many, or many to one, or many to many, as makes best sense in any particular embodiment.

### BRIEF DESCRIPTION OF THE DRAWINGS

FIG. 1 is a set of charts showing corporate predilections for (a) repositories of data and (b) obstacles to creation of a fully function IP system.

FIG. 2 is a schematic diagram of a trade secret monitoring aspect of the system.

FIG. 3 is a schematic diagram of an Internet innovation marketing aspect of the system.

FIG. 4a-d is set of screen shots showing an Explorer aspect of the IMS VB GUI, with a-c showing an earlier version and details on a system trade secret search, and with d showing a corresponding but updated Web version of a File Cabinet search page.

FIG. 5a-b is a set of screen shots showing a Classes/Users aspect of the IMS VB GUI, with a showing an earlier version and with b showing a corresponding but updated Web version of a Human Resource search page.

FIG. 6 is a screen shot showing a Data Analysis aspect of the IMS VB GUI.

FIG. 7a-c is a set of screen shots showing a innovation database Search Results aspect of the IMS VB GUI, with a showing an earlier version and with b-c showing corresponding but updated Web versions of a Database Search page and a NDA Tracker page.

FIG. 8a-b is a set of screen shots showing a Monitor aspect of the IMS VB GUI, with a showing an earlier version and with b showing corresponding but updated Web version of an alternate search results page.

FIG. 9a-b is a set of screen shots showing an Innovator Home Page aspect of the IMS Web GUI, with a showing an earlier version and with b showing an updated version.

FIG. 10a-b is a set of screen shots showing an Innovator Submissions Page aspect of the IMS Web GUI, with a showing an earlier version and with b showing an updated version.

FIG. 11a-b is a set of screen shots showing an Innovator Search Results Page aspect of the IMS Web GUI, with a showing an earlier version and with b showing an updated version.

FIG. 12 is a screen shot showing an Innovator Corporate Page aspect of the IMS Web GUI.

FIG. 13 is a screen shot showing an Innovator Top Innovations Page aspect of the IMS Web GUI.

FIG. 14a-b is a set of screen shots showing an Innovator Database Search Results Page aspect of the IMS Web GUI, with a showing an earlier version and with b showing an updated version.

FIG. 15a-d is a set of screen shots showing an Innovator Management Tools aspect of the IMS Web GUI, with a showing an earlier version and with b-d showing updated versions.

FIG. 16a-b is a set of screen shots showing an Innovator Summary Page aspect of the IMS Web GUI, with a showing an earlier version and with b showing an updated version.

FIG. 17a-b is a set of screen shots showing an Innovator Details Page aspect of the IMS Web GUI, with a showing an earlier version and with b showing an updated version.

FIG. 18 is a Trade Secret System Overview Diagram.

FIG. 19 is a schematic of the NMPS system of the invention.

FIG. 20 is a schematic of the FMS system of the invention.

FIG. 21 is screen shot of the IPX VB Explorer.

FIG. 22 is screen shot of the IPX VB Classes/Users.

FIG. 23 is screen shot of the IPX VB Trade Secret Classes.

FIG. 24 is screen shot of the IPX VB User list.

FIG. 25 is screen shot of the IPX VB User Classes.

FIG. 26 is screen shot of the IPX VB Permissions.

FIG. 27 is screen shot of the IPX VB IP TS Removal Options.

FIG. 28a-b are new and older screens shots respectively of HTML Innovation submission pages.

FIG. 29a-b are new and older screens shots respectively of HTML Innovation database search pages.

FIG. 30a-b are new and older screens shots respectively of HTML Innovation search results pages.

FIG. 31 is a screen shot of an Innovator Summary Page aspect of the IMS Web GUI.

FIG. 32 is a screen shot of an Innovator Management Tools aspect of the IMS Web GUI.

FIG. 33 is a screen shot of a main index page for an Innovator installation of the EIMS system.

FIG. 34 is a diagram of an aspect of the FMS system.

FIG. 35a is a screen shot of a user overview page for an Innovator installation of the EIMS system.

FIG. 35b is a screen shot of a submission for collaboration page for an Innovator installation of the EIMS system.

FIG. 36 is a screen shot of a search agent configuration page for an Innovator installation of the EIMS system.

FIG. 37 is a screen shot of a personal bio page for an Innovator installation of the EIMS system.

FIG. 38 is a screen shot of a collaboration seek and results page for an Innovator installation of the EIMS system.

FIG. 39 is a screen shot of an analysis/ranking module page for an Innovator installation of the EIMS system.

FIG. 40 is a screen shot of a IP asset detail page for an Innovator installation of the EIMS system.

FIG. 41 is a screen shot of a resources contribution page for an Innovator installation of the EIMS system.

FIG. 42 is a screen shot of a technology transfer enablement page for an Innovator installation of the EIMS system.

FIG. 43 is a screen shot of a search agents configuration page for an Innovator installation of the EIMS system.

FIG. 44 is a table of contents for a preferred website.

FIG. 45 is a home page for a preferred website.

FIG. 46 is a Contest page for a preferred website.

FIG. 47 is a Corporate Corner subsite Home for a preferred website.

FIG. 48a-c is a Top Innovations page for a preferred website.

FIG. 49 is an Industry Hubs page for a preferred website.

FIG. 50 is Semiconductor subpage for a preferred website.

FIG. 51 is a Licensing Hubs page for a preferred website.

FIG. 52a-b is an Idea Submission page for a preferred website.

FIG. 53 is a Kids Center page for a preferred website.

FIG. 54a-b is a Best Ideas subpage for a preferred website.

FIG. 55 is a Bike Riders Club subpage for a preferred website.

FIG. 56 is a submission wizard and drawing tool subpage for a preferred website.

FIG. 57 is a Community page for a preferred website.

FIG. 58 is a Life Sciences subpage for a preferred website.

FIG. 59 is a Social Problems subpage for a preferred website.

FIG. 60 is an Inventors page for a preferred website.

FIG. 61 is a Strategic Resources subpage for a preferred website.

FIG. 62a-b is a Site News and Updates page for a preferred website.

FIG. 63 is a Database Search page for a preferred website.

FIG. 64 is a Registration page for a preferred website.

FIG. 65 is a flowchart of a preferred embodiment.

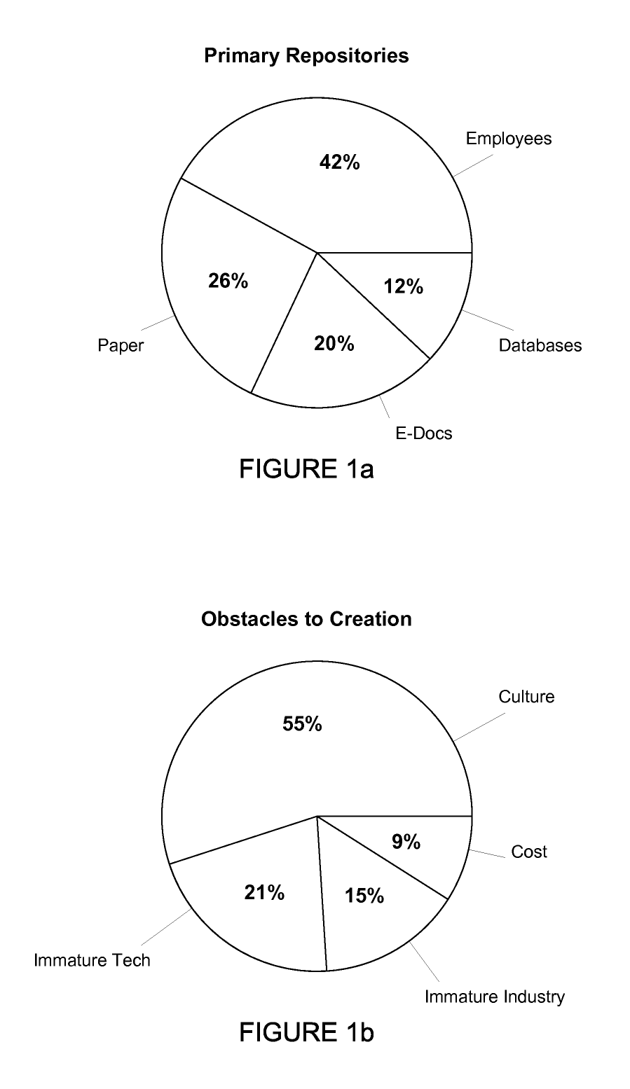

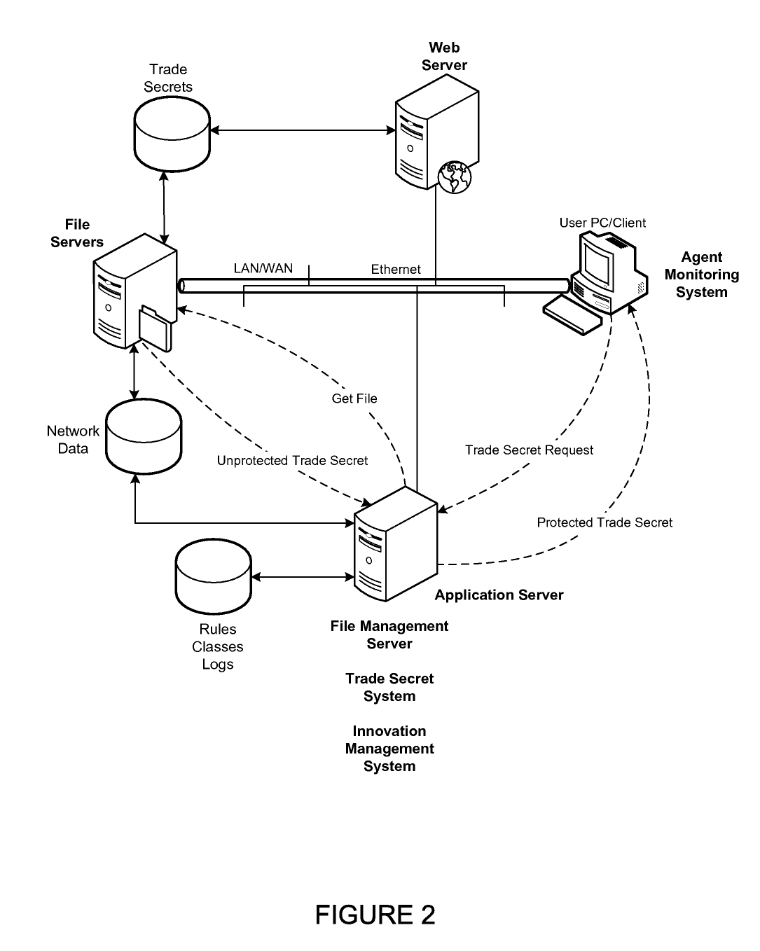

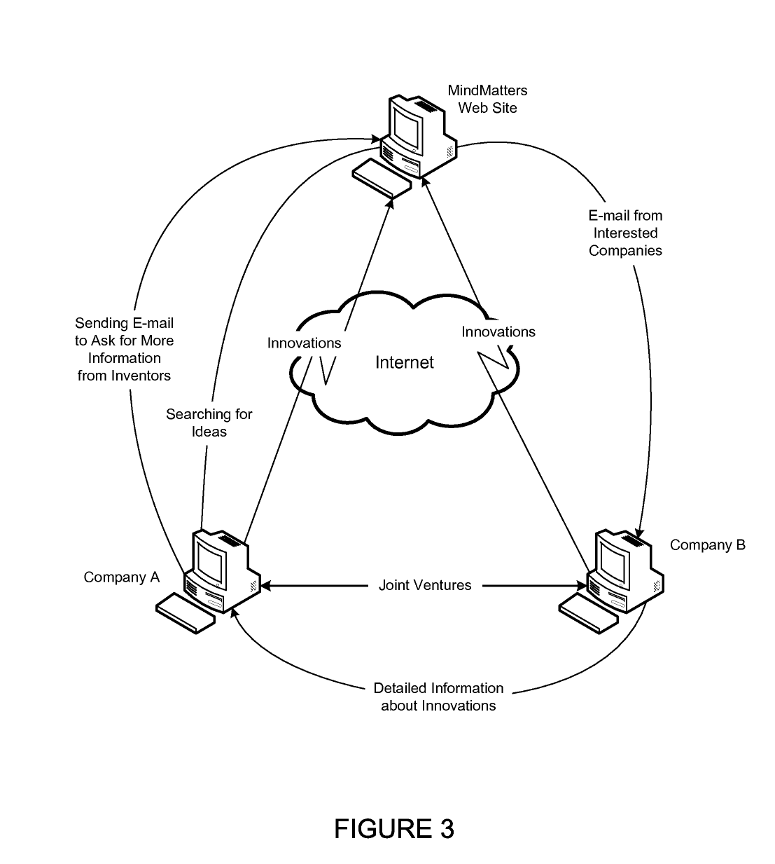

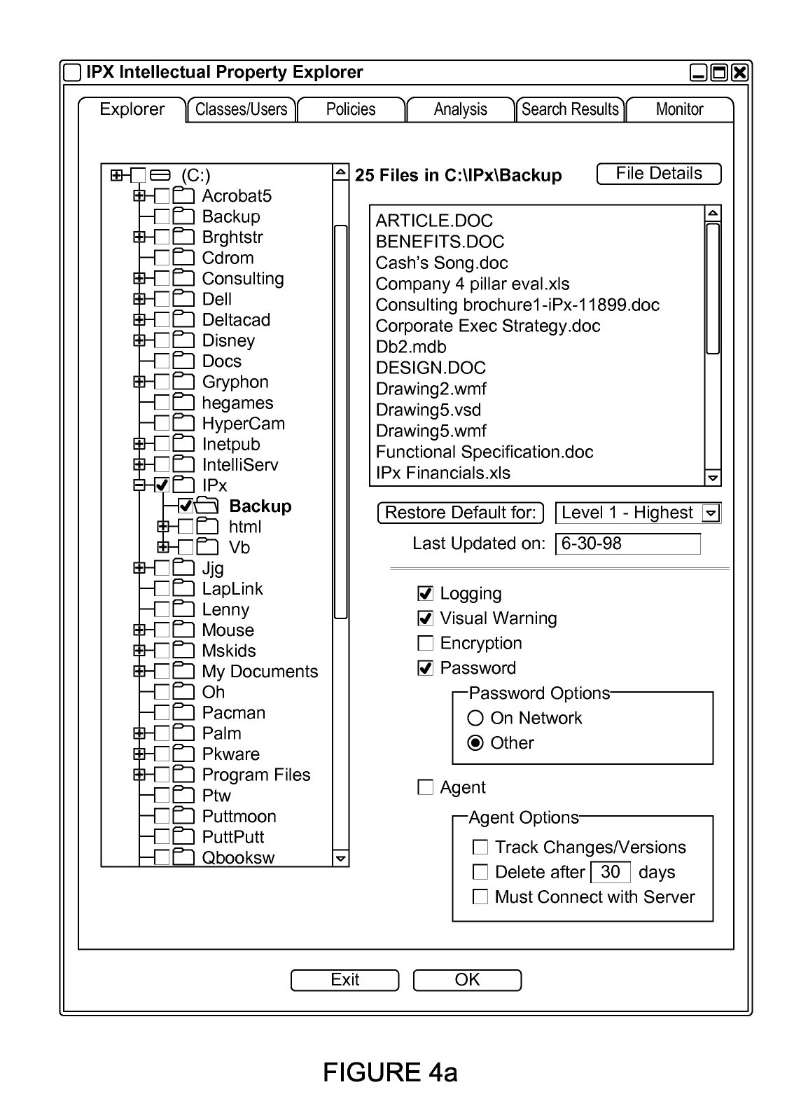

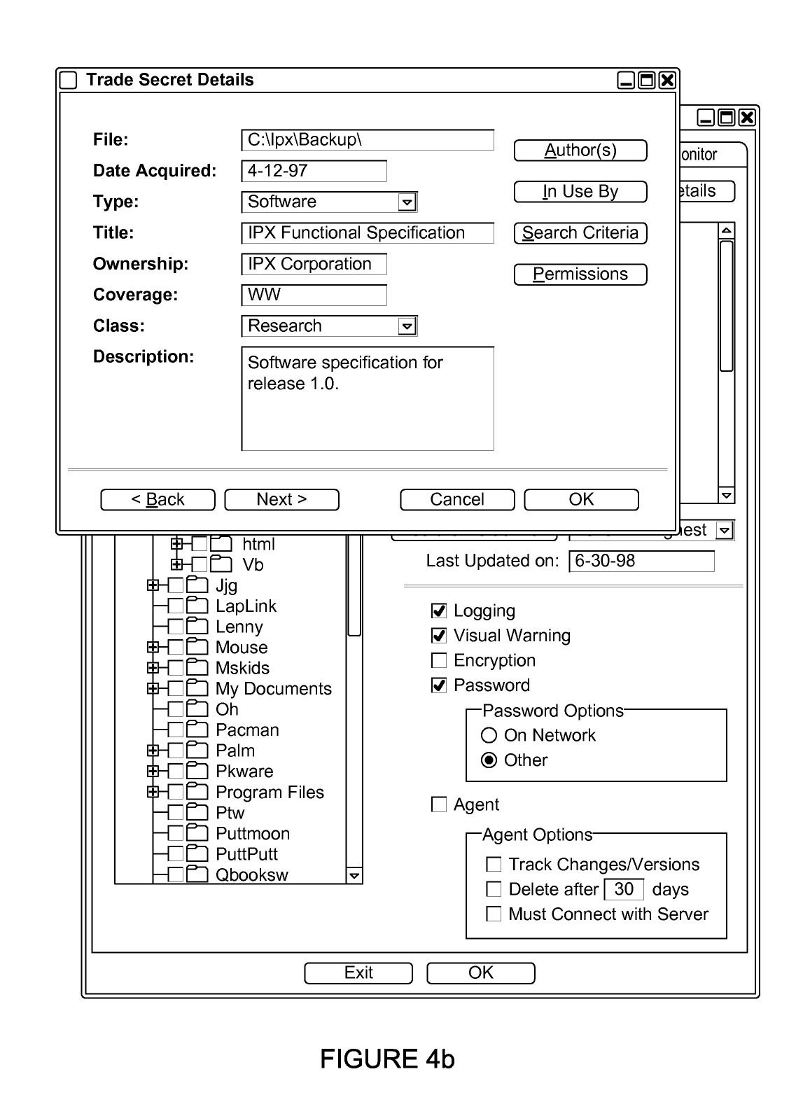

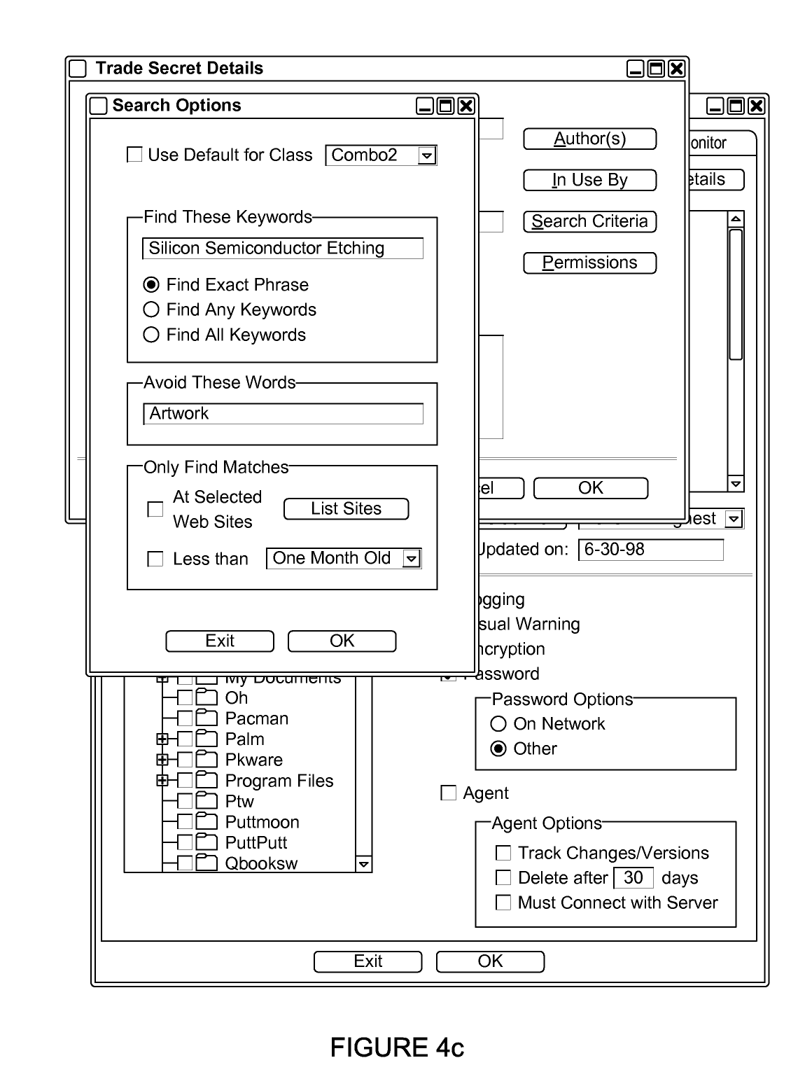

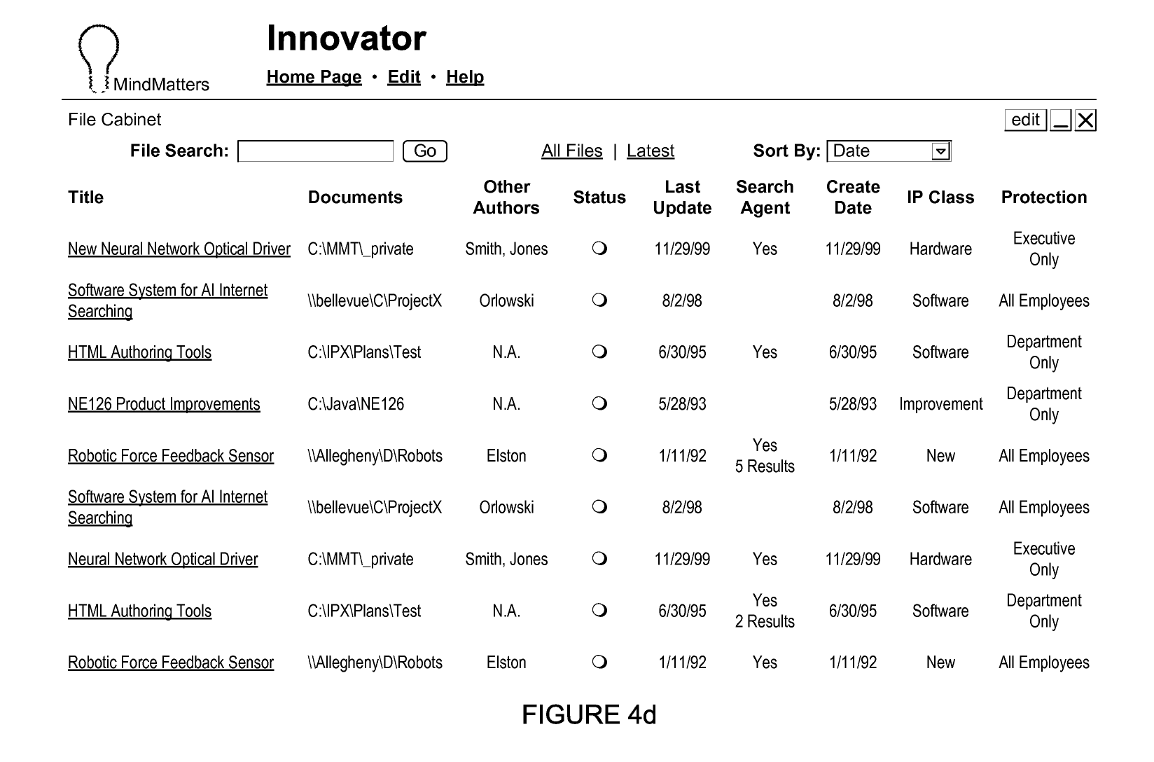

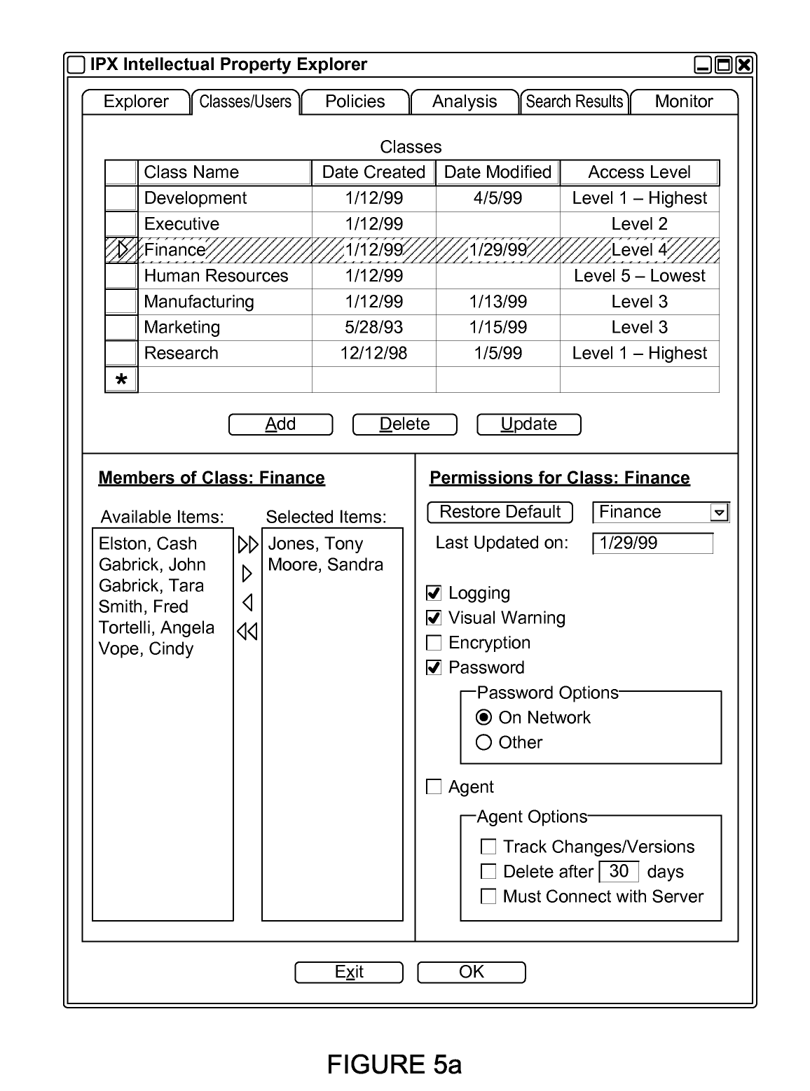

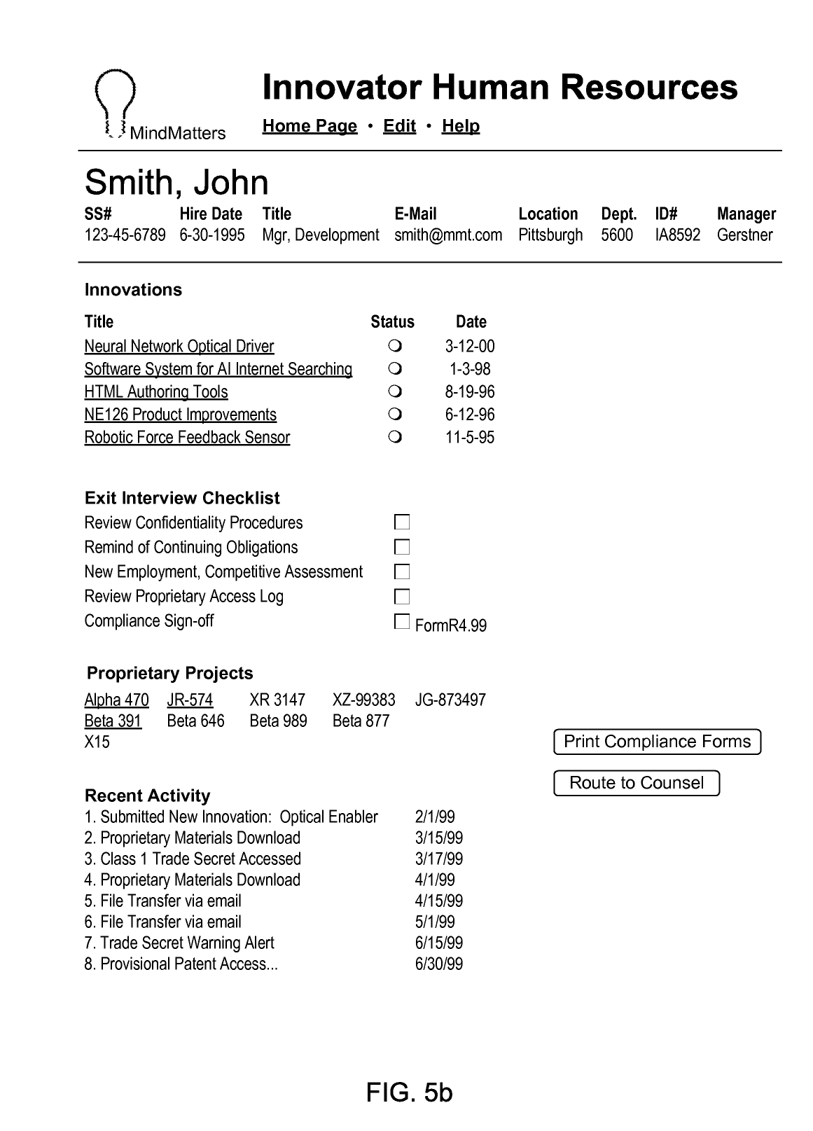

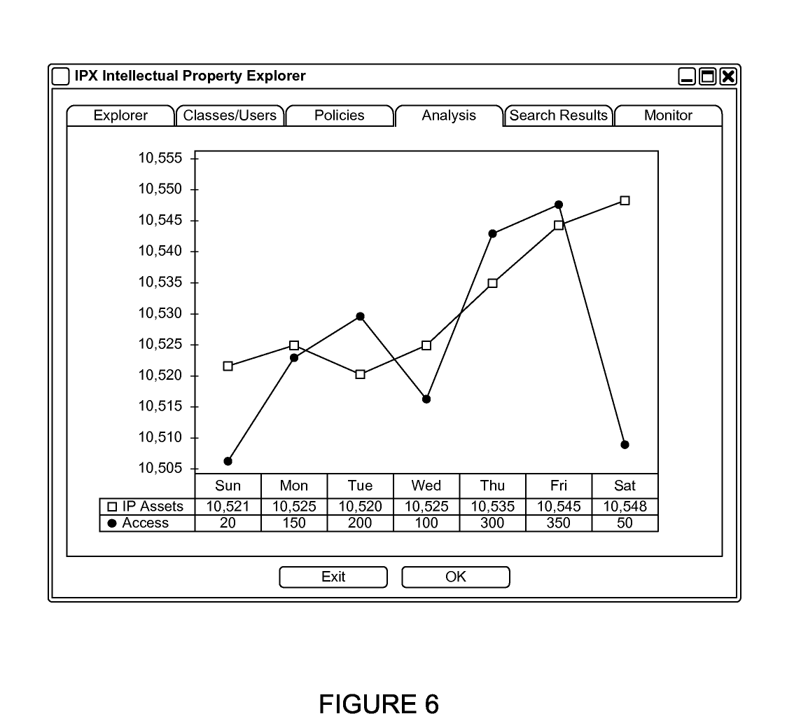

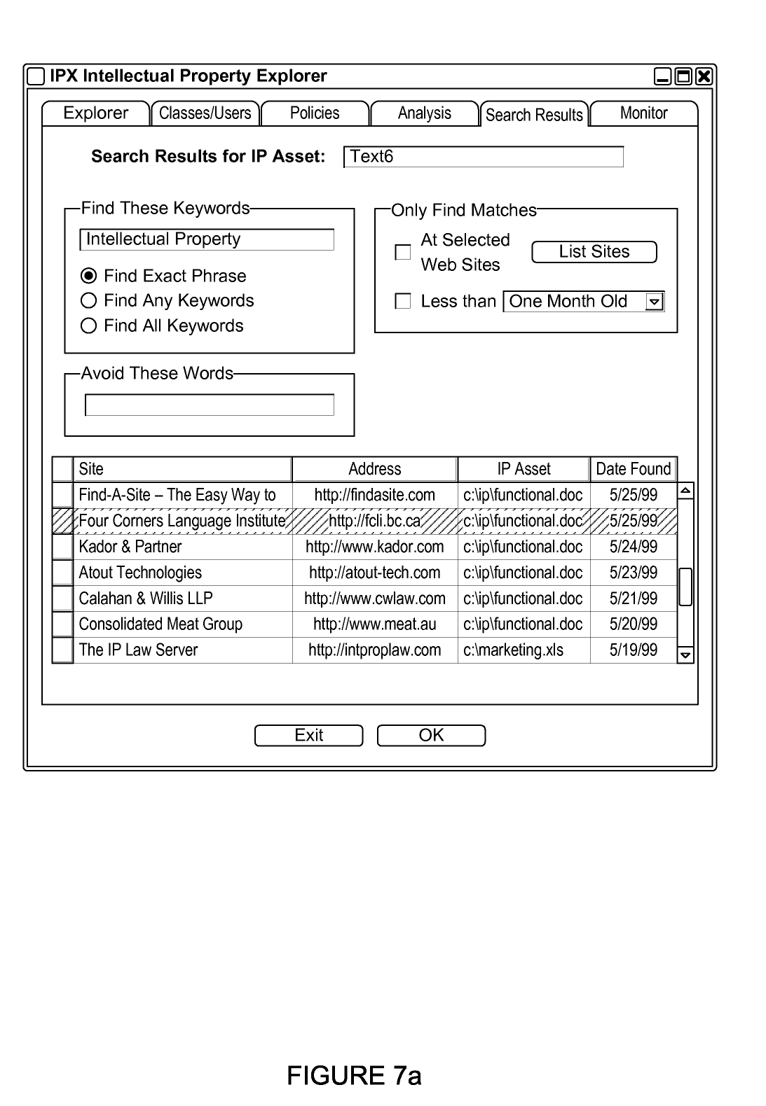

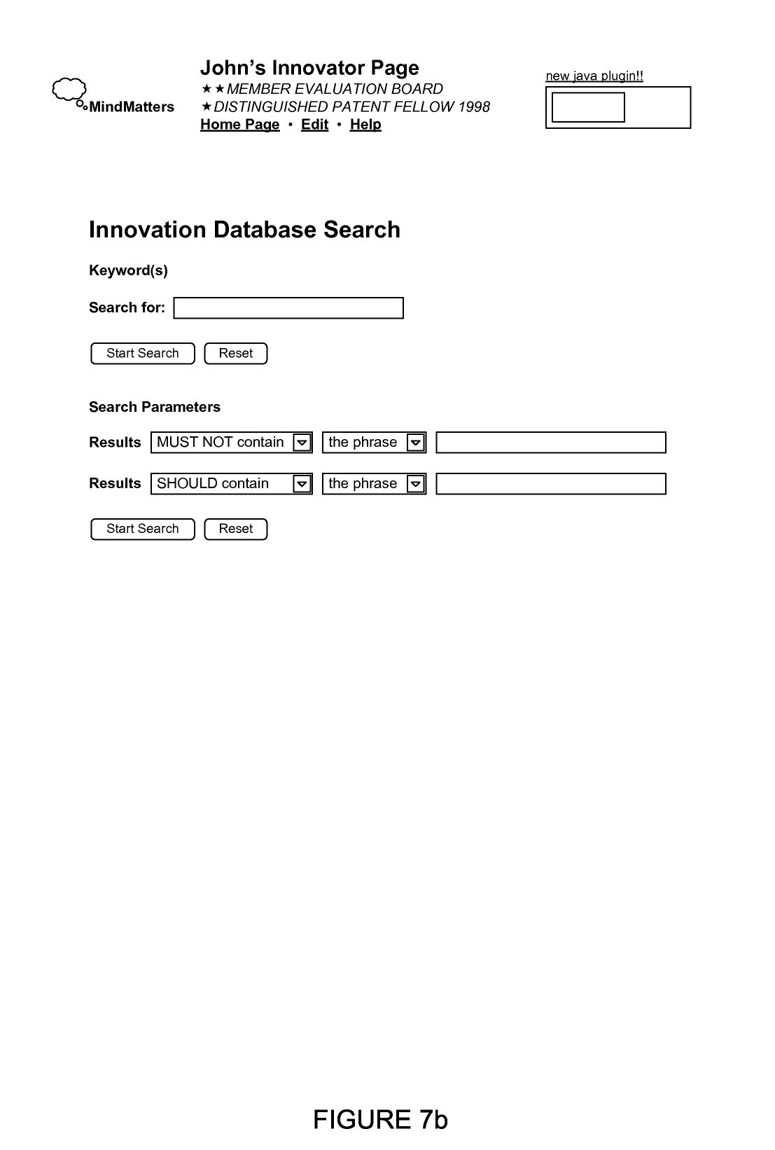

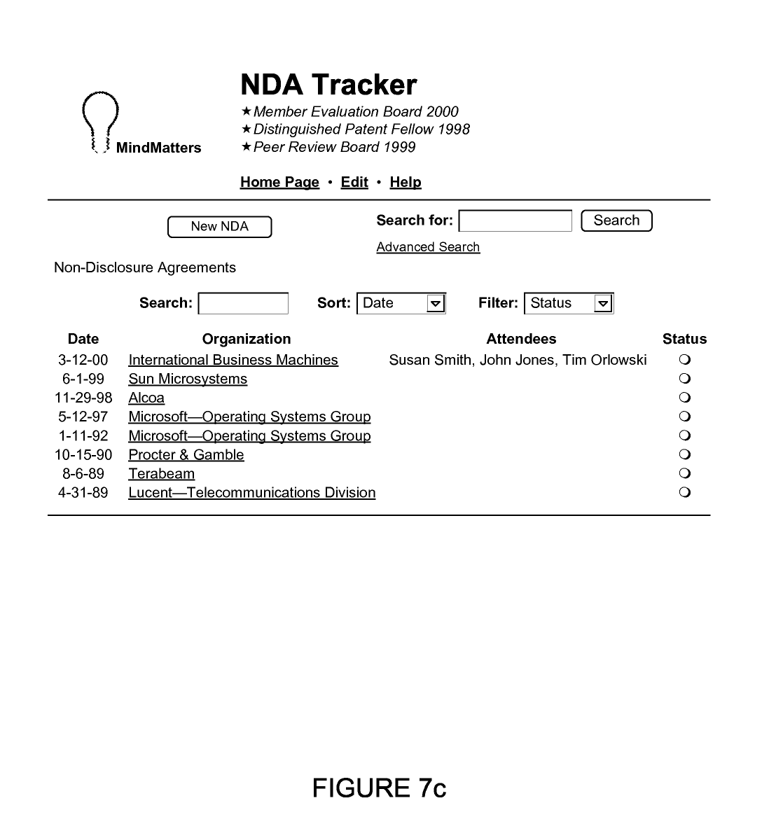

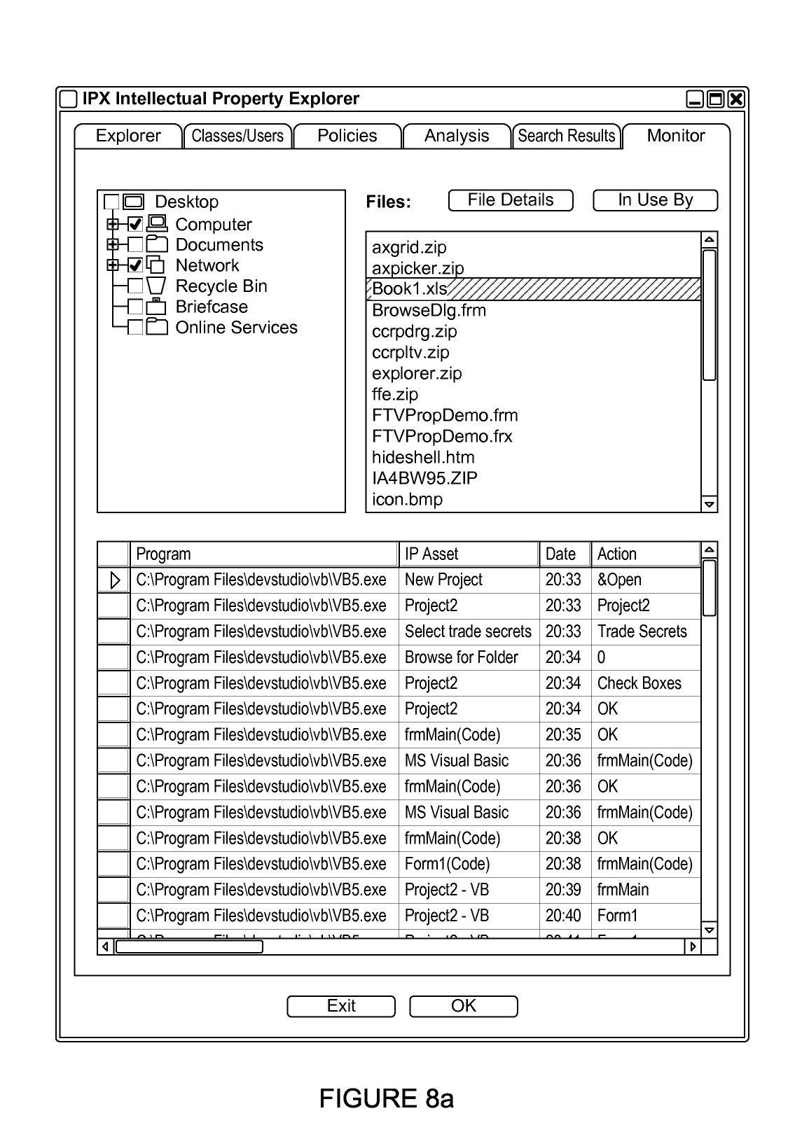

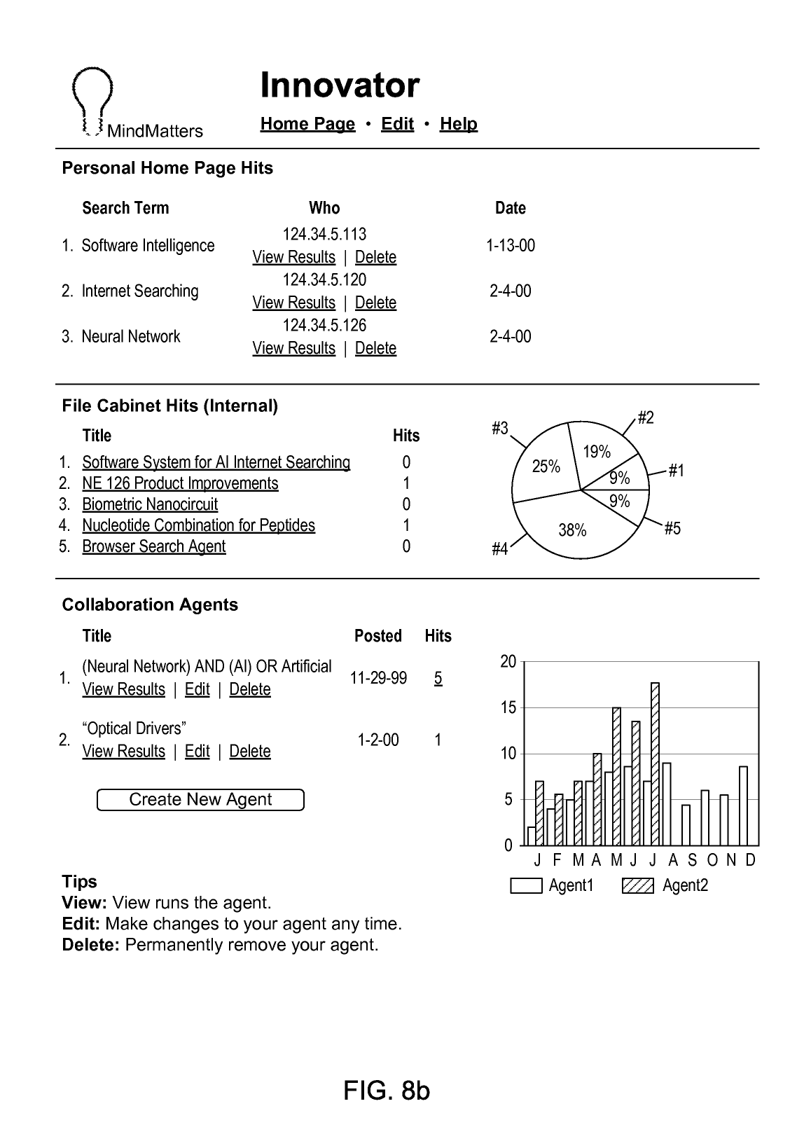

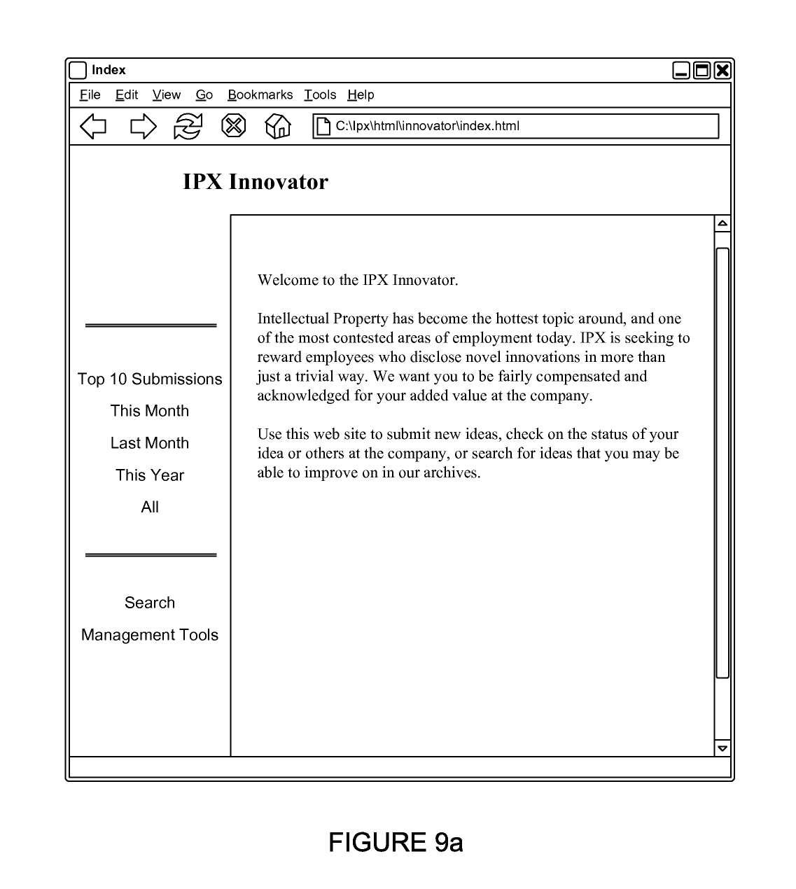

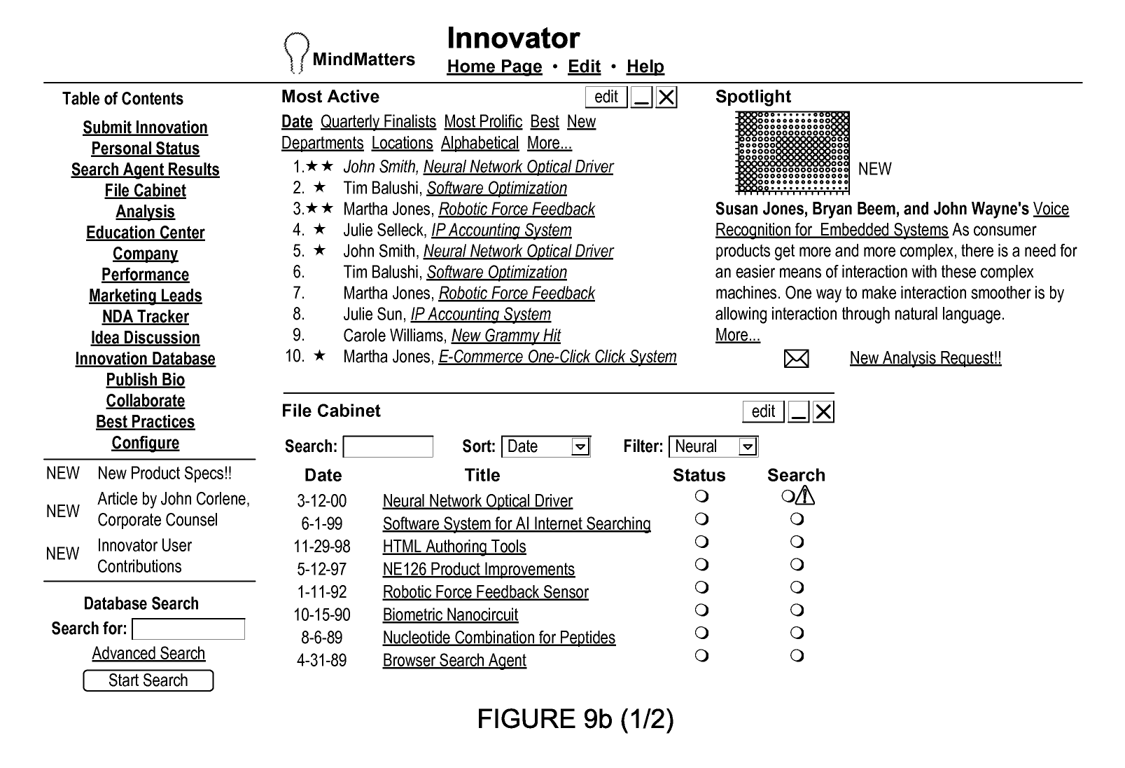

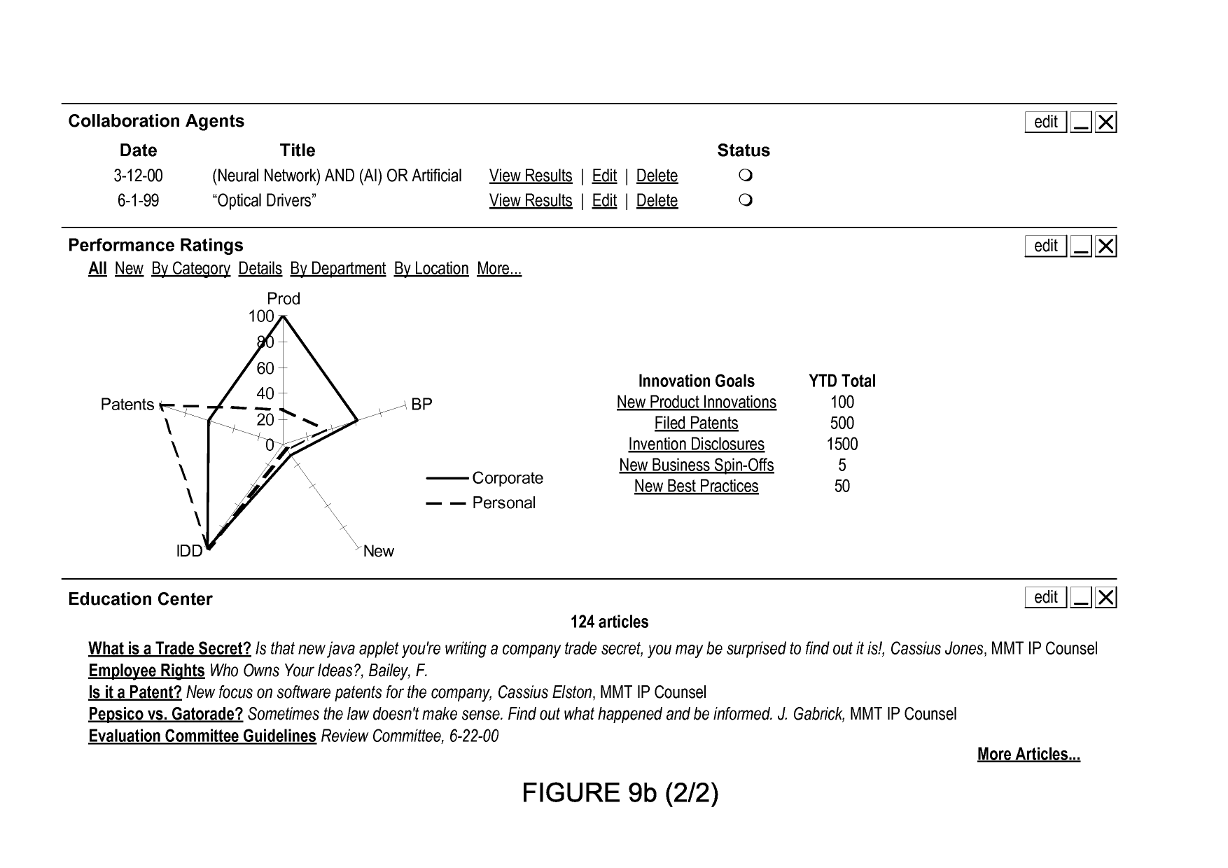

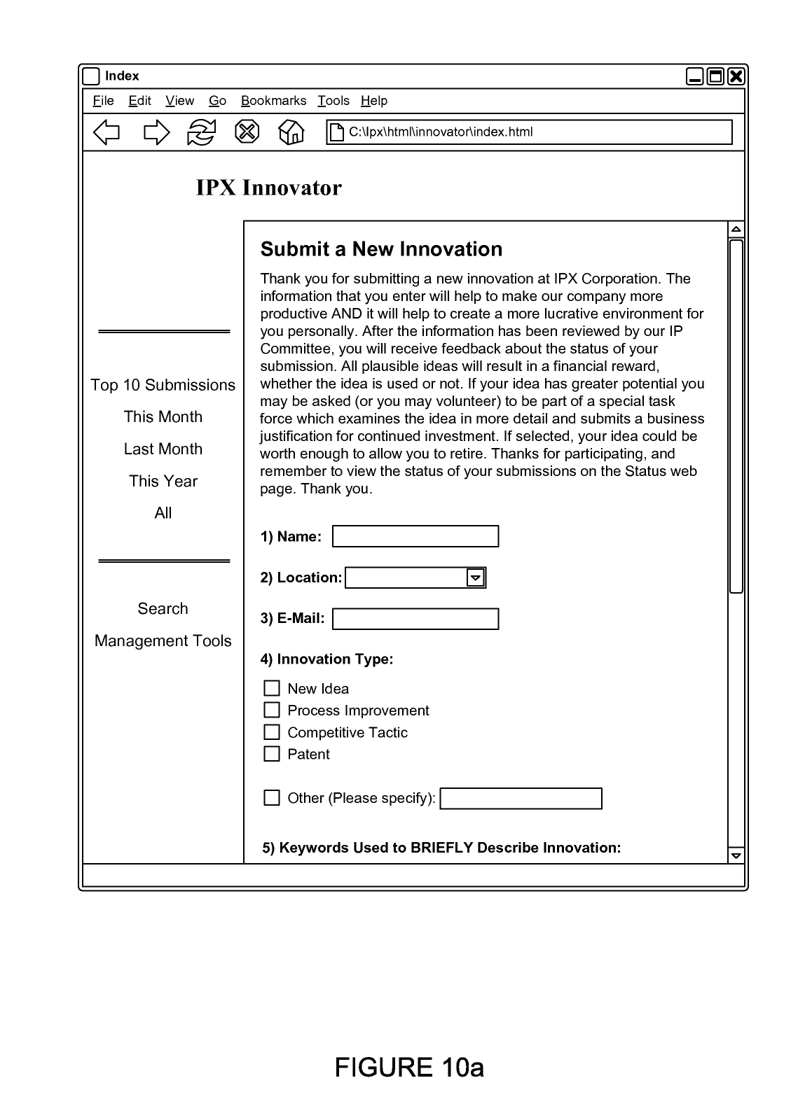

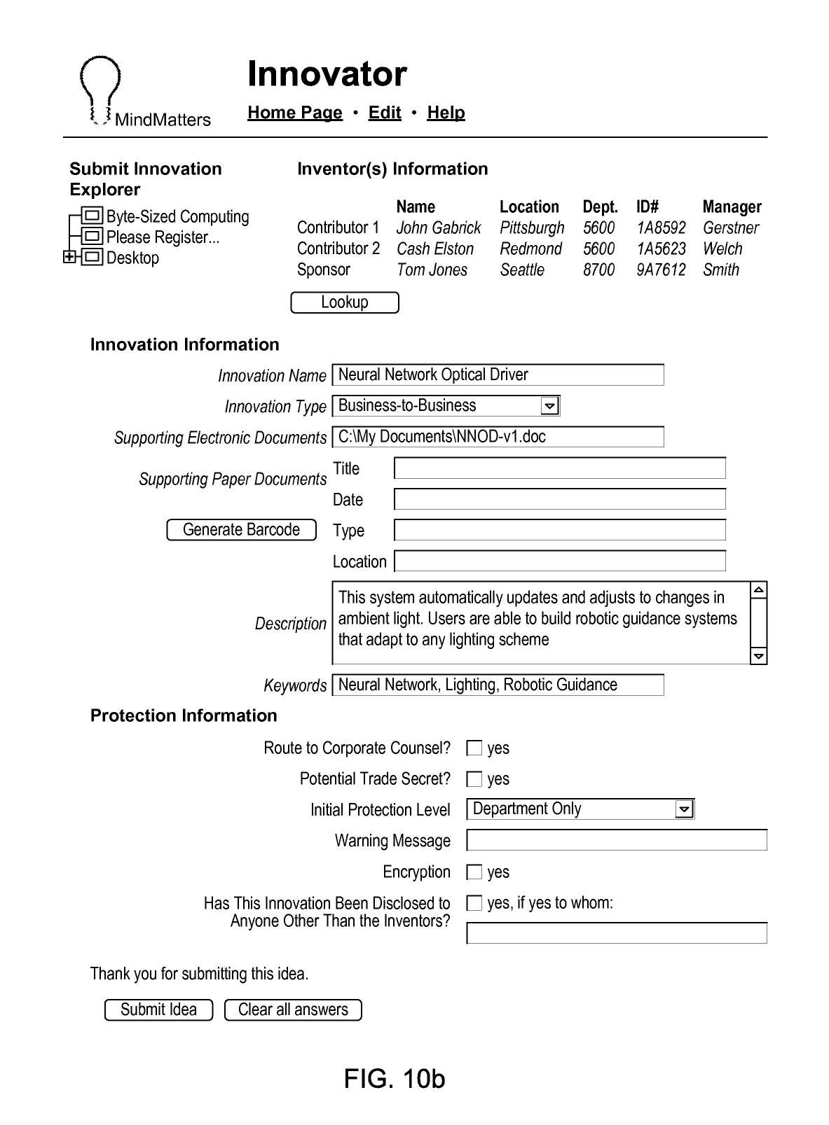

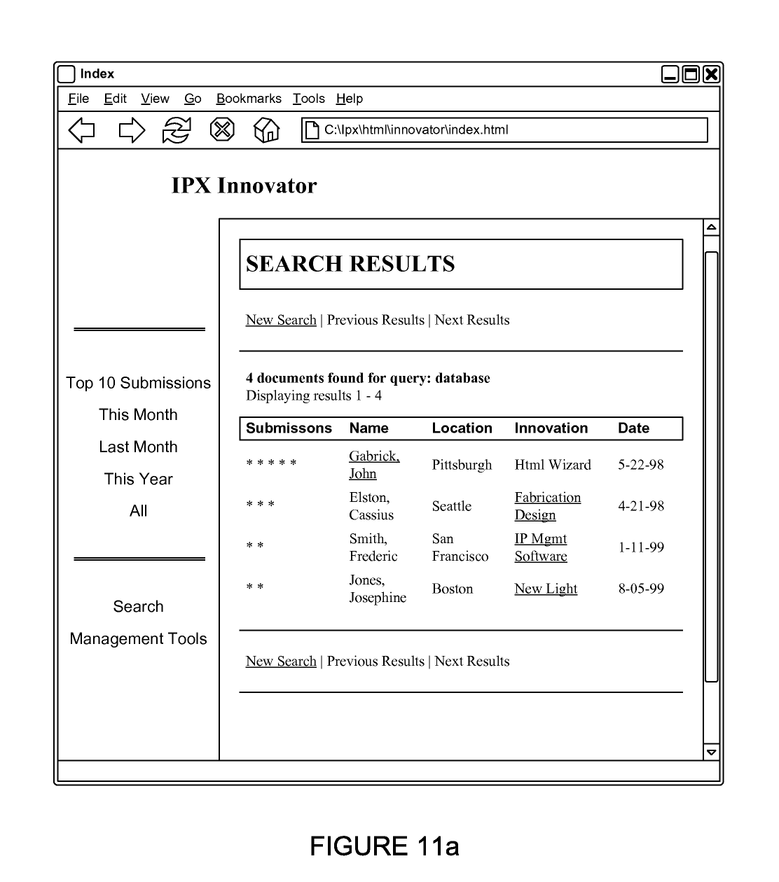

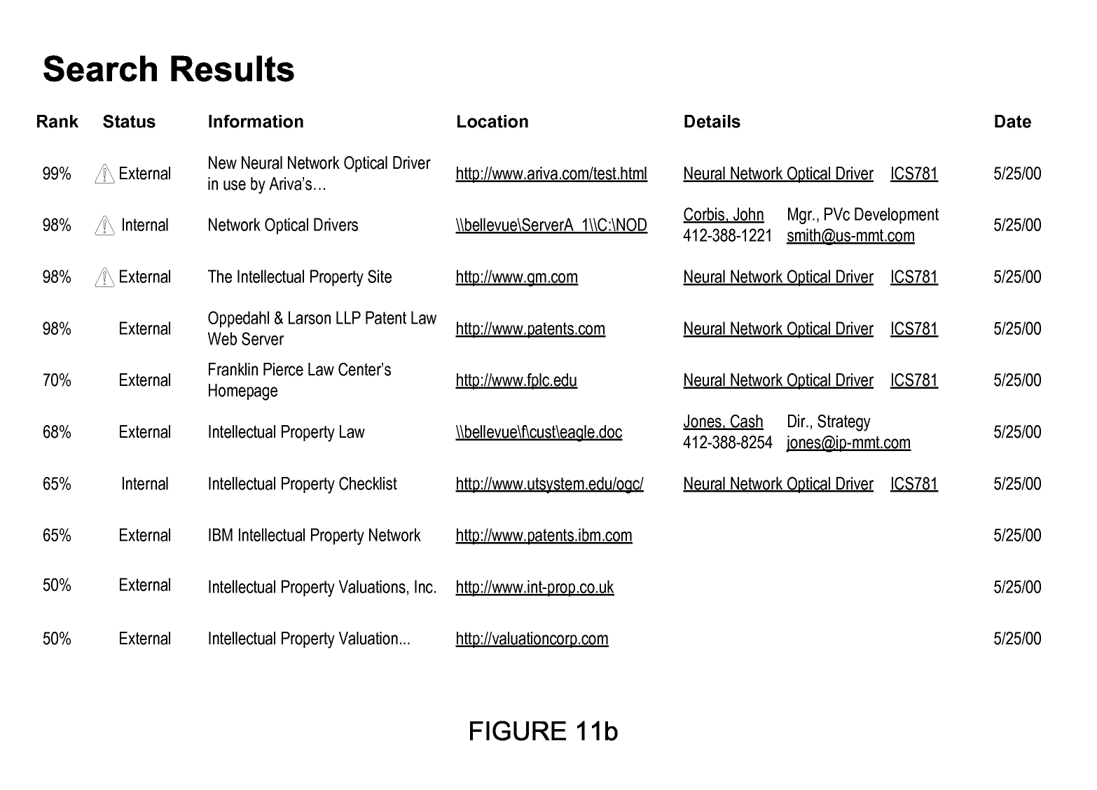

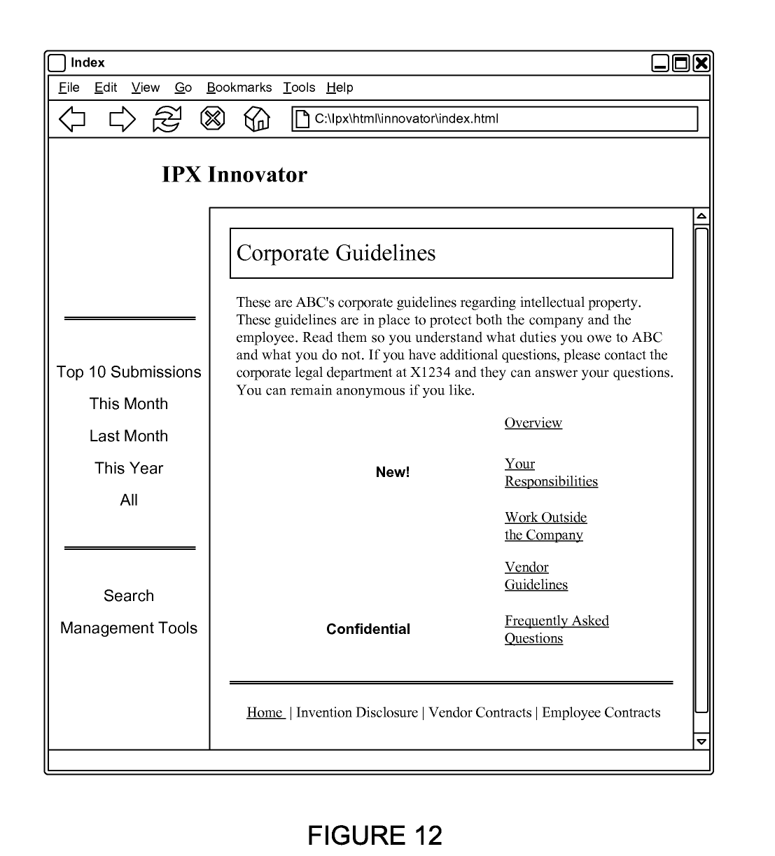

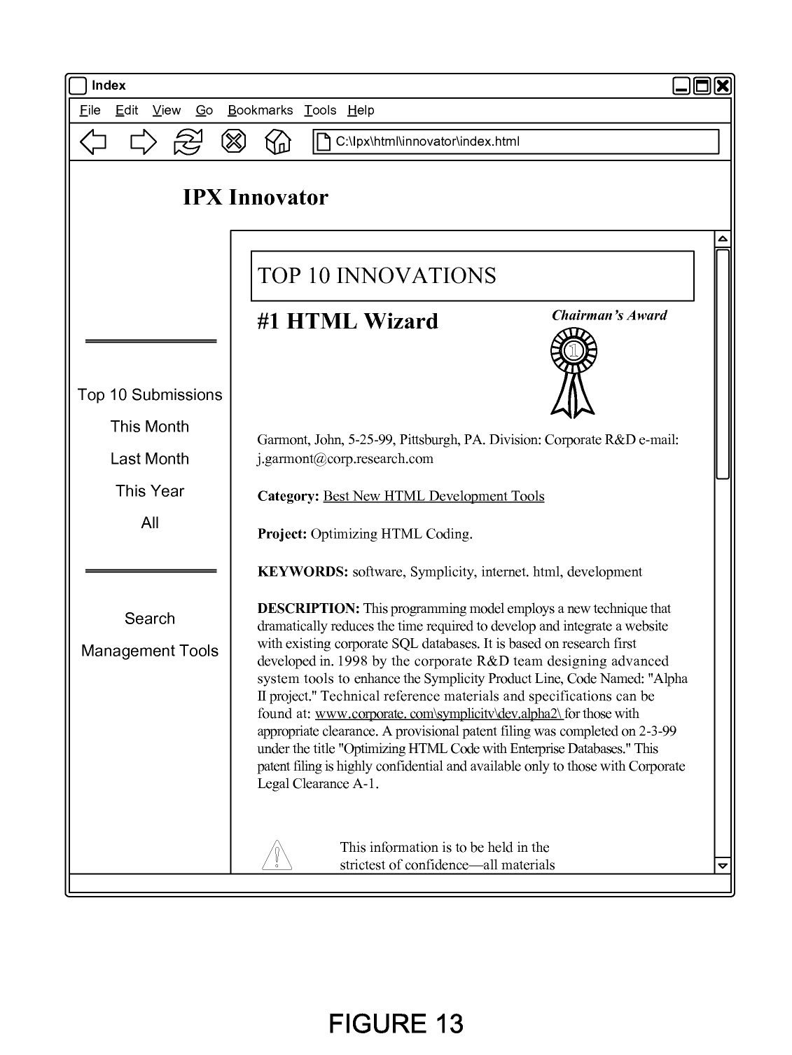

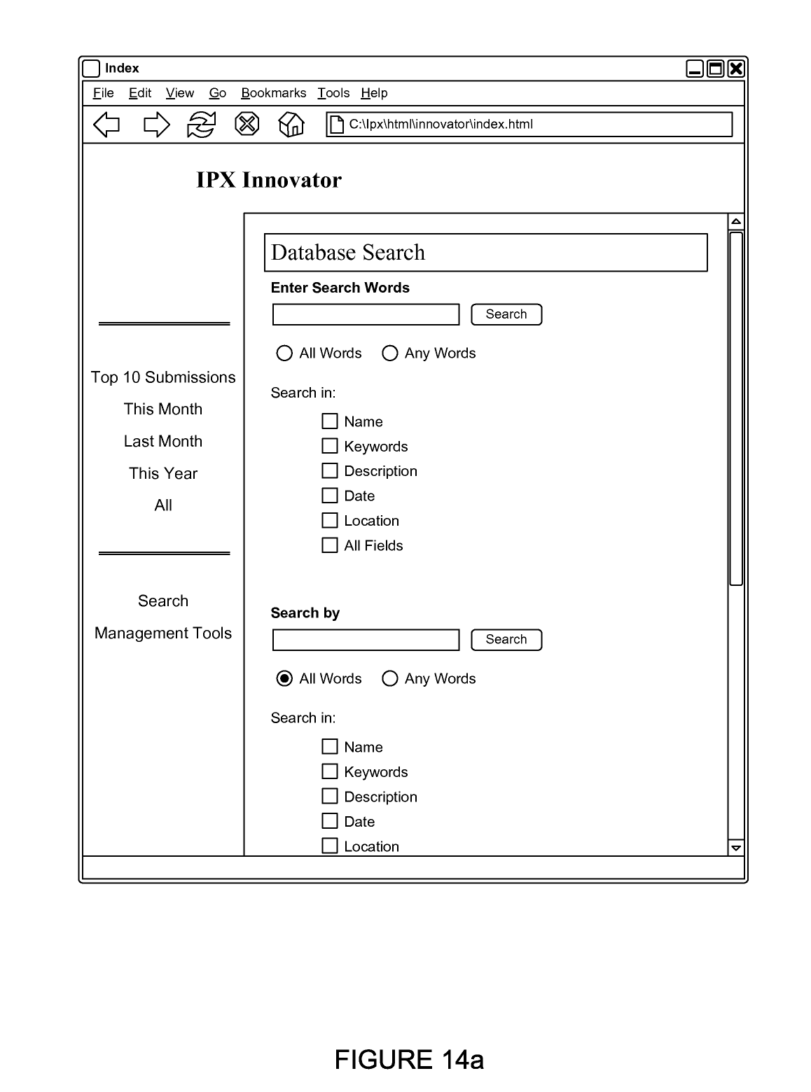

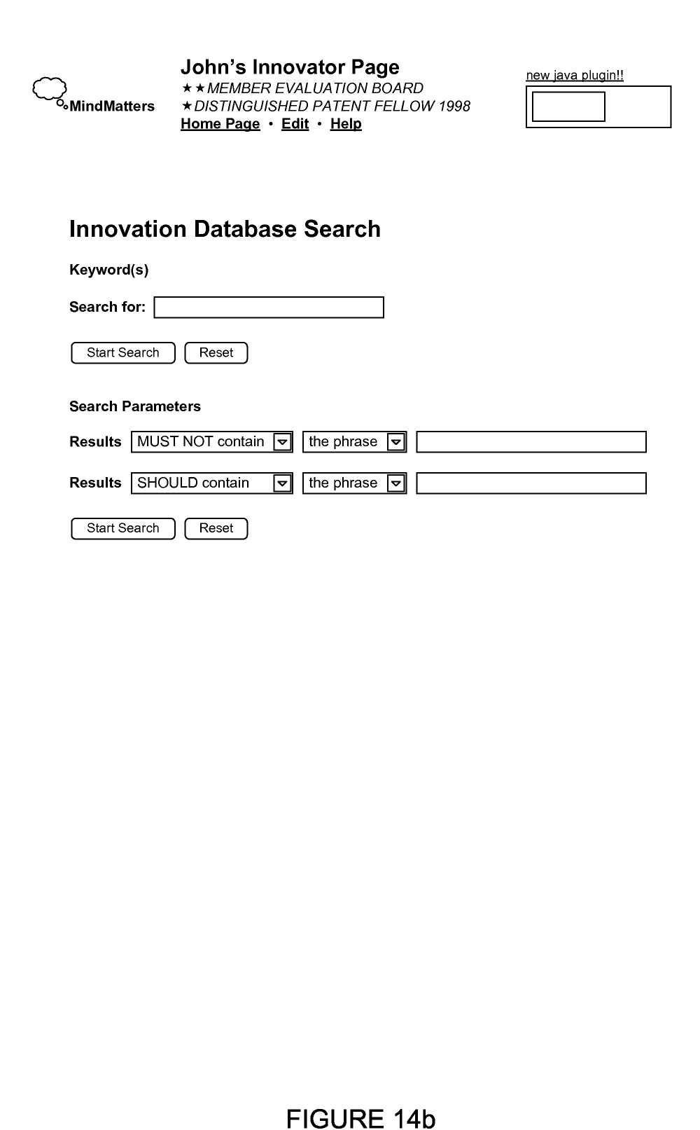

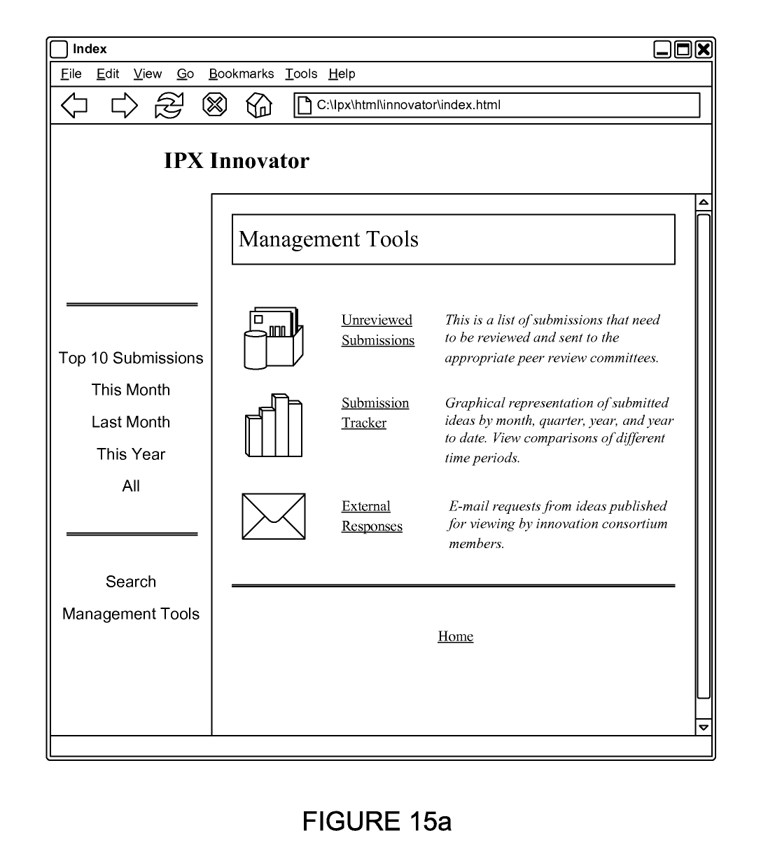

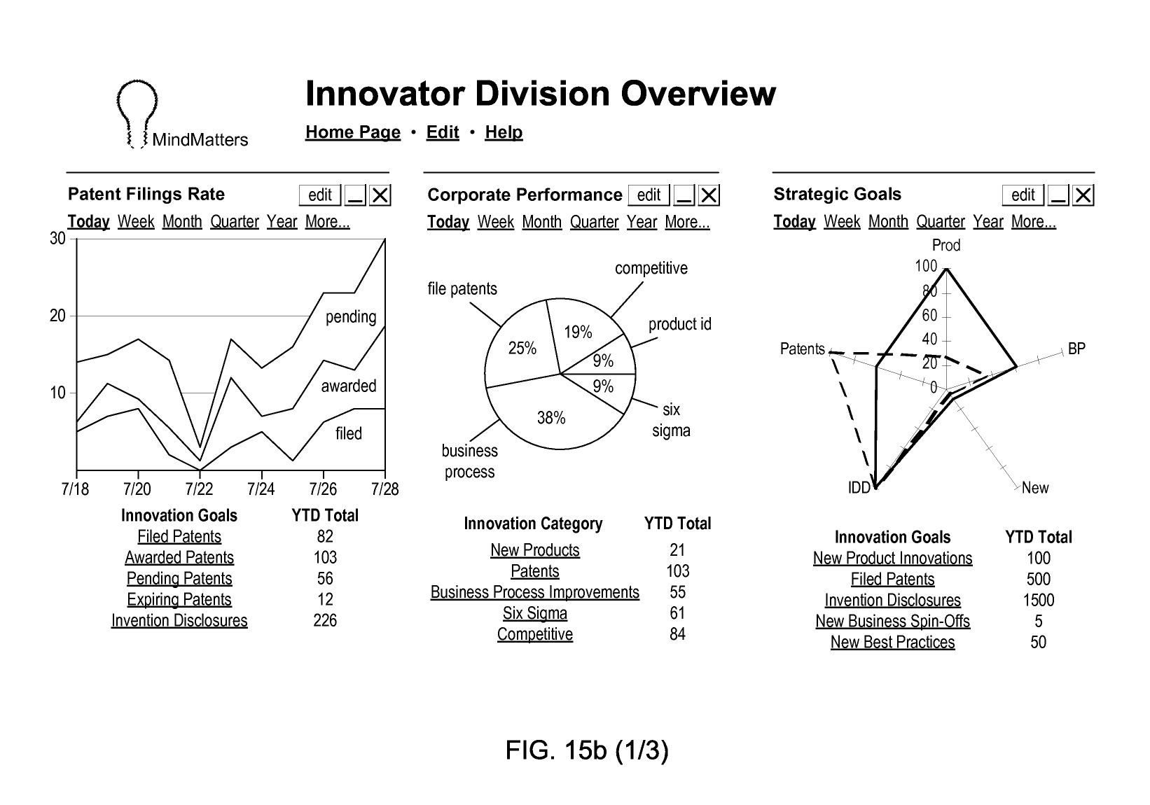

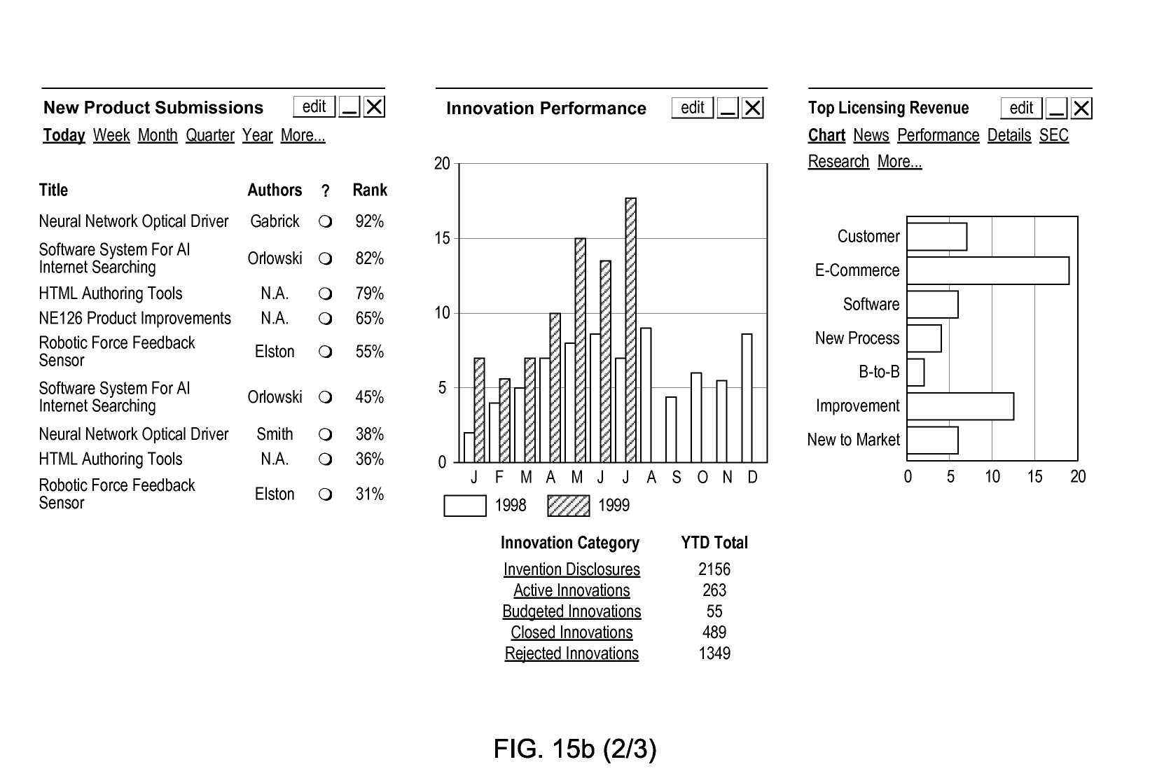

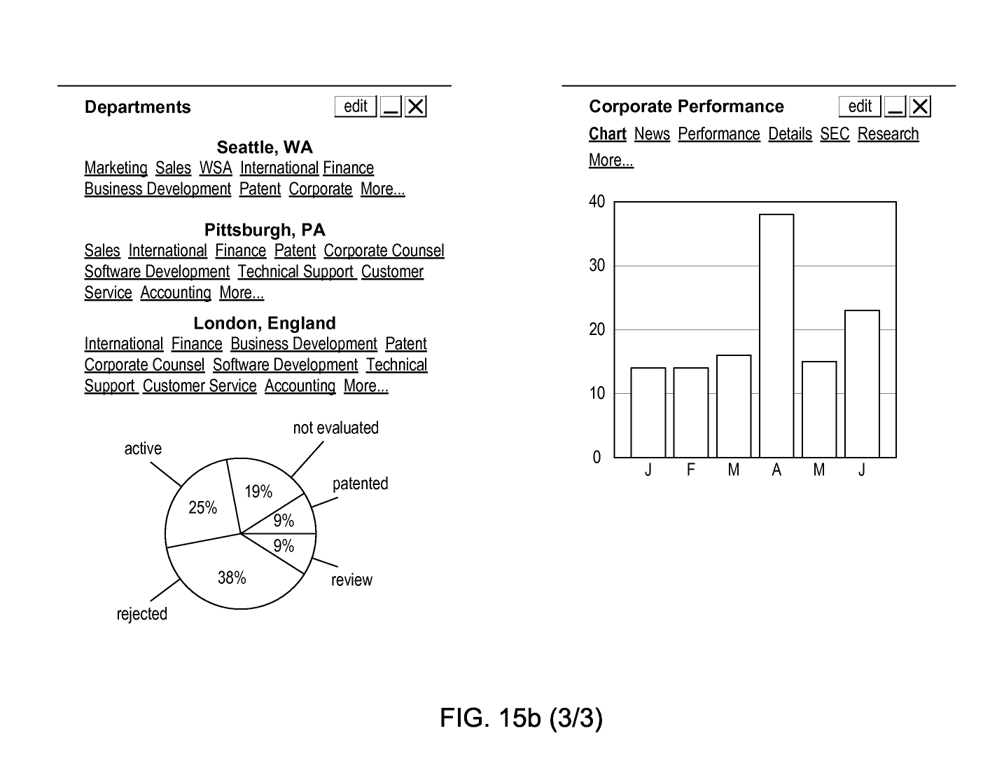

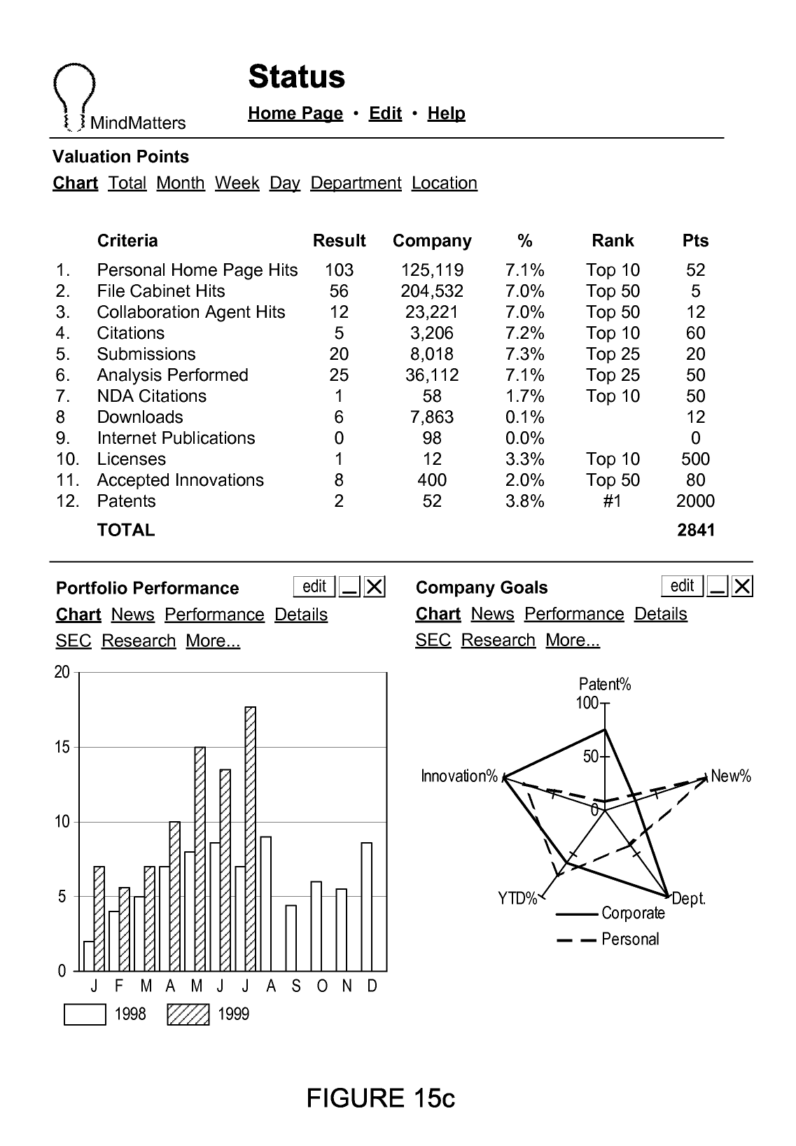

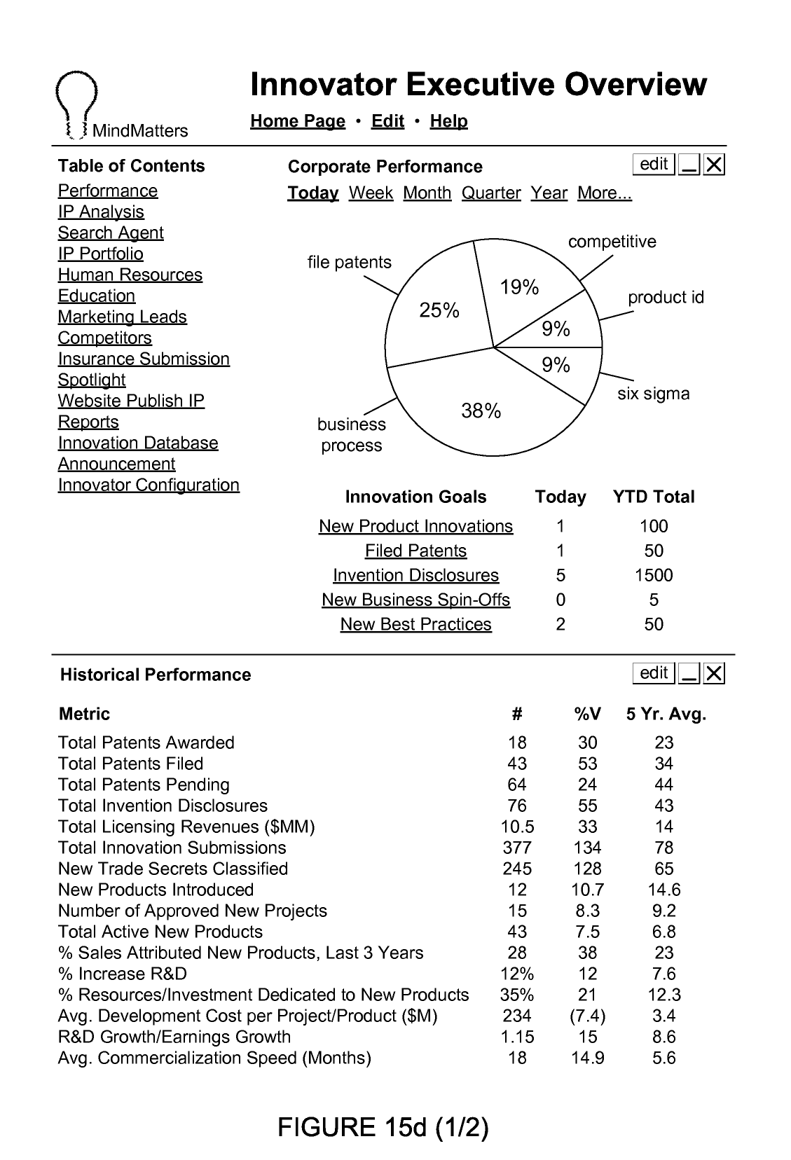

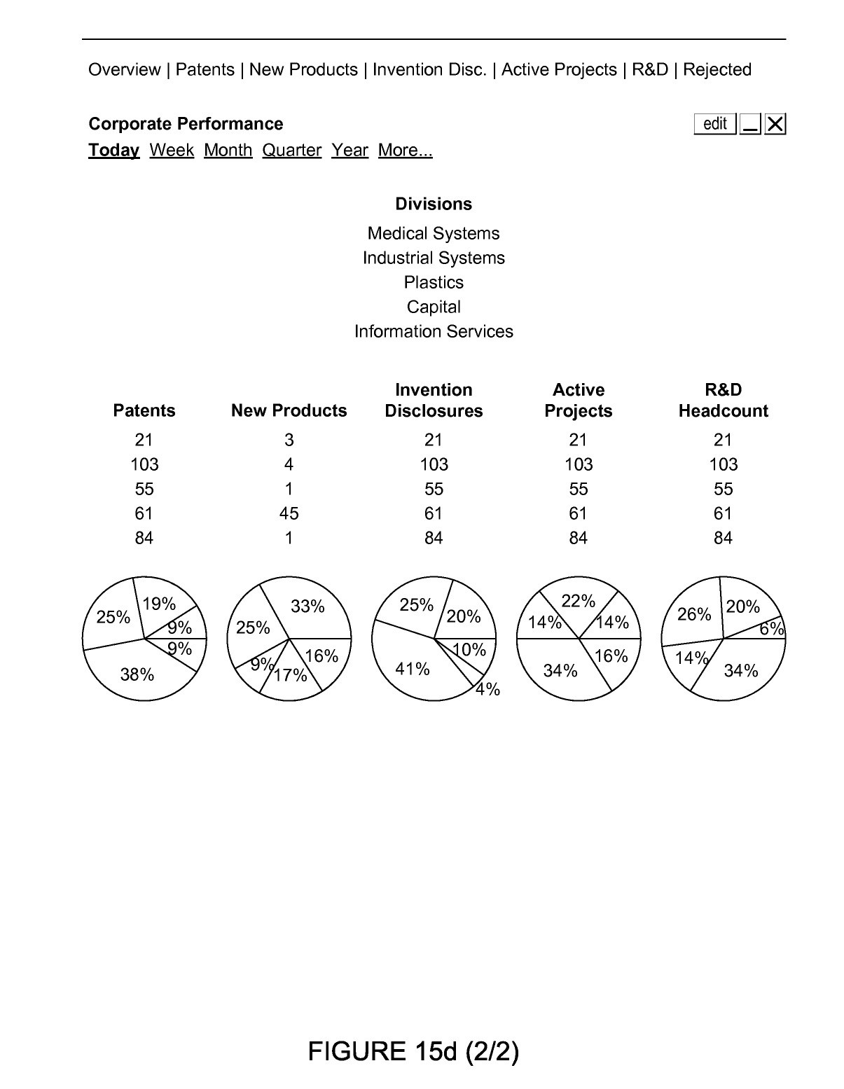

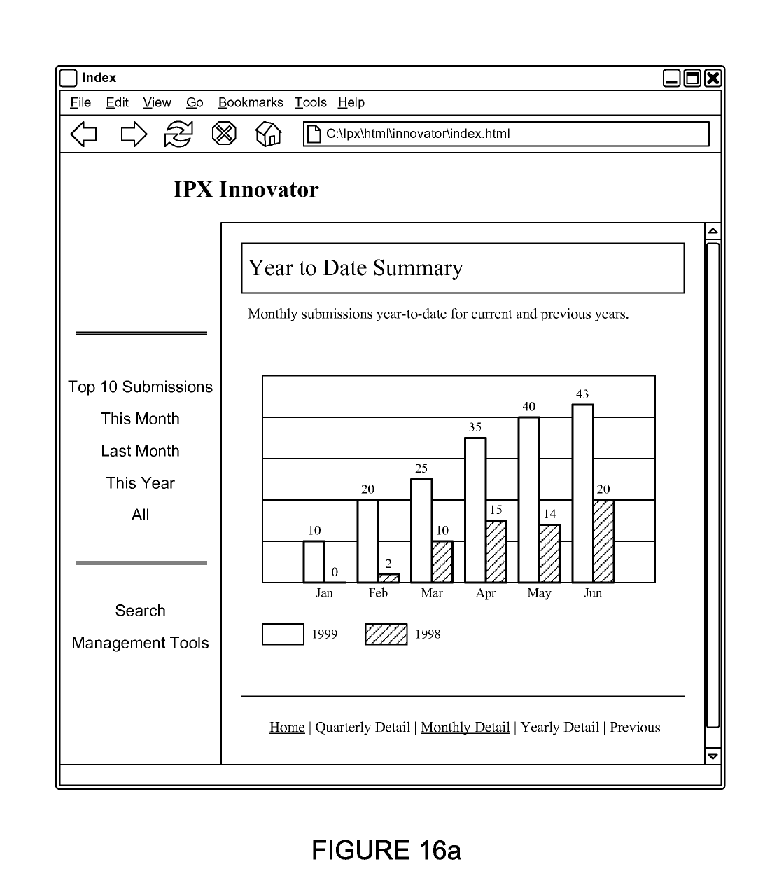

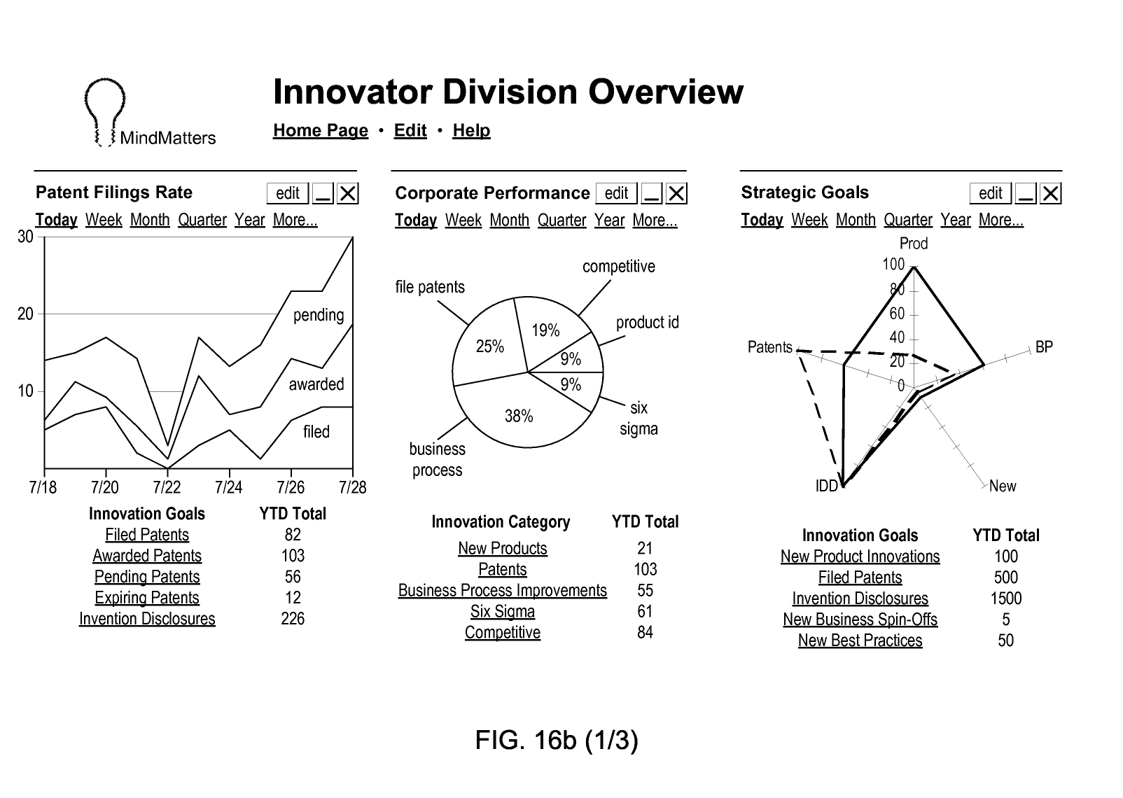

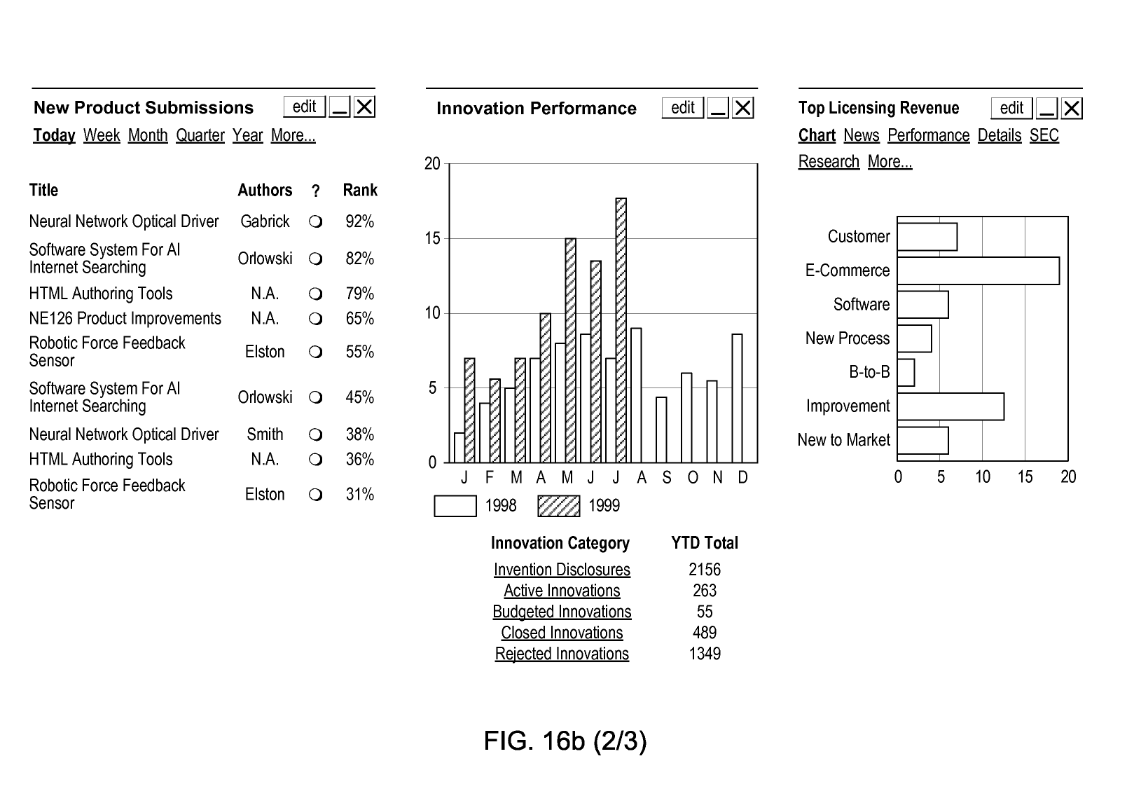

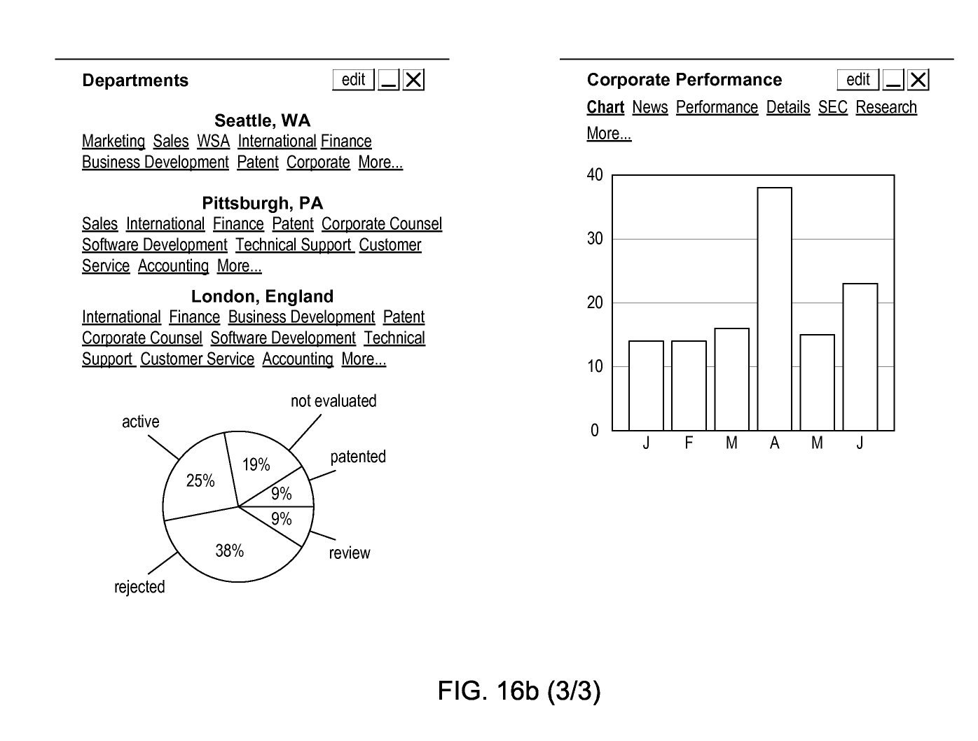

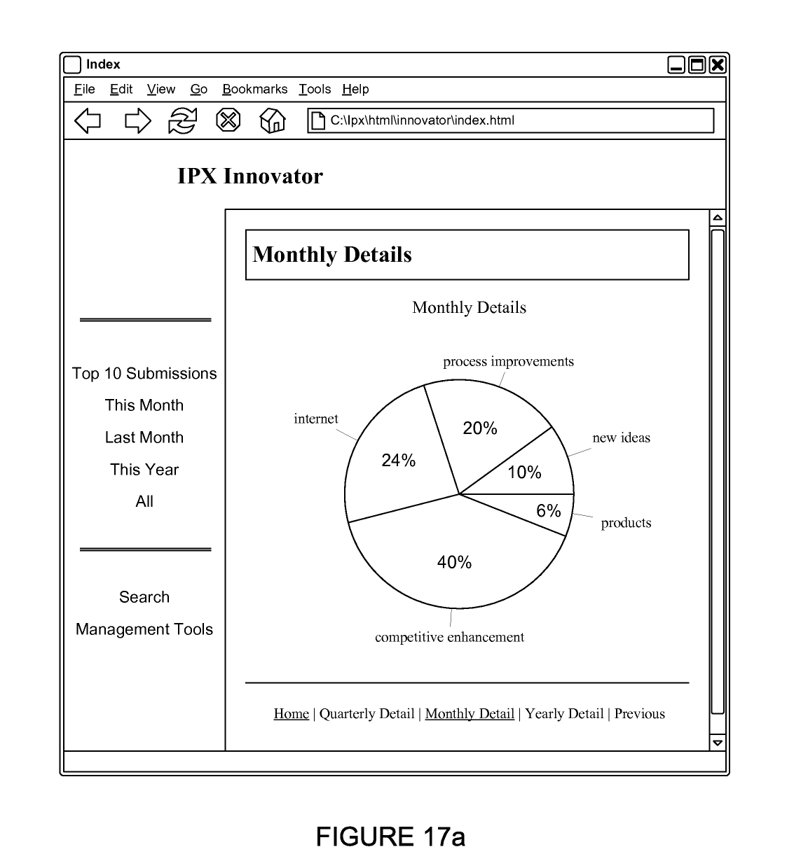

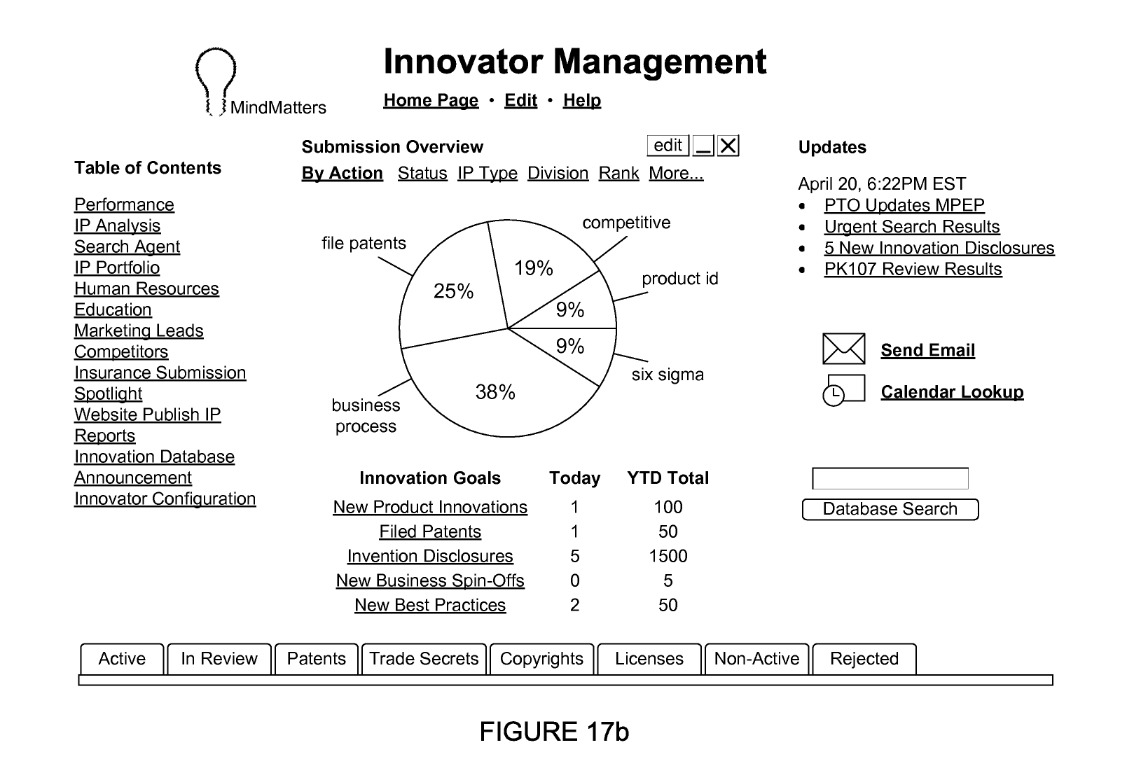

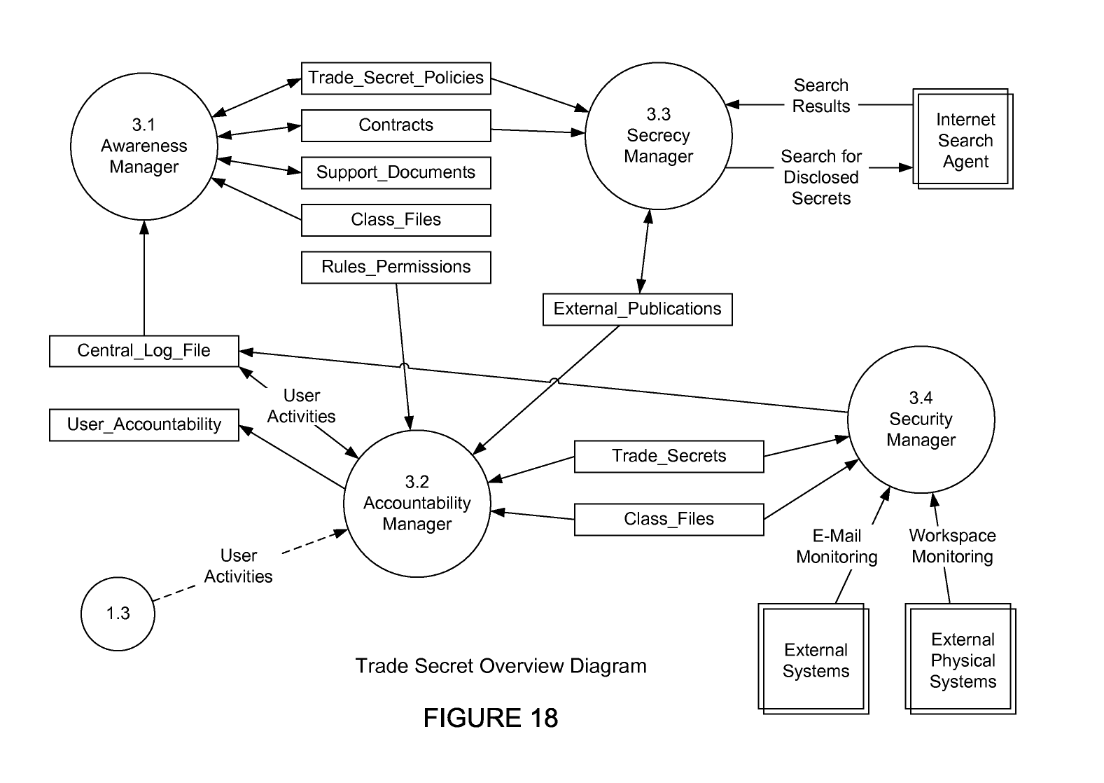

### BEST MODE OF CARRYING OUT THE INVENTION

### A. Innovation Management System (IMS)

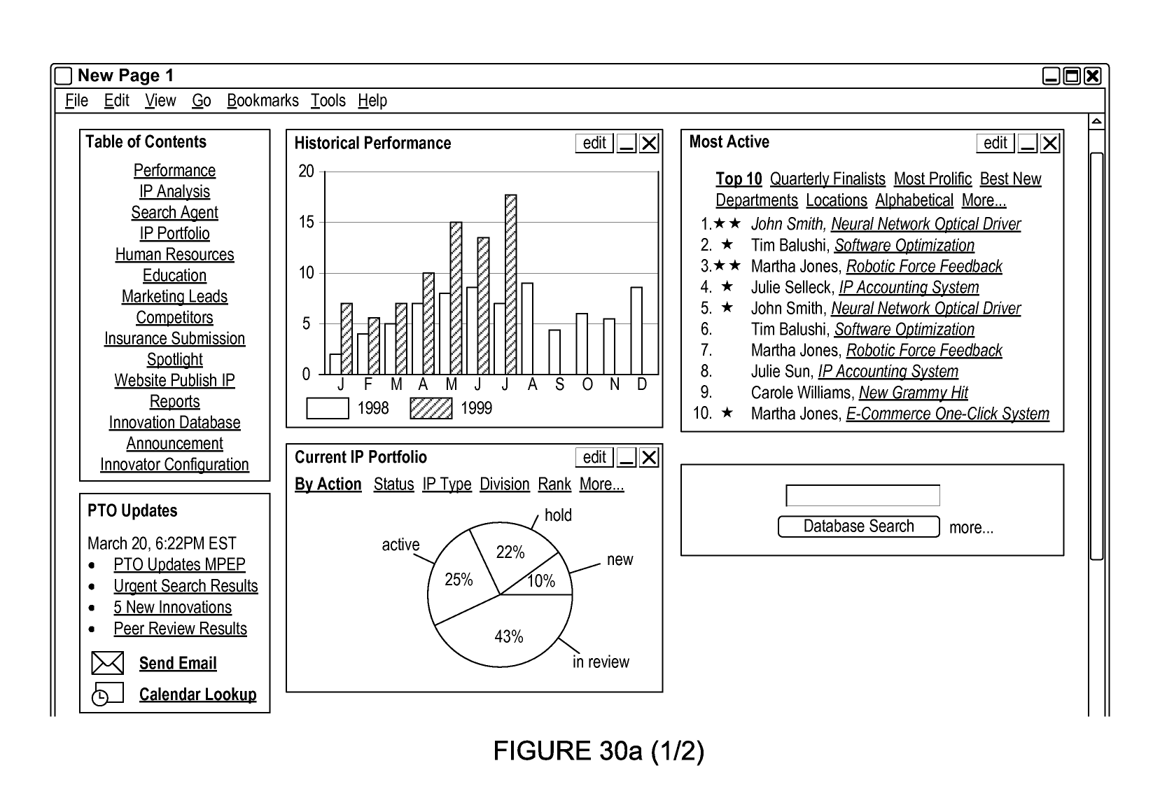

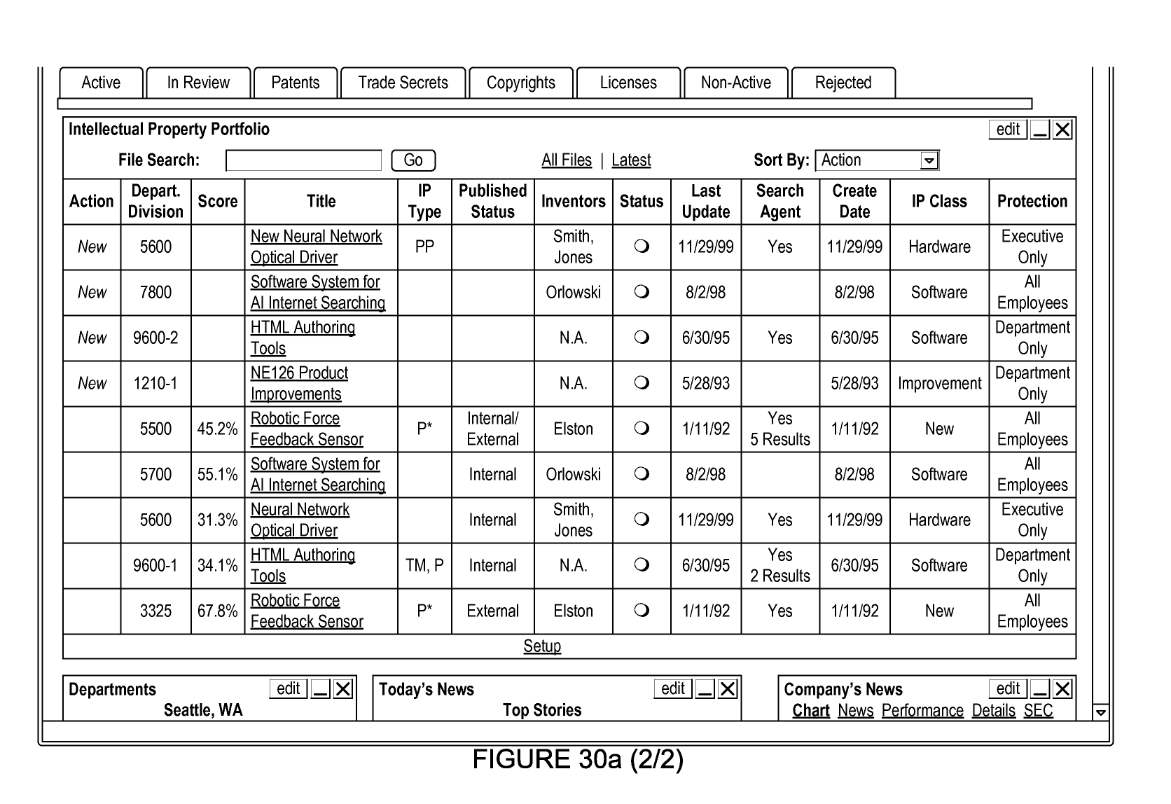

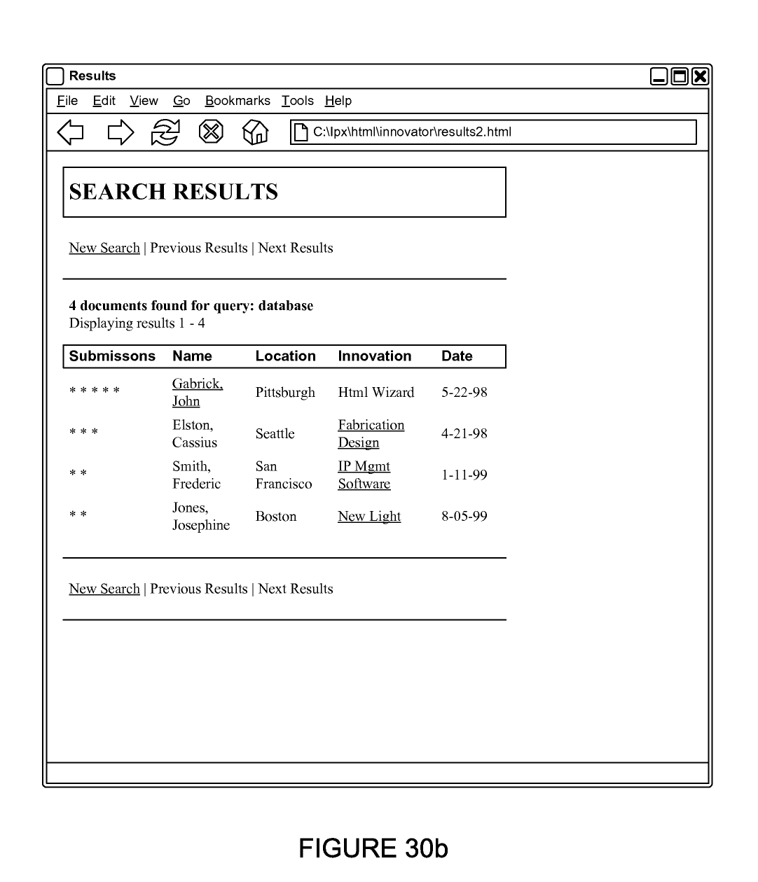

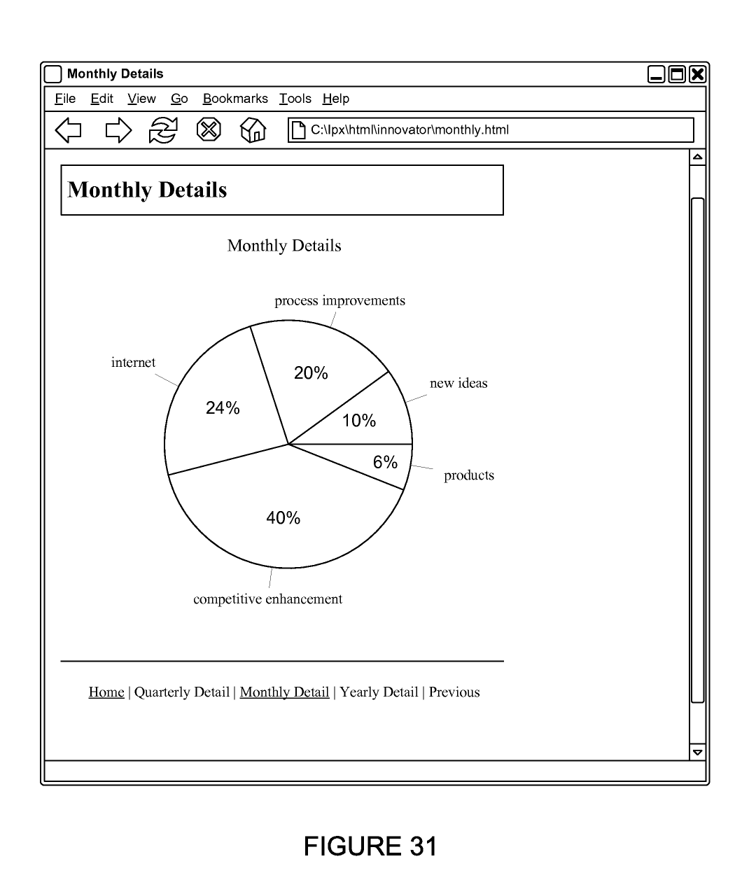

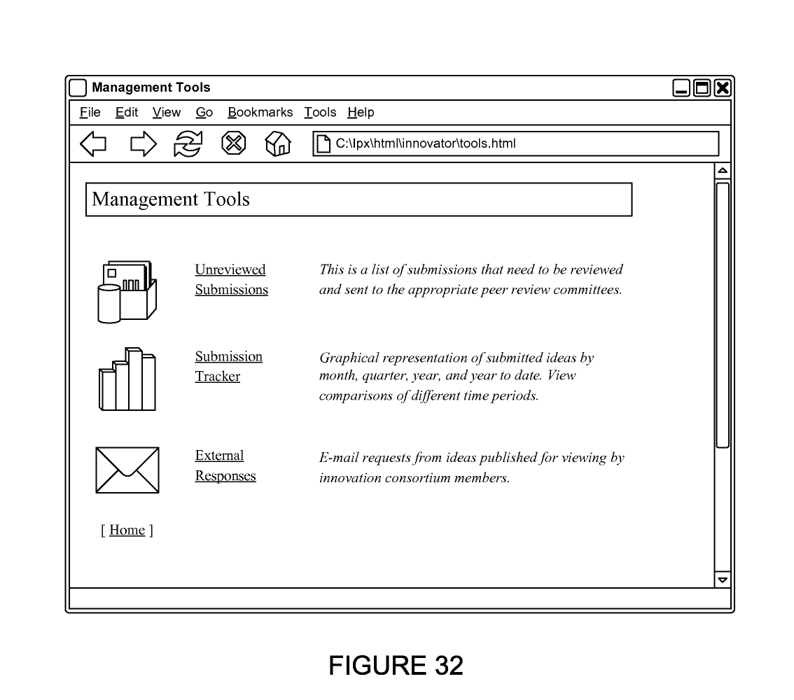

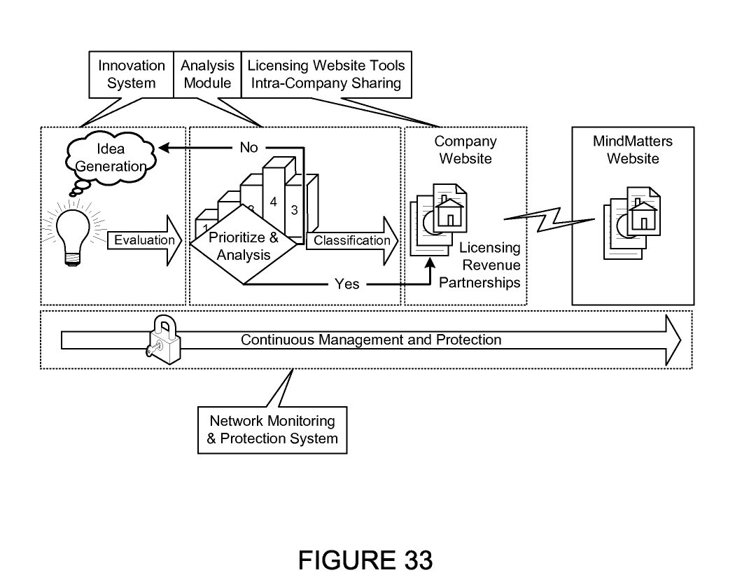

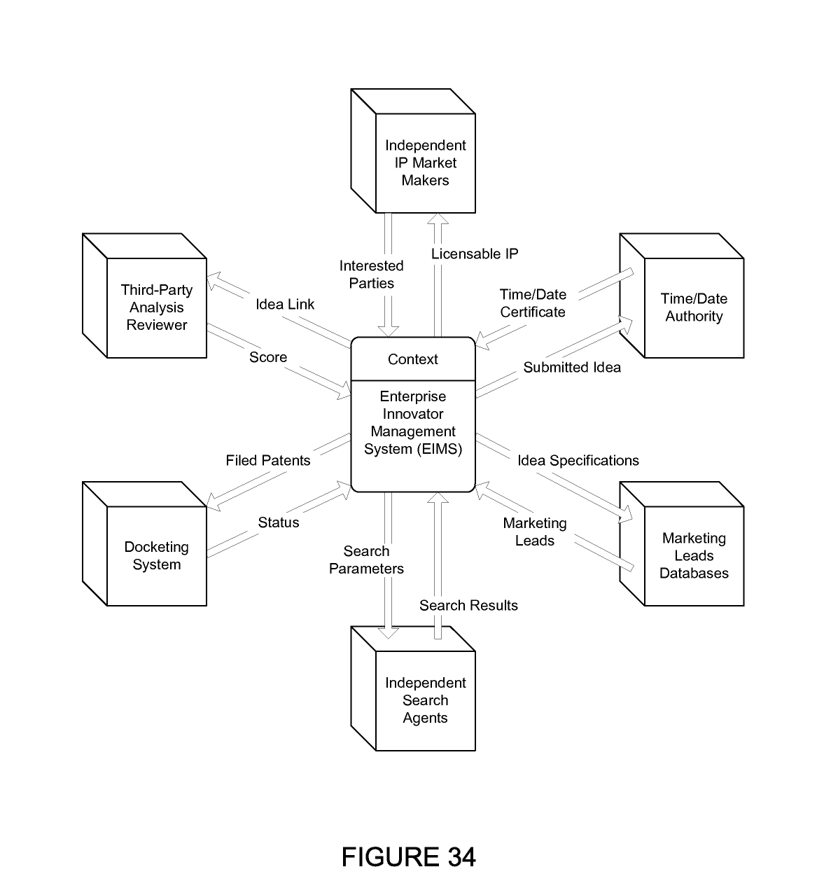

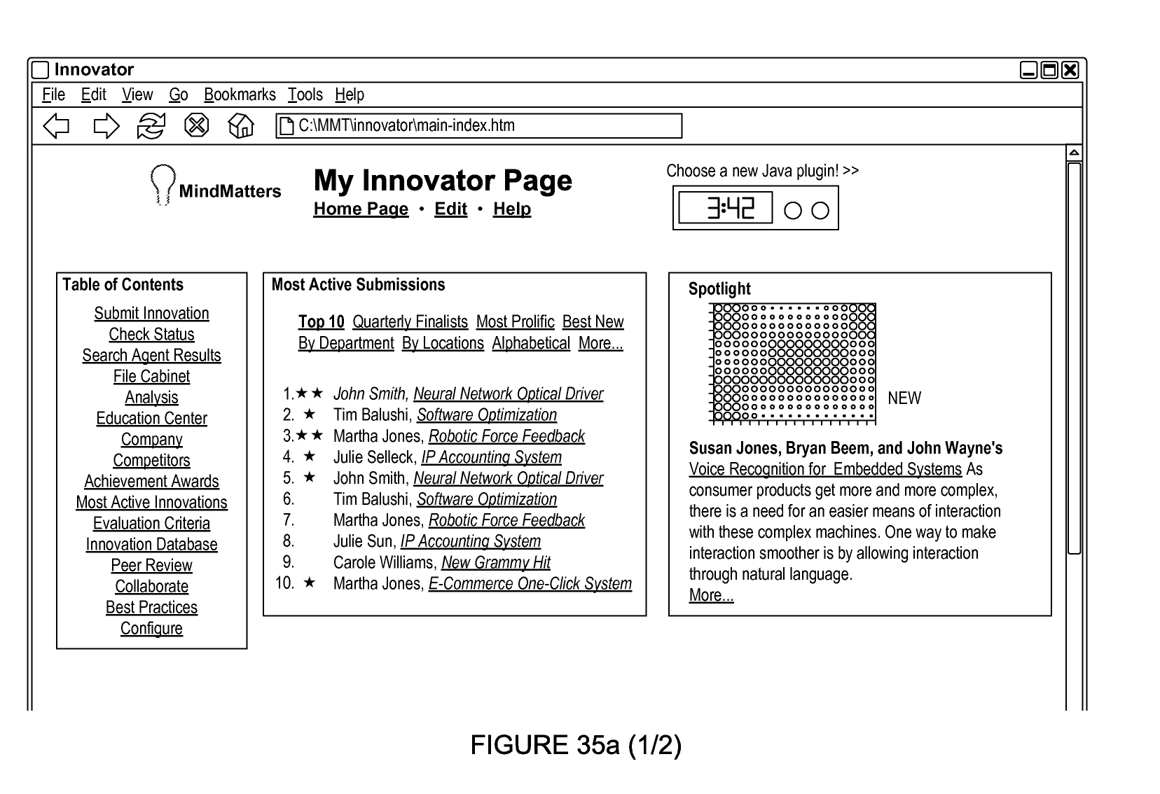

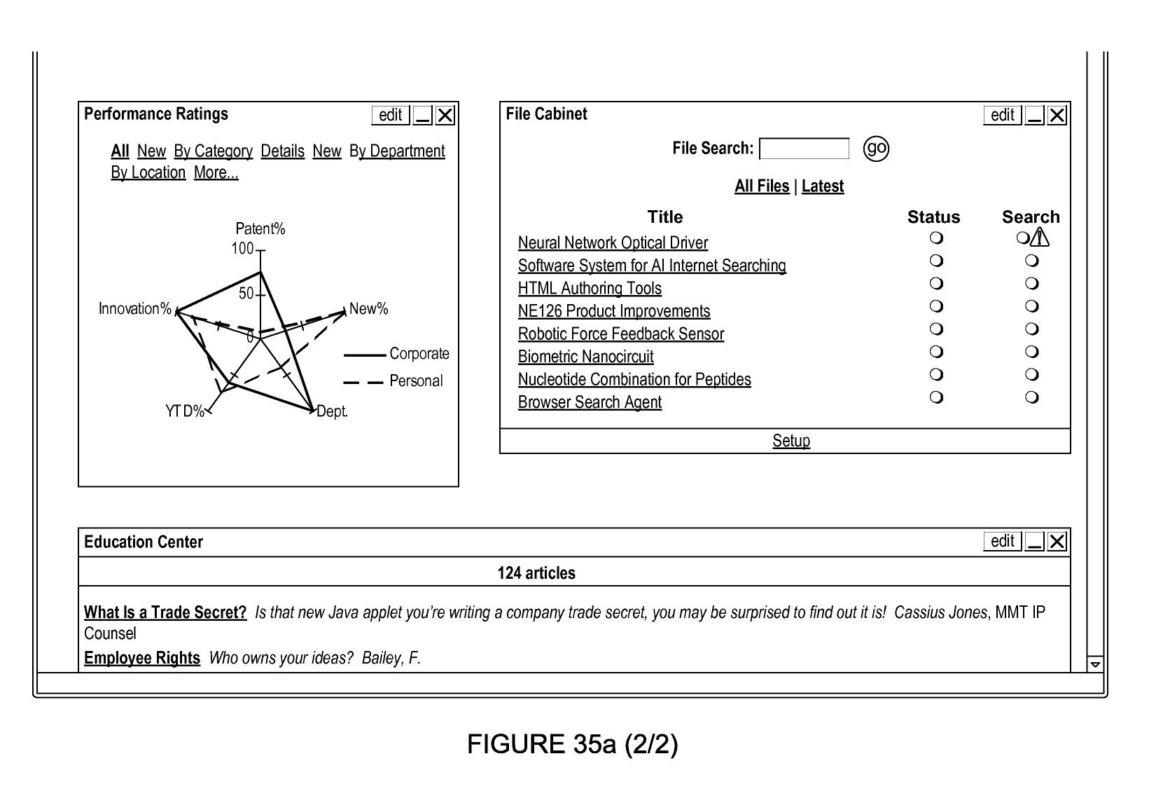

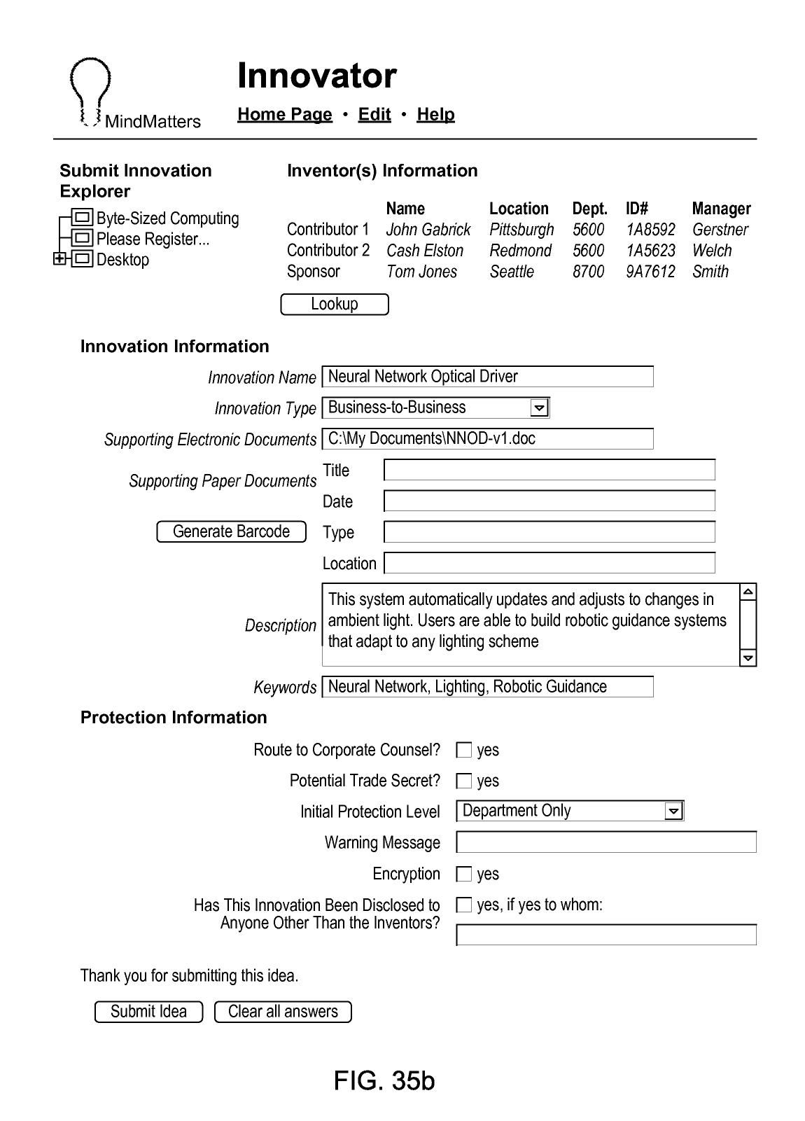

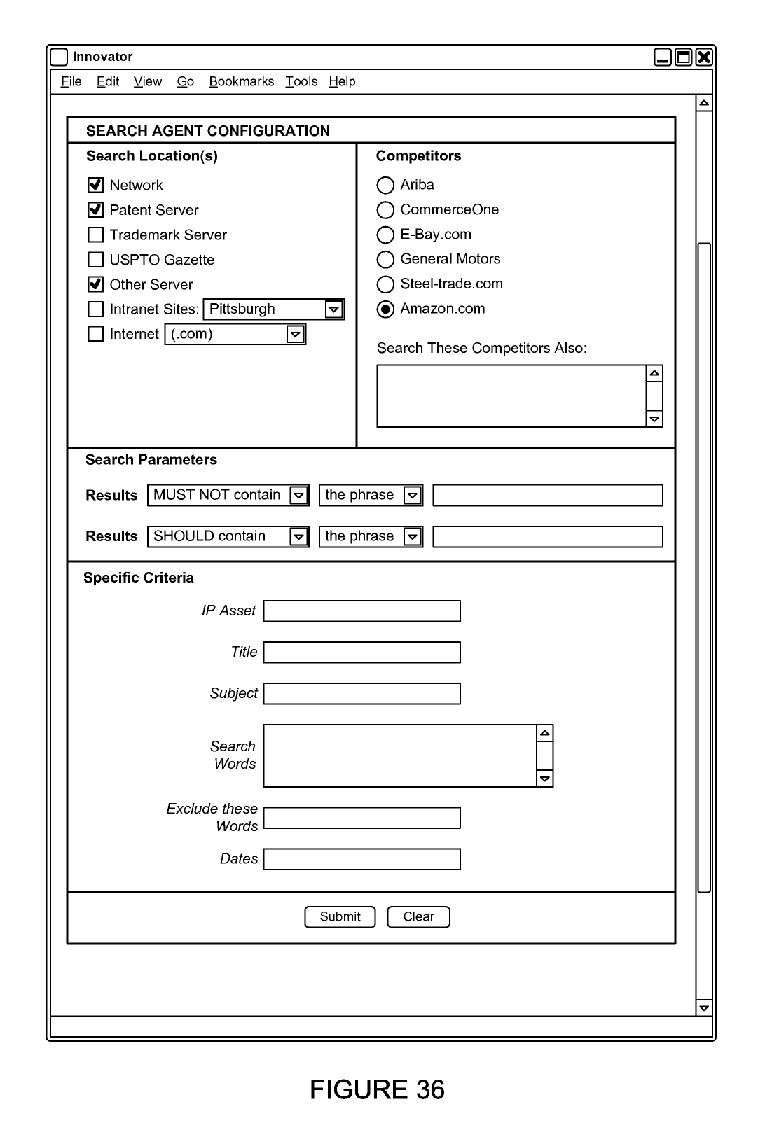

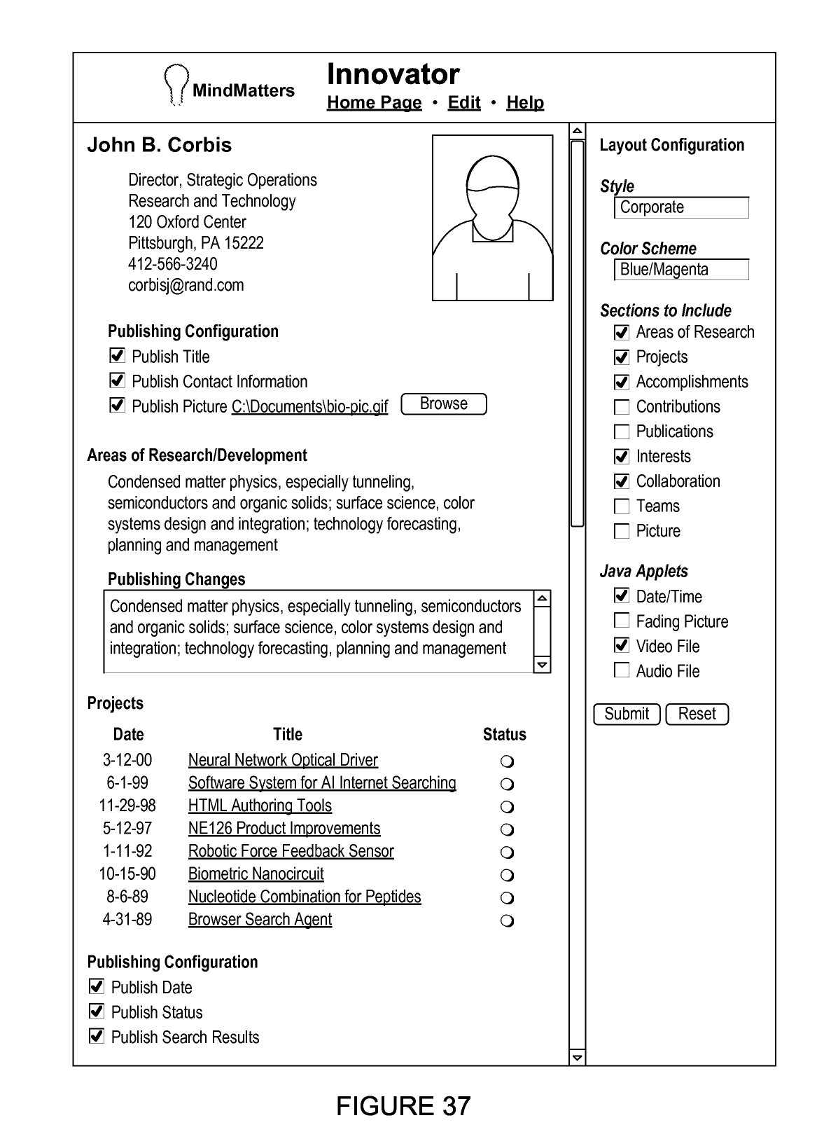

A.1. Innovation Quick Overview: This subsystem is the primary idea input system for the end-user. The main purpose is for the end-user to enter ideas into the system so that they can be “recorded” for other purposes. As an idea is entered, the date/time is automatically entered as well, and the user has the comfort of knowing that his/her idea has been officially recorded. Along with recording the actual idea (via spreadsheet, word processor document, etc), the user also enters pertinent information such as key words, descriptions, supporting references, pictures, department number, employee id, protection level, other authors, etc. Users are also able to search through previously recorded ideas (theirs or other peoples') before submitting an idea to see if their innovation is unique, or view the number of times other people have viewed their submissions. Users are also able to view educational news stories concerning corporate IP (or other configurable source; this is configured by the user). See FIG. 35a.
A.1.1. Configuration: This allows the Innovator to be customized by the user. The user can pick colors, skins, and java applets to personalize their space. Configuration also occurs dynamically, i.e., the user can change the placement of various tables and graphs.
A.2. Innovation Submission: This is the main submission functionality. It includes methods for attaching documents, entering ancillary data (dept. number, key words, etc.), the amount of time spent generating the idea, and references. After an idea is submitted, an e-mail message is automatically sent to the user (as verification) and to the user's immediately supervisor. The system can be configured to send e-mail messages (or hard copy printouts) to any number of peers, groups, or managers. E-mail verification is an important step in the trade secret process. By sending an e-mail to the manager and/or IP department, a determination can be made as to whether the innovation is to be classified as a trade secret or patent protected, or whether it should be deleted. The user is notified of any change in status via e-mail so that any discrepancies can be challenged. Ideas that are successfully submitted are available for viewing in the user's file cabinet.
A.2.1. Paper-Based Submission: For ideas that may need to have paper-based documents submitted, this functionality addresses the situation. The user makes a notation in the system, i.e., title, date of the paper document, then the system generates a unique barcode to affix to the document for tracking. From them on, the document is associated with the idea and is tracked by barcode.
A.2.2. Collaborative Document Submission: This duplicates the functionality of an innovation submission, but allows the user to submit “other documents” that might be useful for collaboration or sharing. The idea is that the more people are willing to share (if they get credit), the better off the organization is. See FIG. 35b.
A.3. Innovation Tracking: This records the date, number of times an idea is accessed and downloaded, and by whom it is accessed (including external viewing on via an unprotected location, see C.1). Data stored in other databases is managed via the FMS. As ideas are viewed, the AMS in conjunction with the FMS determine the level of protection afforded, i.e., encryption, visual warning, etc. This function also records the results of key word searches as described in the D3.3 and D3.4.
A.4. Innovation Searching: This function allows users to search the idea database for similar innovations or authors with similar ideas for collaboration. Searching can be based on key words, authors, dates, abstracts, or descriptive classifications. An important element of this search mechanism is that it allows searching in the internal corporate network (LAN/Intranet) as well as through external sources. Internal searches are augmented by searching network servers and repositories as well as through interfaces to document management/knowledge management systems. Internal results return the relevant matches as well as the person/team responsible for the match. External searches can be handled in two different ways, either directly by the innovator system through the company's network or via an external source, such as MindMatters. The importance is that a third party can perform a search without disclosing the identity of the entity requesting the information, this is particularly important when competitive searches are made. See FIG. 36.
A.5. Innovation Statistics: This function allows the user to view statistics on any ideas in the database. Statistics include: author, key words, date submitted, number of times viewed, number of contributions by the author, and viewing rank (the higher the number of times other people viewed the idea, the higher the ranking). If the idea has been submitted for peer review or the status of a review are also possible to see. If the company has an award program, statistics on this are shown as well. For example, if the a particular idea won “best new computer software”, then this accolade is shown.
A.5.1. Personal Statistics: This function allows the user to see his/her personal innovation statistics. This includes: personal home page hits, file cabinet hits, citations, downloads, collaboration agent hits, submissions, analyses performed, NDA citations, patents, Internet publications, licenses, and accepted submissions among other things. See FIG. 30a&b.
A.6. Innovation Reporting: This function presents all of the ideas in a summary manner. Managers are able to view the number of ideas submitted per individual, department, or division; the frequency of ideas submitted by day, week, month, etc.; the types of ideas by key word, area, etc.
A.7. Publish Biographical Information: Generates an automatic home page based on previously entered data, network user information, file cabinet data, and user input. See FIG. 37.
A.8. Relationship Manager: This is a mechanism for increasing person-to-person communication and networking within large networks, i.e., corporate, Internet, intranet. With a large number of people in a network (physical or electronic), it can be very difficult to locate people within the network who others can collaborate with in various development and marketing initiatives. When locating others within a particular network, a person may be trying to find complementary skills/experiences or similar skills/experiences. For example, in some large corporations, it is nearly impossible to locate all of the pockets of work associated with Java, pervasive computing, or semiconductor research. Although many of these environments have various internal stratifications, countless organization charts, re-organization efforts, and databases, the most common method employed is word-of-mouth or random hit-and-miss calls using one of the aforementioned information sources. Most of the titles and job responsibilities are either out-of-date or meaningless. There are several observations of the current situation:

People “network connectivity” is based on seniority in the corporate environment and on submission of data to search portals, not skill, capability, or interest.

Organizational turnover creates people-network gaps.

Duplicated effort results from uncoordinated pockets of activity, such as sales people from different departments talking to the same customer.

Lost productivity spent meeting with the wrong people, a critical misstep since today's marketplace demands increasingly faster speed of execution.

There is no “trust” factor. It is difficult to assess whether a person is credible, honest, or representing themselves properly, particularly on the Internet, but also to some extent in corporate environments.

People need a motivating mechanism in order to keep personal data updated

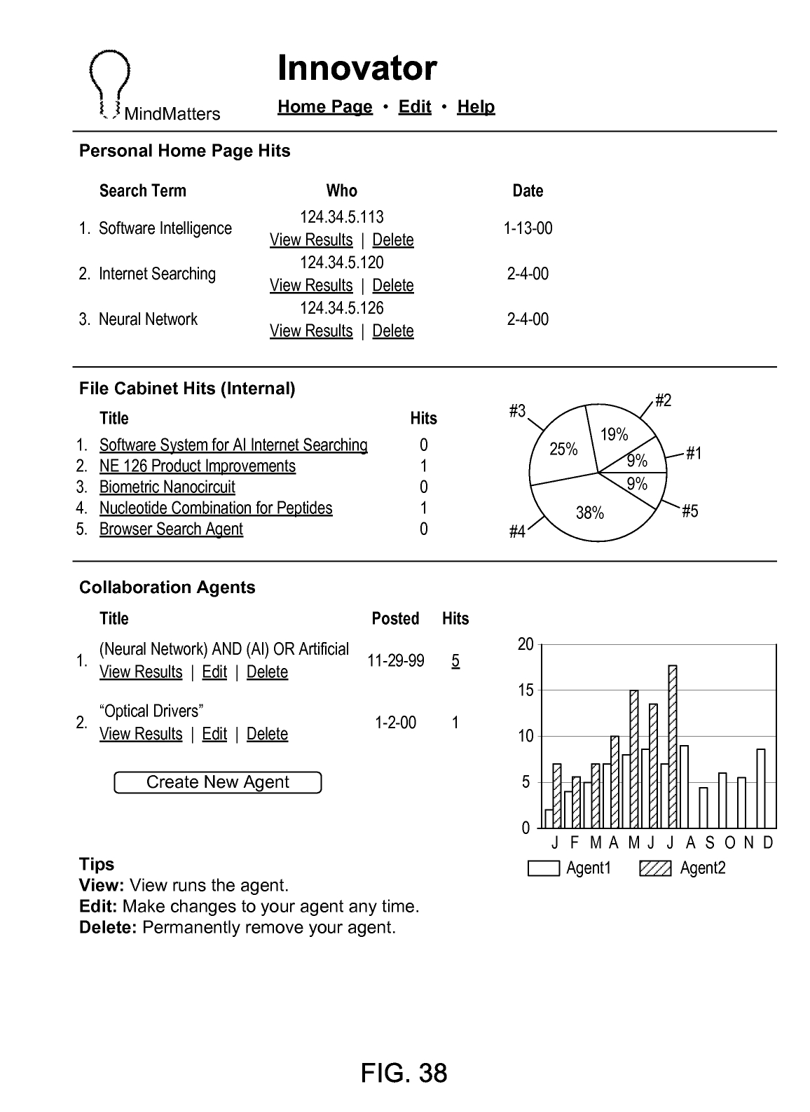

A.8.1. Collaboration: This function allows the user to submit new collaborative agents, check on the status of “hits” to his/her file cabinet, and check on the status of “hits” to his/her home page. It is important to note that this collects metrics that are used to determine the “value” of an idea. For example, if a particular person's innovation has received many “hits” from other users, then that is a good indication that the innovation has created value for the company. See FIG. 38.
A.8.2. Agent: Users can enter search agents into the system. Each agent, which can be terms that are either related or unrelated to the user's innovations, scans the systems new submissions and home pages for key words. If located results are posted for later viewing. The agent searches both current and archived innovations, document management systems and home pages.
8.2.1. Automatic: This function builds a relationship profile based on the user's department, title, and file cabinet. This is supplemented by the user and available to the search engine.
8.2.2. Custom: This function allows the user to build their own profile. It includes fields of interest, title, department, research areas, etc.
A.8.3. Home Page Hits: This tells the user what other agents have found his/her home page as a source. So, if another user's agent finds my home page, then I am notified for follow-up as well.
A.8.4. File Cabinet Hits: Similar to above. If another agent finds used my file cabinet submission as a source, then I am notified.
A.9. NDA Tracker: This module allows the user to enter and track NDAs. Users enter time/date, attendees, document number, and company name as well as any IP that was disclosed. The system can generate an automatic NDA if necessary. These NDAs are linked back to existing IP.

### B. Analysis/Ranking Module

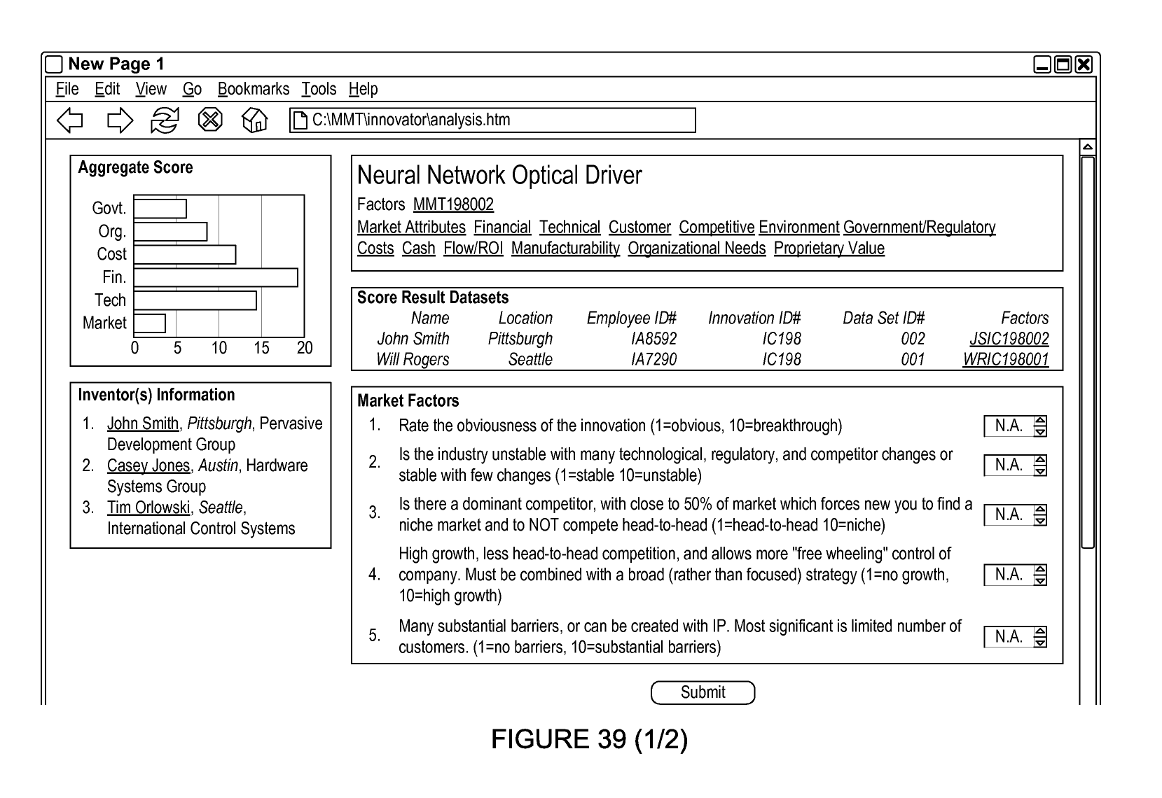

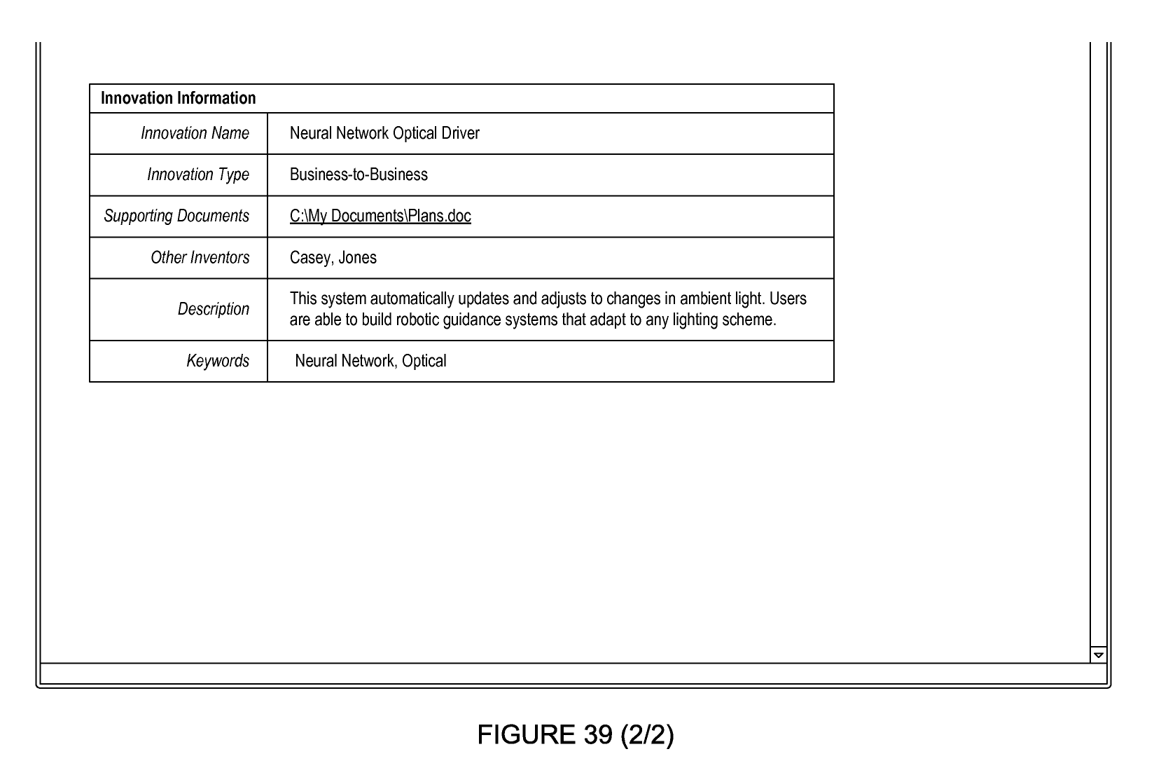

This set of tools allows peer groups, IP counsel, or other trusted sources to rank and prioritize innovations that are entered (either through the Innovator or manually) into the system. The power of these tools is highlighted in their ability to quantify both objective and subjective measurement criteria. The rankings are aggregated and weighed relative to the company's strategic objectives, that is, a company can decide that financial factors such as development expense or ROI are more/less important than customer-relationship factors such as new product introductions or quality. Once ranked, innovations can then be compared against each other and scientific judgments can be made regarding level of investment. See FIG. 39.

B.1. Collaboration: This functionality allows external/internal users to be automatically notified that they need to add their analysis of a particular idea. Notification can be automatically configured based on users' preferences, i.e., if I am an expert on neural networks, then I get notified automatically should any ideas in this topic area become available. Optionally, notification can be manual, where a link is sent to the desire person. The link is active and allows them to instantly access the analysis/ranking functions for that particular innovation.
B.2. Innovation Rating/Analysis: This functionality allows for the rating and prioritization of ideas/innovations in addition to files. This functionality includes entering idea descriptive information, rating the ideas according to the method defined below, and comparing the ratings of all ideas to determine the best places to make investments. As part of the analysis process, analysis requests are sent to independent people for valuation.

### B.2.1. Rating

2.1.1. Rating Factors: this allows the user to enter the rating factor categories. After all categories are entered, the user can determine the relative importance of each factor with respect to goals, costs, or benefits, etc. The relative importance is determined by using the pair-wise comparison technique. Different importance ratings can be saved, for example, one set of ratings might be used for healthcare ideas/innovations whereas another might be used for semiconductor innovations.
2.1.2. Rating Factors Variables: For each rating factor category, multiple questions/variables can be entered for evaluation. For example, for a rating factor of technical merit, the variables might be 1) difficulty to reproduce and 2) cost to reproduce. Variables are structured such that a numerical value can be entered or that a numerical value can be inferred, i.e., 1=bad, 10=good, or little=1 and large=10. Initially, these variables each receive equal weight, however, functionality to rate the relative importance of each of these variables is optionally contemplated.
2.1.3. Calculate Index: Based on the ratings of the individual variables, the index is calculated as follows: sum each category on a base of 100, then multiple that answer by the rating factor relative importance.
2.1.4. Comparative Analysis: In addition to rating innovations by absolute factors, they can also be ranked comparatively. In this manner, innovations are ranked relative to other user-selected innovations, i.e., Idea A versus Idea B. Even though ideas are ranked relatively, they are stilled assigned a numerical score based on the difference between the two ideas. In this case, a score of 5, for any particular factor indicates no difference between Idea A and Idea B, a score of 1 ranks Idea B much worse compared to Idea A, and a score of 10 indicates that Idea B is much better than Idea A.
2.1.5. Qualitative: As another ranking/analysis alternative, the user is given the option of adding non-quantitative measures as well. This is preferably manifested as a simple comment field, or a discussion of the relative merits versus competitors among others.
B.2.2. Routing: After the author has performed his/her analysis, links to the analysis web page can be sent to people for independent analysis. The author has the ability to pick from an IMS-generated list of people with the expertise required to send the analysis request to.
2.2.1. Analysis Valuation Points: People who are selected for an analysis request are awarded valuation points.

### B.3. Valuation Manager:

B.3.1. Citations: Capability to relate new documents to previously generated documents. When a new innovation is submitted, there is an opportunity to list references. These references generate valuation points for the original author(s).
B.3.2. Searches/Hits: When a database search or collaboration search returns hits, these hits generate valuation points for the original author(s). The hits must be from unique users and the valuation is based on the relevance of the hit, i.e., if the hit is 65 out of 100, the valuation is lower than if the relevance was 3 out of 100.
B.3.3. Downloads: When a person actually downloads or views a returned “hit” then the original author receives valuation points.
B.3.4. NDA Tracker: IP that is listed within the context of an NDA also receives valuation points.
B.3.5. Analysis: The results of the analysis in B.2 above is another component in determining the overall valuation. Optionally, the people who perform the individual analysis are scored according to their total relevancy points. For example, if a person is recognized as the premier expert in a discipline, then that person's valuation has more impact on the overall score.
B.3.6. External: This assigns valuation points for Internet publications, hits on the Internet, and licensing of an innovation.

### 3.6.1. Internet Publication

### 3.6.2. Licensing

B.4. Accounting Analysis: This function accommodates the financial analysis of an innovation.
B.5. Innovation Marketing: This function provides marketing information to the user. Since information on innovations/ideas has already been enter through other parts of this system, this information can be properly formatted and then sent to third party databases for marketing leads. At these third party sites, marketing leads are automatically generated based on the input from the MMT system. Additionally, the user can add/modify information associated with an idea before it is sent so that a more complete marketing framework can be constructed. When the leads are returned to the system, this function automatically aggregates them and presents them to the user so that they can be used for follow-up, i.e., direct mail, phone, e-mail. Leads are annotated and tracked and can be exported to third-party contact managers.

### C. Licensing Web Site & Intra-Organization Sharing

C.1. Innovation Exchanger: This function allows certain classes, key words, etc. of ideas to be published to an externally (unprotected) viewable location. The purpose of external publishing is to foster the development or use of ideas by other entities. By publishing basic information such as brief abstract, application area, and key words, along with a unique id, external viewers can read the briefs and determine whether a particular idea is worth following up. If an external viewer was interested in gathering more information, he/she can click a button that automatically sends the ID number in an e-mail to the corporate IP (or other) department for consideration. This function records the exchange of e-mails concerning the innovation.
C.1.1. Internet Publisher: This function allows the user (providing they have correct access) to submit an idea for publication on the Internet. This is either on the organizations external Internet connected site or to the MMT Internet site. Users are able to select one or both, the date to publish, the duration to publish, expiration, contact point, and what types of information are to be made available, i.e., inventor's name, potential applications, category, score, etc.
C.1.2. Organization Intranet Publisher: This function is identical to C.1.1, however, it allows a separate configuration for internal viewing. Whereas a company may not want to have the inventor's name published to an external website, they may want it published internally.

### D. Network Monitoring and Protection System

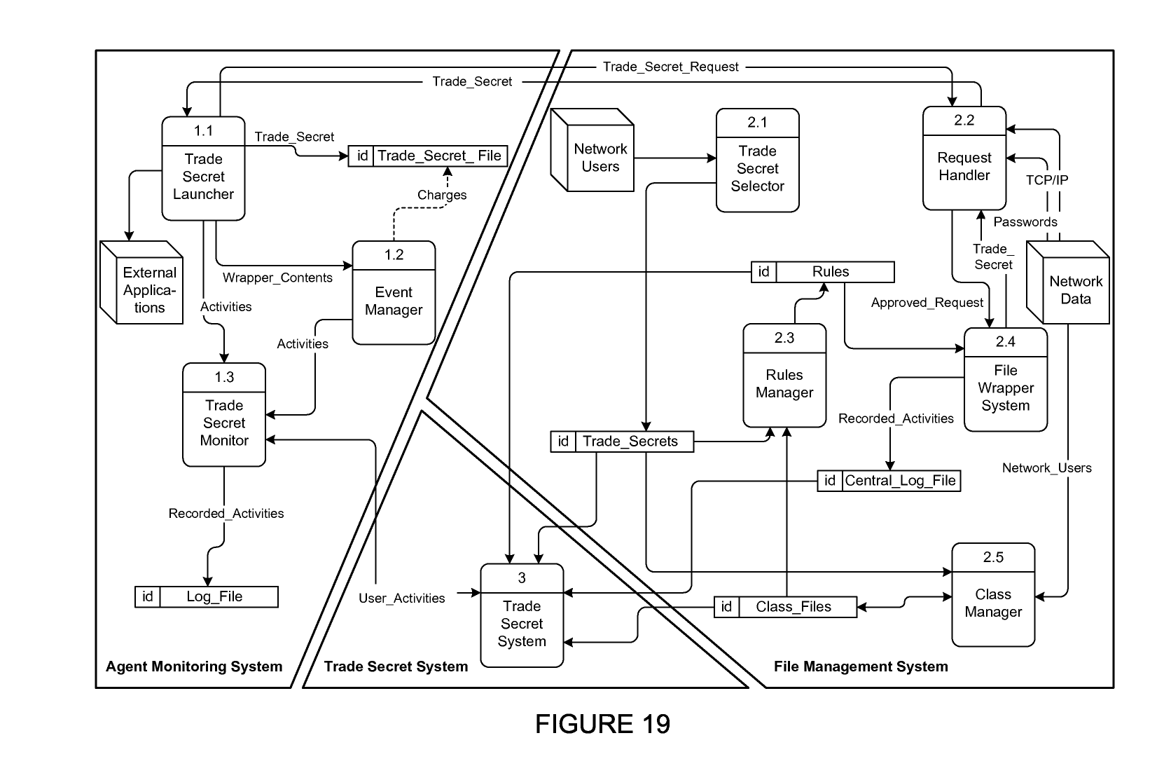

This Network Monitoring and Protection System preferably comprises some or all of three functional components: Agent Monitoring System (AMS), File Management Server (FMS), and a Trade Secret System (TSS). The system provides complete protection of trade secrets by defining what data is considered a secret, who is allowed access to the secrets, what type of access is permitted, and by enforcing policies for accountability, awareness, and security. See FIG. 19.

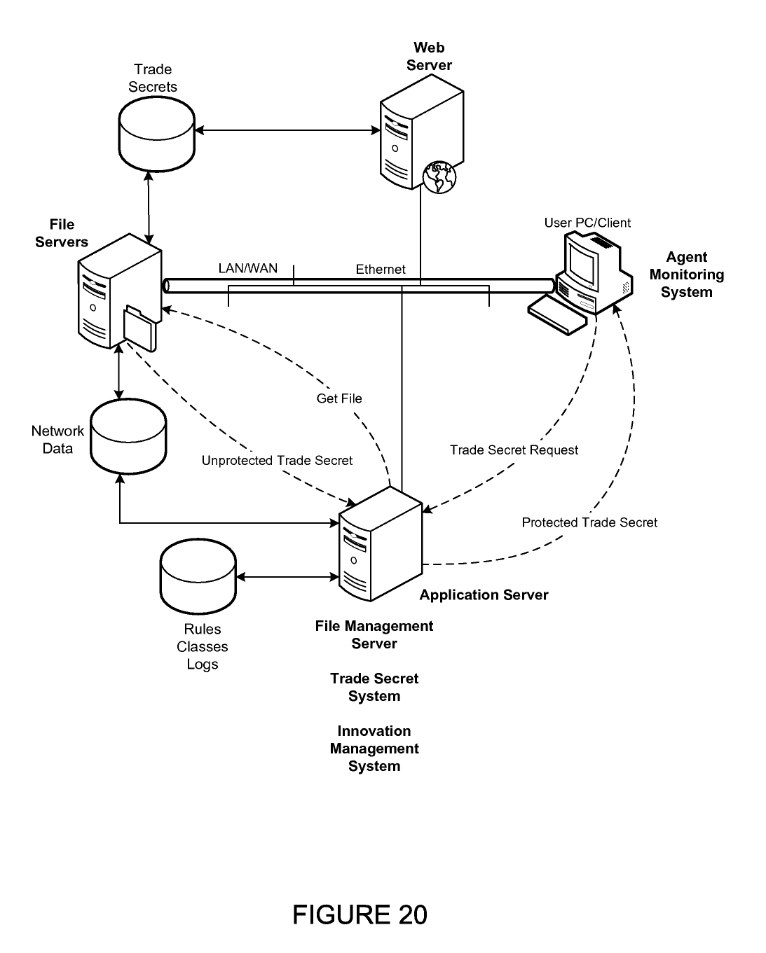

The system can be used in at least two different modes: either with or without the Agent Monitoring System running. In the former, the client PC makes a request through the AMS, and the file is returned from the File Management Server into this process. In this case, the AMS and the FMS communicate with each other and the File Management Server provides trade secrets based on all of the available rules. In the latter mode, any client can be used to access files on the protected server. In this case, the AMS and the FMS do not communicate with each other, instead the File Management Server monitors the trade secrets and applies the protections based on the rules which do not include the user. See FIG. 20. Other modes include:

Full Protection Mode: The AMS along with the FMS and TSS are all running. This provides the ultimate level of protection as the trade secrets are fully wrapped and are monitored on the PC/client.

Medium Protection: The AMS is not running, but the FMS is actively monitoring the trade secrets and is wrapping them with protections that can be employed when the AMS is not running. For example, the display of a visual warning, encryption, and password protection is available without the AMS.

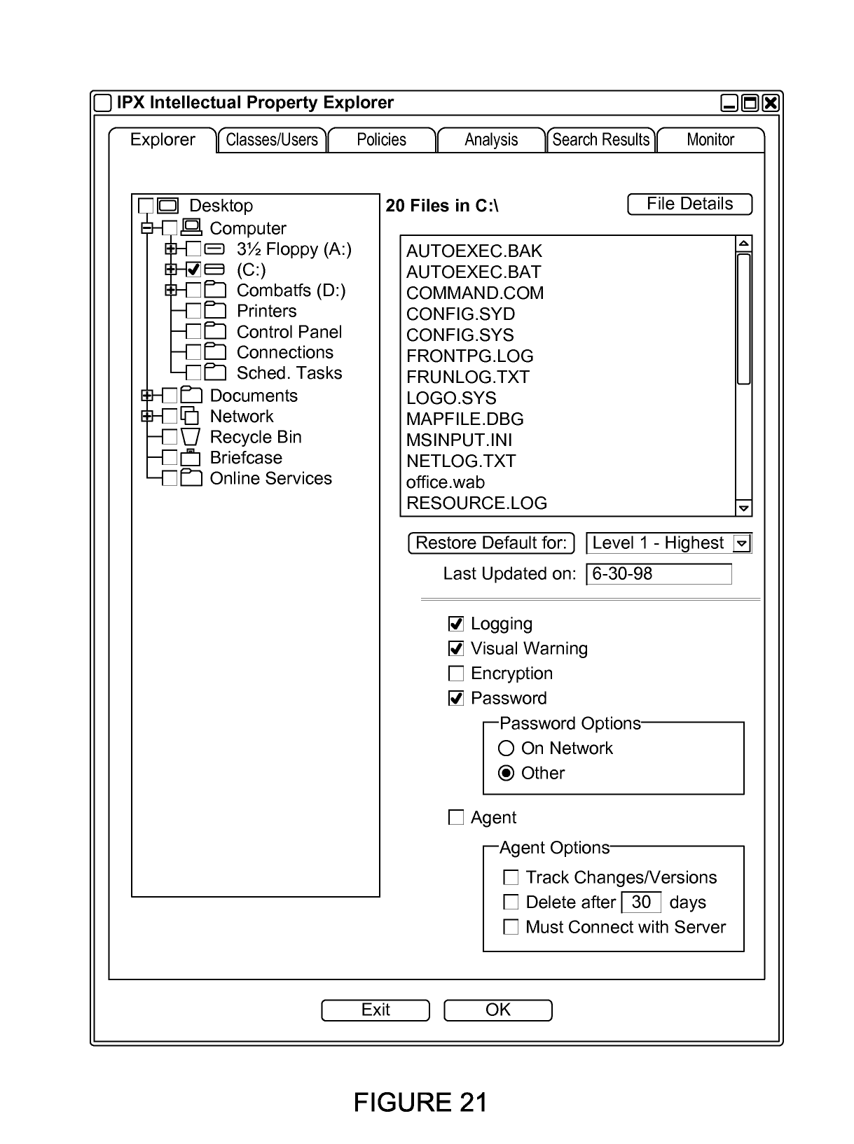

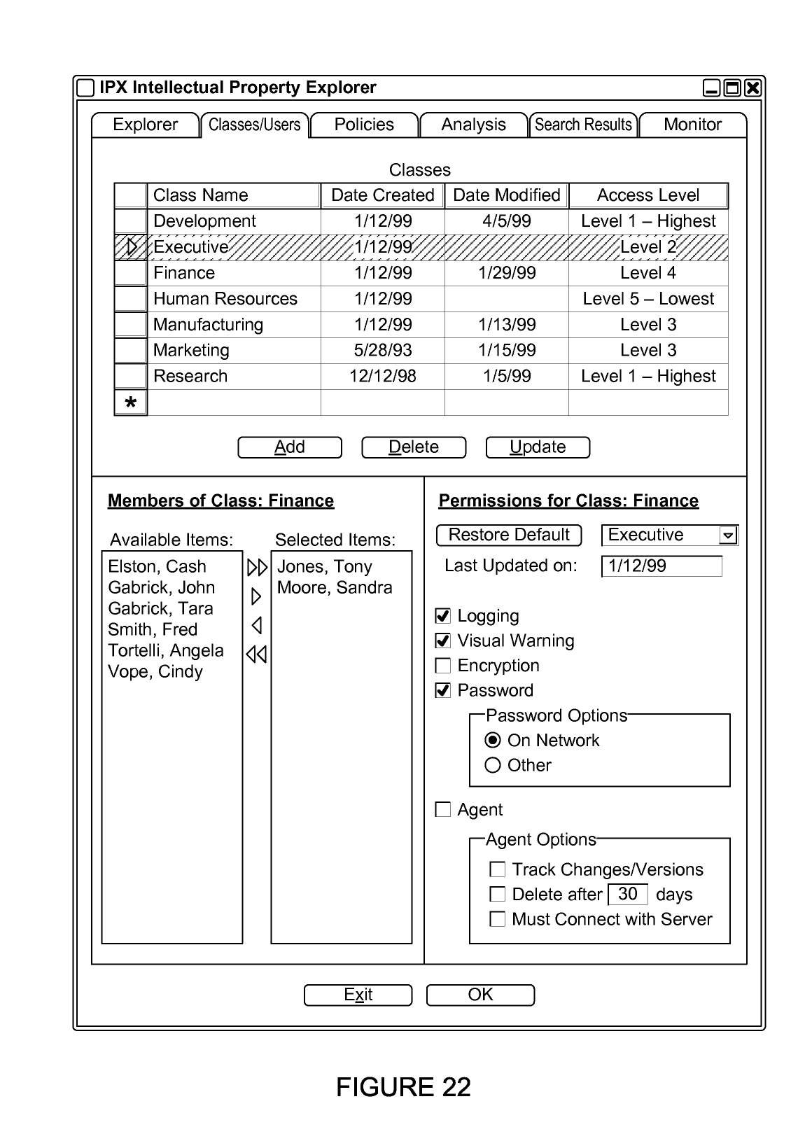

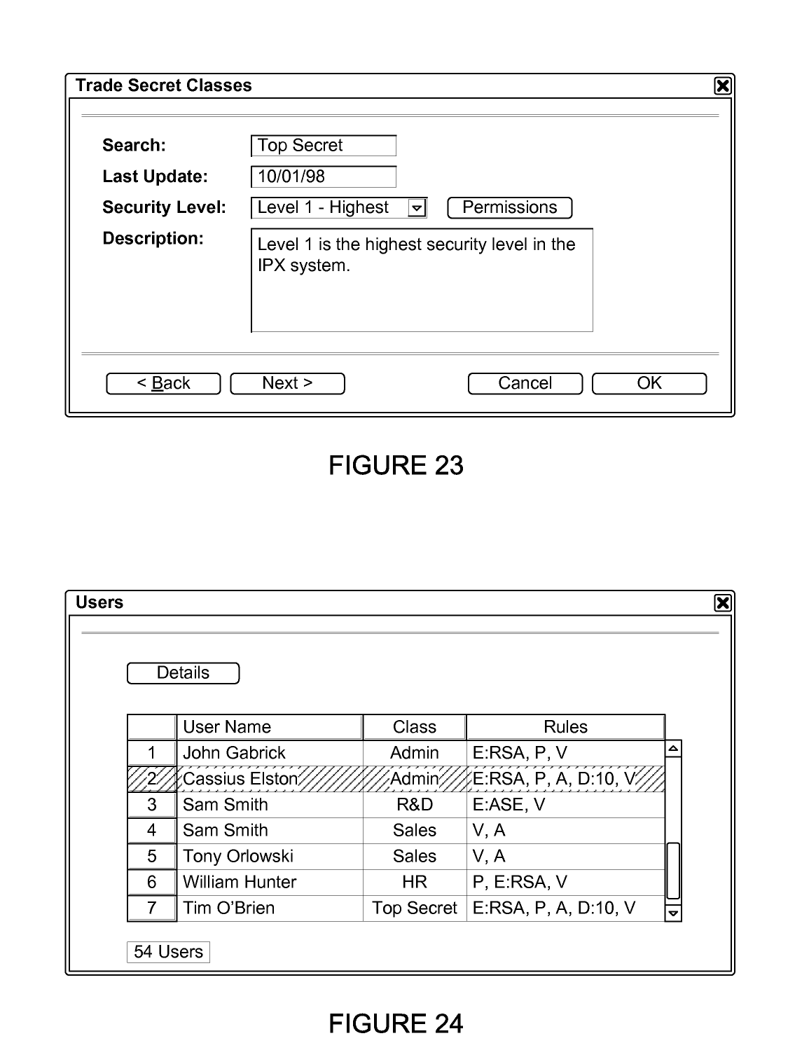

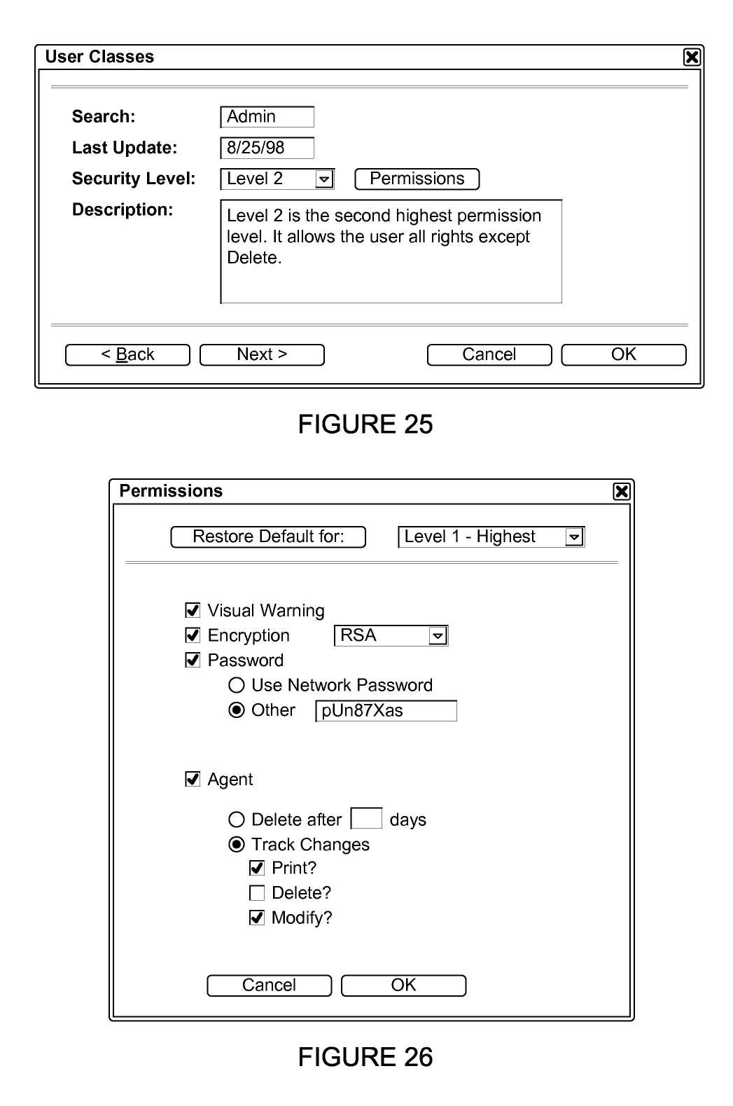

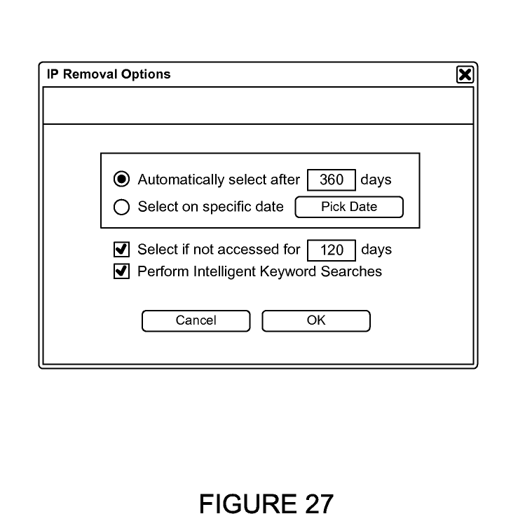

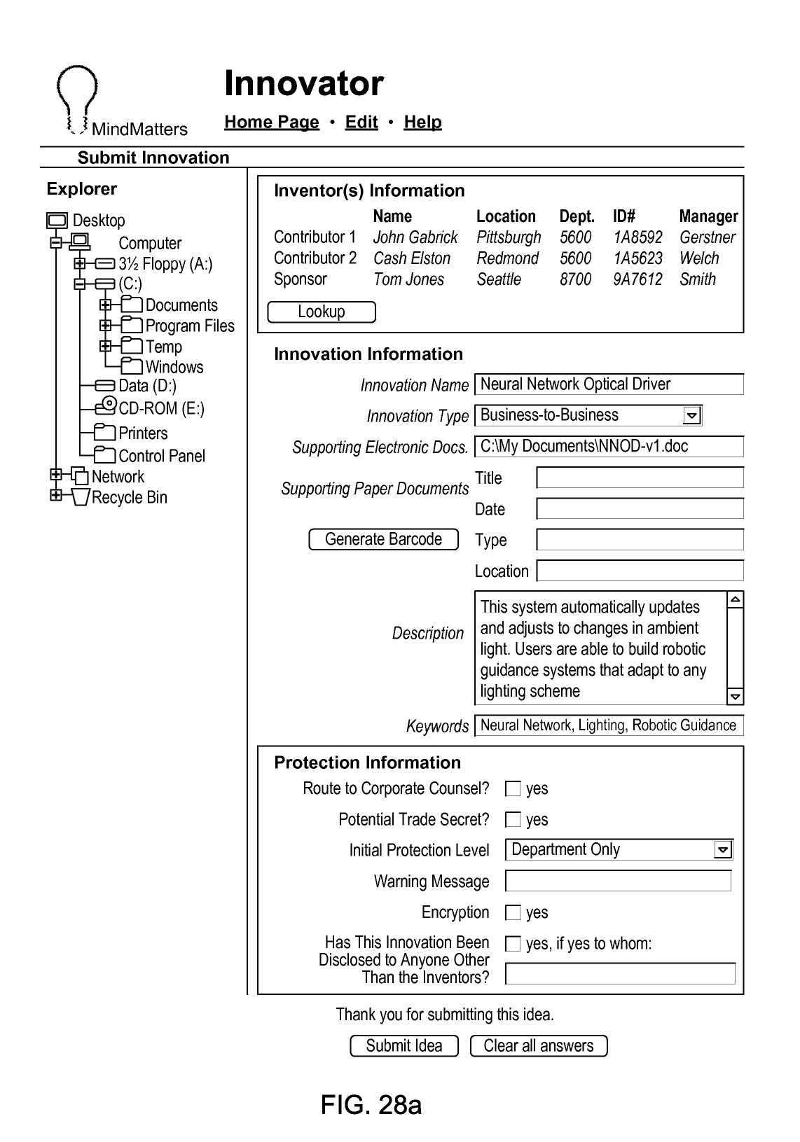

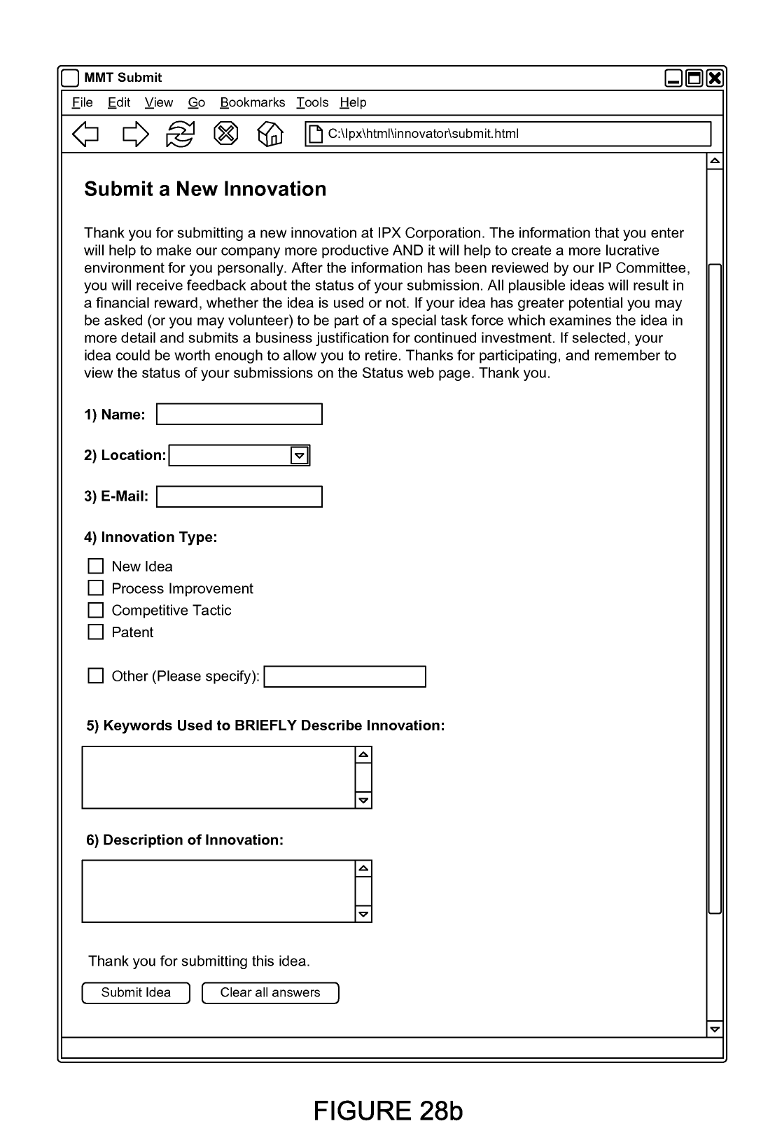

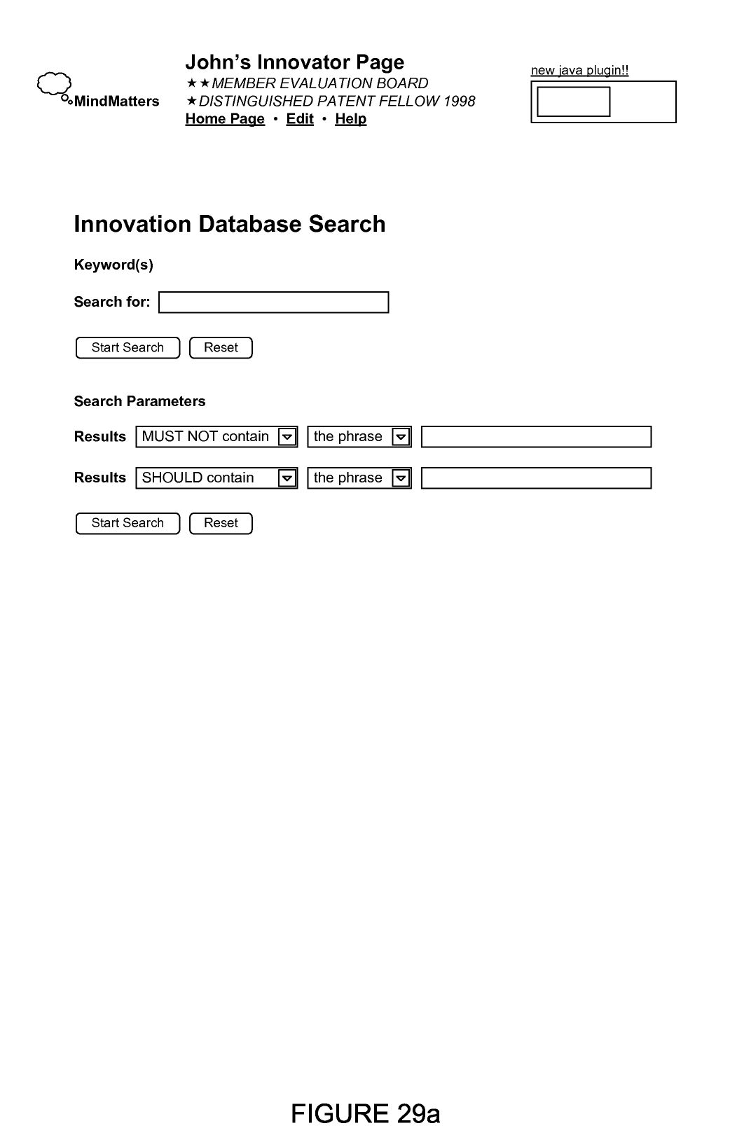

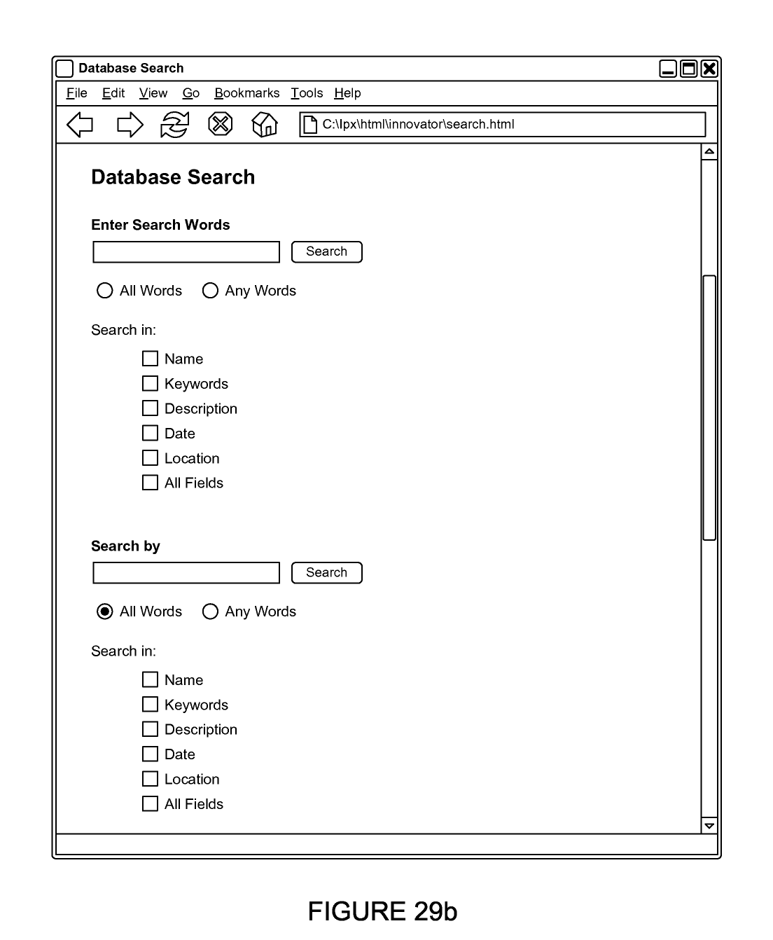

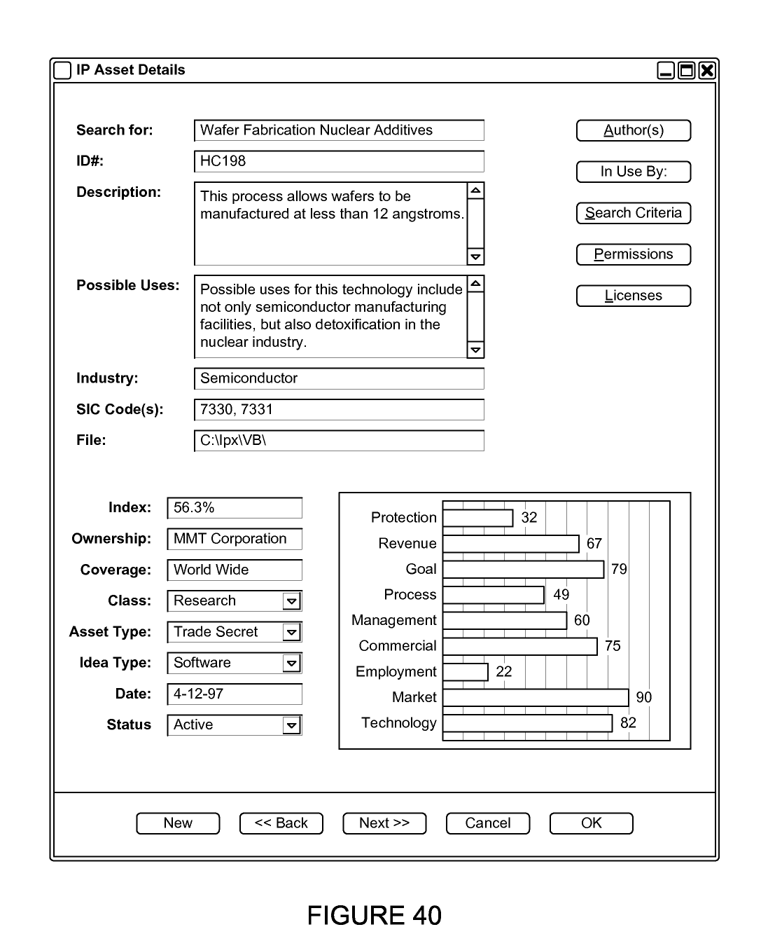

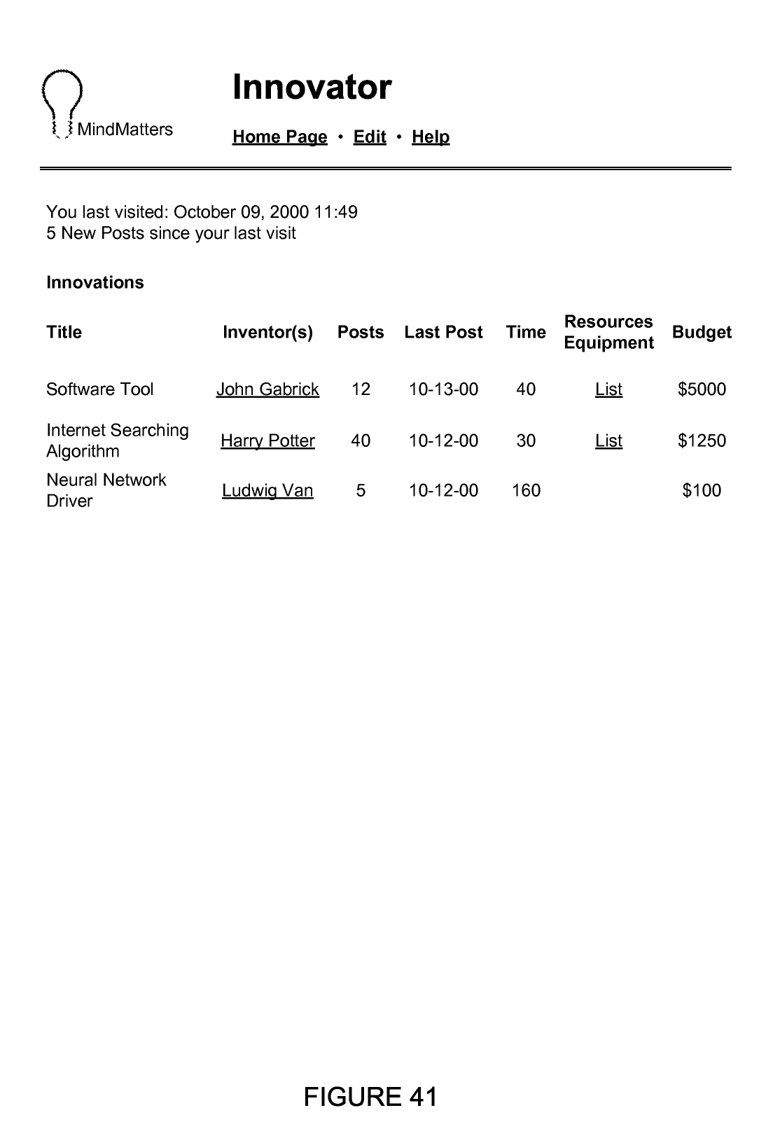

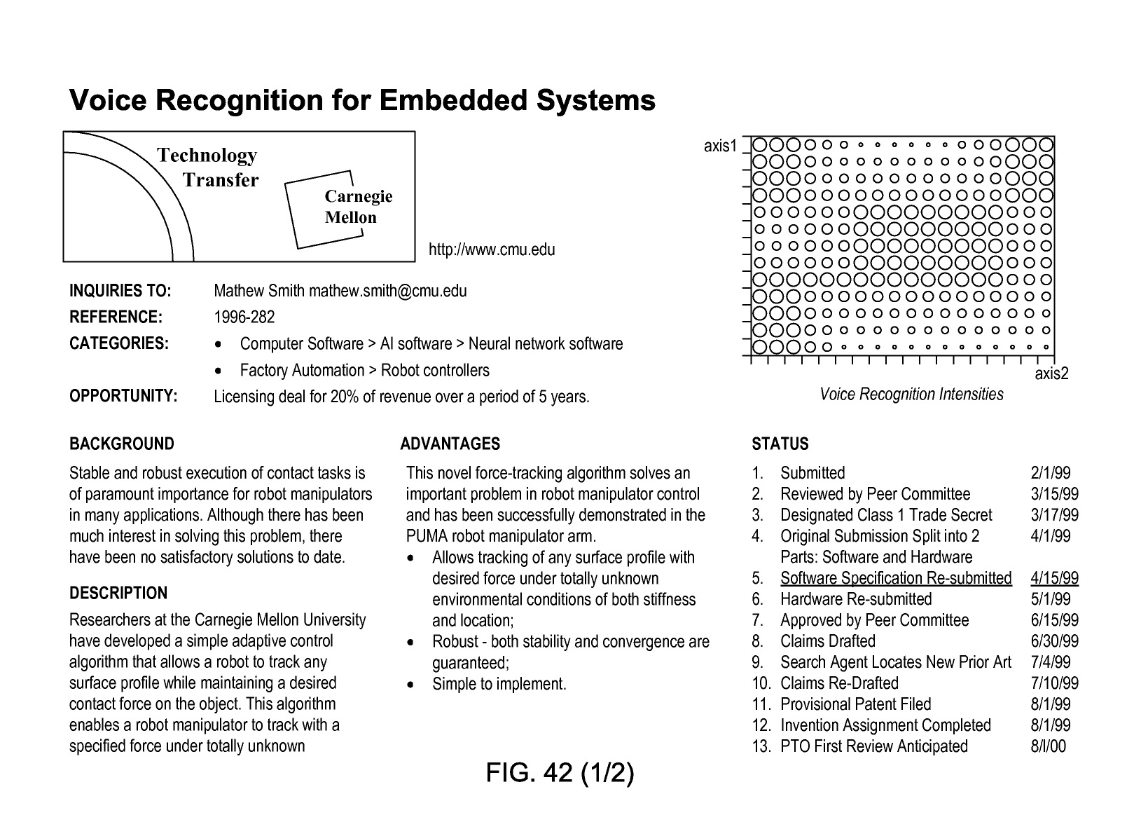

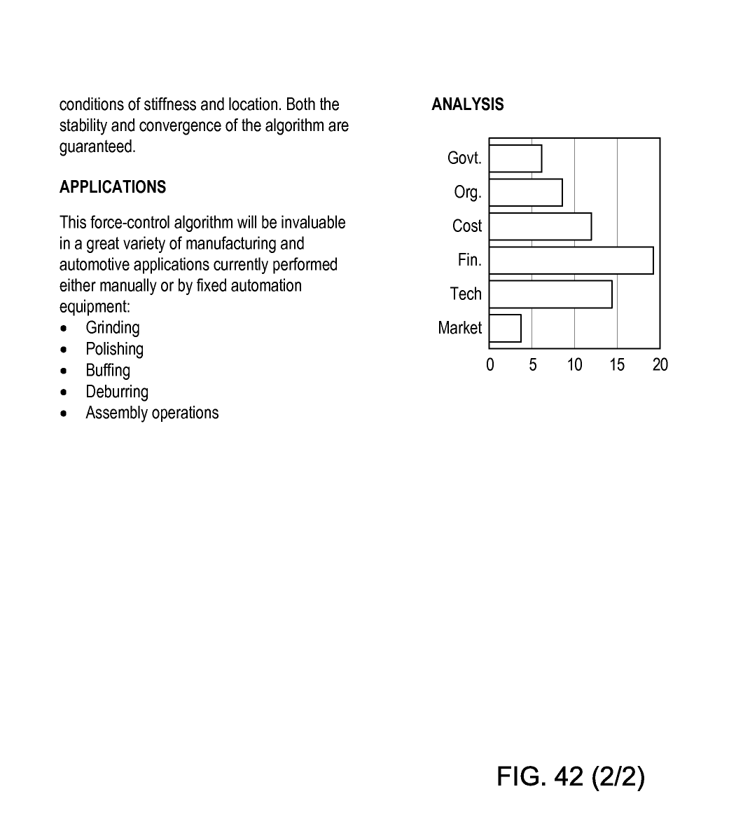

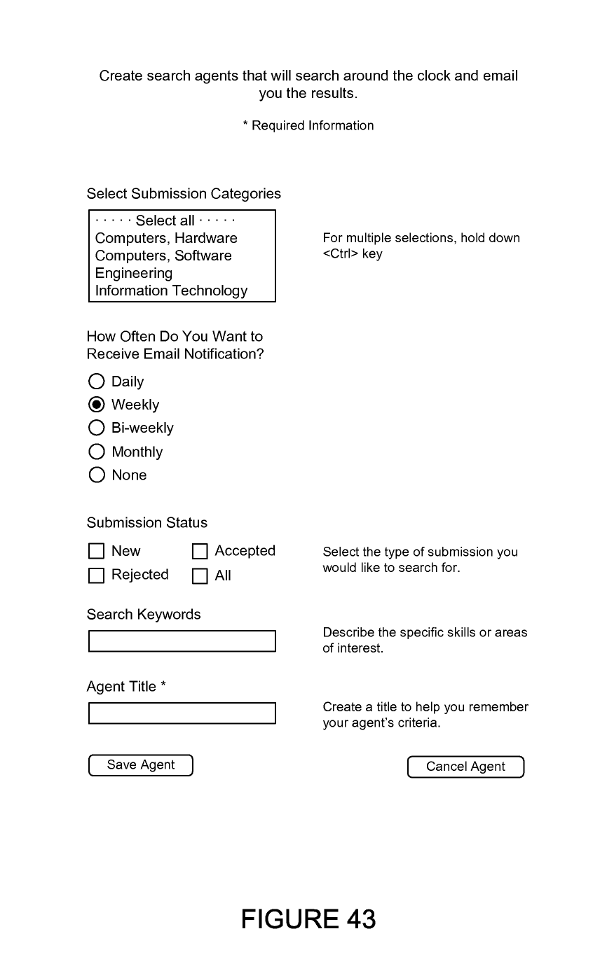

D.1. Agent Monitoring System (AMS): The AMS resides on the client hardware, usually a PC, and monitors the user actions on the trade secret files. The AMS acts as a permissions agent, giving the ability to read, print, mail, etc the trade secret by the user. In some cases, the AMS communicates with the File Management Server concerning the use of the trade secret. These communications can either be batched or transmitted continuously.
D.1.1. Trade Secret Viewer: This is the central controlling process on the agent machine. It is the vehicle by which the user makes the request for the trade secret, it handles the incoming approved trade secret storage, launches any applications that are necessary to process the trade secret (for example, the user wants to print the trade secret out, then this process starts the word processor application), and this process sends activities it performs to the Trade Secret Monitor.
D.1.2. Event Manager: This function reads the wrapper on the trade secret and then schedules any events that are necessary, i.e., deleting or changing the trade secret after a certain number of days. This process also sends all activities to the TSS.
D.1.3. Trade Secret Monitor: The Trade Secret Monitor records all activities performed on a trade secret, and sends the events to the File Management Server. It can also watch for activities from any launched applications dealing with the trade secret, send reports, or watch a certain data area on the disk.
D.2. File Management Server (FMS): The FMS handles all requests for trade secrets from the AMS (user). The FMS checks the user name against a password list (network, asked via browser, employee id, etc) and verify the user before allowing a file request to be made. Once the user is verified, the trade secret requested file is matched with the rules associated with that particular trade secret, encrypted, wrapped with a monitoring agent, logged and sent back to the AMS. The File Management Server maintains information about trade secrets such as: artwork, designs, blue prints, tools, methods, patents, trademarks, copyrights, maskwork, computer files, databases, business logic (computer code and methods) and other proprietary information that may be defined from time to time. With respect to each type of intellectual property, the FMS maintains information on dates (last update, when added, when deleted, various stages of property (patent pending, patent, etc), a description of the property, title, ownership, coverage, inventor/author, licensing, and supporting documents. The FMS contains all of the functionality to select files/directories/servers as trade secrets, create classes of trade secrets, create classes of users, apply permissions (encryption, visual notice, etc) to trade secrets, classes of trade secrets, users, or users of trade secrets, and to create rules by mapping trade secrets (or classes of trade secrets) to users (or users of trade secrets).
D.2.1. Request Handler: This process handles incoming trade secret requests, verifies the user from the network password list, initiates the request, and eventually sends back the requested file or a deny. This function can either be called directly such as the case with the AMS makes a specific request, or in “sniffer” mode it can watch the network traffic for files/transactions that have been designated as trade secrets.
D.2.2. Trade Secret Management: This function allows administrators to select/deselect files, directories, or servers/workstations, locations, etc to be used as trade secrets. The administrator selects by clicking a check box next to each file/directory/server/location. (Similar implementation as a Windows Backup program). Additional functions within this group allow for specific types of intellectual property to be described in more detail. For example, drawings may contain references to authors, creation dates, or products that incorporate the features described. Each type of intellectual property has its own set of attributes that can be tracked. See FIG. 21.
D.2.3. Rules Management: This function allows the administrator to create rules. Rules are the mapping of trade secrets and trade secret classes to users and user classes. The administrator is allowed to add, change, or delete rules by rule number, class name, or user. The rule consists of a mapping (either one to many, one to one, many to many, or many to one) which describes the relationship between the intellectual property and the user(s). See FIG. 22. See FIG. 40.
D.2.4. Class Management: This function sets up classes of trade secrets and users for the rules. The purpose is to make rule definition faster. By setting entire classes of files as trade secrets, either by server, location, etc. then the rules can be set up once for the entire class instead of one file at a time.
D.2.4.1. Trade Secret Classes: This function consists of a listing of directories, servers, or grouping of files that consist of a class, the class name, and the permissions for the class. The list also contains previously selected files/directories/servers as well, so that the administrator can select them and put them into a class. Administrators have the ability to add, delete, or modify classes. Trade secret classes can be viewed/sorted by trade secret, class, or permissions. See FIG. 23.
D.2.4.2. User Classes: This function consists of a list of network users, their class, and the permissions of the for the class. The list also contains all network users as well, so that the administrator can select them and put them into a class. Administrators have the ability to add, delete, or modify classes. User classes can be viewed/sorted by user name, class, or permissions. See FIG. 24. See FIG. 25.
D.2.4.3. Permission Management: This function assigns permissions to user and trade secret classes. See FIG. 26. For example, this allows the trade secret class “research” to have the permissions as designated in the Security Manager (D3.4). A permission can consist of the following attributes in any combination:
D.2.4.3.1. None: In this instance, no tracking is performed. In most cases, this de-activates existing rules.
D.2.4.3.2. Visual Warning: This presents a “blue screen” or some type of visual display on the client PC. This is displayed each time the trade secret is accessed, informing the user of the trade secret that the information is confidential (or some other messages entered by the administrators)
D.2.4.3.3. Password: This rule demands a password to access the trade secret each time it is accessed by the user. This can either be a password that is made up by the user when they initially download the trade secret, or it can be their normal network password, or a completely different password set by the administrator.
D.2.4.3.4. Encryption: This rule encrypts the trade secret by one of the commonly available methods set by the administrator.
D.2.4.3.5. Agent: This type of rule allows the trade secret to be monitored by tracking any modifications to the file (or alternatively the physical data), and monitoring key strokes. It also allows the trade secret to be deleted after a certain number of days automatically by the Agent Monitoring System residing on the PC. It can be further refined to perform NSA or other data segment erasing methods to ensure complete removal from the system. The agent also gives the option of sending tracking information back to the File Management Server for analysis by the administrator, or “insisting” that the agent be allowed to communicate with the FMS before any further actions are allowed on the trade secret.
D.2.5. File Wrapper System: This process is extremely complex as it grabs the file/data and performs the functions required in the rules, including encryption, setting expiration dates, translating the file to an executable image, called a wrapper (file+rules+agent), etc. The wrapper can also contain the Agent Monitoring System. The file/data can either be a specific file/data pulled in from the network via TCP/IP sniffing, a file/data pulled from a specific location, or the file/data that is a result of an external query (database call). All of these actions are logged. The executable image is in a format that can be processed (read, print, modify, delete, etc) by the Agent Monitoring System.
D.2.6. Reporting System: This process takes information from the log files, rules, wrappers, etc. and prepares reports on usage, activity etc.
D.3. Trade Secret System (TSS): This functional process manages the accountability, awareness, secrecy, and security (four trade secret pillars) status of each trade secret. This process also allows the user to dynamic change each of the four pillars to reflect strategic changes in the business. The TSS is the primary mechanism for creating the rules.
D.3.1. Awareness Manager: This function tracks and logs a company's (or entity's) IP Policies, management oversight procedures, the dissemination of an understanding of Public Disclosure (as defined by U.S. Law), the tracking and dissemination of What a Trade Secret is (according to U.S. Law). The purpose is to show that various supervision entities have created awareness for trade secrets as prescribed by law, and that the people who use the trade secrets have a clear understanding, and hence accountability of the trade secrets that they use.
D.3.1.1. Trade Secret Finder: This function determines potential trade secrets by “reading” files on the network and comparing the text with lists of key words and phrases entered by the management. This is designed to be used periodically to maintain integrity of the system. Final decisions regarding a documents status are made by management.
D.3.1.2. Trade Secret Eliminator: This function determines which trade secrets should be demoted and removed from protection. By searching by key word, date, and usage, the function intelligently makes recommendations for removal. Final removal is determined by management. See FIG. 27.
D.3.2. Accountability Manager: This function tracks and logs a company's IP reviews, employment contracts/IP agreements. The purpose of this function is to track contracts and paper trails that provide awareness of the trade secrets. Reports from this function give the complete detail on the level of trade secret usage/disclosure by aggregating class information, trade secret information, user activities, user awareness acknowledgments, and external data to give a rating as to the protectability of the trade secret. By measuring where the trade secret is used, how it is disclosed, how it is protected, and employee awareness a rating can be generated. Intelligent search function uses key words plus SIC Code and other market-specific information to conduct a more intelligent search. This function employs “spider” graphs and the pair-wise comparison methods described elsewhere herein.
D.3.3. Secrecy Manager: This function tracks and logs confidentiality agreements, publications, press releases, and marketing collateral associated with a company's trade secrets. This process maintains access to the external networks (Internet) and conducts key-word searches to find other companies/disclosures of monitored trade secrets. There are several third-party products that can be hooked into this system to perform this function. This process provides the interface.
D.3.4. Security Manager: This function tracks and logs public access to workspaces, network security, E-mail, and demonstrations. This process is the primary interface to e-mail monitoring programs and external physical security systems (tracking ID card usage, etc.)

This section further describes some typical use of the System. Because of the nature of the System, it is not always possible to numerically delineate an exclusive sequence of events, however, each subparagraph represents at least one (sometimes many) functional aspect of the system. There are three general functional flows presented in this section: the user, the administrator, and the manager. The user is the person who wants to view/modify the trade secret, the administrator sets up rules, wrappers, and files/directories/machines as trade secrets, and the manager defines trade secret policies and runs/views reports.

### User Flow, Network Monitoring and Protection

If the name and password are valid, and the trade secret is allowed to be accessed by the user, then the file is wrapped according to the rules set forth by the administrator.

Wrapping takes place in the File Management Server and creates a binary executable of the file with the wrapping contents. The wrapper can also contain the Agent Monitoring System (if the user does not have it, but it is required for file access).

The file is sent back to the user's PC.

The user double-clicks (or opens, or performs some other function which initiates access to the trade secret) on the trade secret file.

If the wrapper required encryption, then the trade secret is decrypted.

If the wrapper required a password, then the user is prompted for the password.

If the wrapper required a visual warning, then a “blue screen” is presented to the user so that the confidentiality of the trade secret is described and the responsibilities to the user are presented.

If the user types an invalid password X times, then the trade secret is rendered inoperable (either deleted or stays dormant), the appropriate logs are generated by the Agent Monitoring System, and if required the log information is sent to the File Management Server.

If the Agent Monitoring System (AMS) has been activated, then it begins recording activities defined by the administrator that occur on the trade secret document.

If the AMS receives a command from the user to view the trade secret, then the appropriate application is started (probably Adobe Acrobat with modification attributes set on startup) and the document is displayed. Depending on the user's pre-determined authorization, the application allows the user to read/write/delete/update the trade secret. Each action by the user is logged locally, and can be communicated back to the File Management Server.

If the AMS determines that the trade secret should be deleted, then the AMS deletes the file and performs the secure erasing method. This activity is logged, and communicated back to the FMS is required.

The user receives a mail message informing him/her that new IP policies are now in place and should be reviewed for compliance. The user reads the policy (on the internal web server) and responds by electronically signing the policy.

### Administration Flow, Network Monitoring and Protection

The administrator sets up the File Management Server to be either in one of three modes: with the Agent Monitoring System running or without. If the Agent Monitoring System is running, this implies that the AMS software is either resident on the user's PC or the AMS software is wrapped with a requested file and sent to the user's PC to be installed before the trade secret is viewed. Using the AMS software implies that a greater level of protection is operational as the AMS records information in addition to the File Management Server that records the initial request.

The administrator further sets up the FMS by deciding whether the FMS should be set into “sniffer” mode, where it simply records requests/receipts of trade secrets, or whether it should be set to intervene between every receipt by appropriately wrapping the trade secret with protections.

The administrator sets up the FMS to the type of network(s) being monitored, such as TCP, IPX, NetBUI, etc. and the types of network packets being tracked, such as IP, HTTP, etc.

The administrator uses network services to set up the FMS server as a client in the system. This ensures that this server receives all updates about user access, including the network password list.

The administrator runs the Trade Secret Finder to locate various trade secrets. First, the administrator entered key words, projects, locations, servers, etc. and the Finder presents a list of possible machines, folders, and documents to protect. This saves the administrator time in setting up the system.

The administrator selects any combination of servers, directories, and files to be designated as trade secrets. If no other actions are performed, i.e., no rules are set up, then the FMS goes into default mode where it simply records the access to each trade secret. Access records contain file name, file location, user, date/time, and other identification.

The administrator further designates classes of trade secrets. These classes group the trade secrets according to policy defined at the company, such as by physical location, by server, by company department, by directory, by trade secret type, etc. For example, the administrator may assigned the trade secret class “research” to the servers located in the company's research lab in Seattle, Wash. This preferably consists of the five machines and their corresponding files and directories. In another example, the administrator may define the class “project X” to include the directories labeled C:\project_x on the servers in Tampa, Fla. and Pittsburgh, Pa. The purpose of defining classes is to make the application of rules simpler.

The administrator further designates classes of users. These classes group users according to viewing restrictions. Classes can be defined by location, by job function, by current network access privileges, by department, by title, by name, etc. For example, the administrator may define all users who have the title “research assistant” to a user class called “research-assistant” and to have view-only access to any trade secrets. In another example, the administrator may define users who reside in Orlando, Fla. to have view and modify writes to any trade secrets, as well as the ability to delete trade secrets that have been downloaded to the users more than 30 days. Or simply, the administrator may select all users that live in Redmond, Wash. to a class labeled “redmond”.

The administrator sets up rules by mapping either trade secrets or classes of trade secrets with users or classes of users, and by adding/modifying/deleting further file manipulation properties. For example, the administrator sets user class “research assistant” (which has view-only access) to trade secret class “research” (which can look at files on the Seattle, Wash. server). In addition, the administrator may elect to further refine this rule by requiring that all trade secrets are also encrypted and password protected.

If the company is managing assets loaded into third-party databases, i.e., Oracle, DB2, Access, then only classes of users can be designated.

If databases are being monitored, then in addition to user name, date/time, and other identifying information, the FMS also records the database calls.

### Manager Flow, Network Monitoring and Protection

A manager decides to enter a new trade secret into the system. Since the physical file is already present on the company's network file system, the manager uses a Windows Explorer-like tool to find and select the desired file. Selection takes place by placing a check mark next to the file. Similarly, if the file is originally placed into an already protected directory, then the new file receives the same level of protection as the current files in the directory.

The manager enters information regarding the ownership, economic value, and key words to be associated with the trade secrets.

A manager decides to enter a new user. In this case, the manager uses a tool that brings up all users for the network. It is assumed that the new user has been added to the company's network file system. The manager then selects the user and either puts him/her into an existing class, creates a new class for that user, or assigns access rights to the individual user.

The manager is presented with a monthly REVIEW FOR REMOVAL report indicating files that need to be re-verified as trade secrets. This report lists the trade secrets that are “owned” by him/her, the file, date, accesses, etc. These files were either selected by the intelligent removal agent, or are generated by administrator direction in order to keep the system updated. The manager either checks or un-checks files that should be removed.

The manager enters IP policy files into the Awareness Manager.

The manager selects an IP policy or policies and a class or classes or users and requests that a notice be sent to all of the users (in the selected class) informing them of new IP policies.

The manager later views a USER AWARENESS report that indicates which employees have read and responded to the new policies.

The manager enters a new vendor contract, licensing agreement, joint venture, etc. document that includes the disclosure of certain corporate trade secrets. This document is tied to the trade secrets it covers so that trade secrets that leave the company and go into the hands of third parties can be tracked.

When this third party relationship is terminated, a THIRD PARTY DISCLOSURE report of all disclosed trade secrets is printed, and the trade secrets are either destroyed (and marked accordingly in the system), or returned (and marked accordingly). The appropriate dates and other related information are entered into the system at this time.

The manager prints out a trade secret along with a disclosure to give to a third party, this information is automatically recorded.

A new employee is hired and entered into the system. Based on the user's assigned class, a set of materials (IP policies, non-disclosure, etc) are automatically generated and printed. When the documents are signed and returned to the employee file, this information is entered into the system.

The manager prints a TRADE SECRET DISCLOSURE report that lists each trade secret, the users who have accessed it, what activities were performed on the trade secret, what the level of protection of the trade secret is, where it is located, and what third parties have the trade secret.

The manager prints a USER DISCLOSURE report that details the trade secrets accessed by the user, the types of activities performed on the trade secret, and the time and date. Any obsolete trade secrets are listed as such, but all of the information is presented.

An employee terminates their employment. Along with a USER DISCLOSURE report, a form which indicates that the user is leaving, and a notice which informs the employee about their responsibilities to keep the listed trade secrets confidential. This form is entered into the employee file.

The manager requests a PROTECTABILITY report. Based on the types of disclosures, activities, level of awareness of users, public disclosures, this report provides a rating as to the protectability of the trade secret. For example, if a trade secret has been accessed by users that have not read the IP policies, then the protectability is lower.

The manager views a SECRECY report that details suspected exposure of the trade secret outside the corporate network as well as potential external information that could render the trade secret useless. The manager reviews this information and determines the extent of exposure for each entry in the list.

The manager is presented with various reports from external IPX systems via the SECURITY report. This aggregates information about e-mail, physical security, etc., and relates it to the trade secrets. For example, e-mail scanners which have detected key words being sent to external parties might raise an alarm. Physical security which has been compromised where trade secrets are located is an indicator of trade secrets to be flagged for possible removal.

Further specification of the components of the System follows:

### File Management System (FMS)

A File Management System is advantageously located on an MMT or other corporate server. LAN packet detector and decoder technology (such as from Packetboy, Australia; LinkView, www.linkview.com, US; NetSniffer, www.assert.ee/netsniffer/index.html; NetXRay, Cinco) is employed in a manner that will be known to those skilled in the art. The FMS exists in promiscuous mode, and reads the packets. Reading a packet generally means to decode packet contents, determine if it contains data (ie trade secret) that is being monitored by reading results of the action completed below with respect to marked selections of files being stored for monitoring. Monitored files are optionally and advantageously put into filters for the LAN detector; and positive filter results are placed into a file for use by the wrapper function described below. If the packet contains a trade secret, then it is sent to the wrapper application process

File Selection is preferably with check boxes (similar to Backup utilities). Functions are alternatively coded in VB using VTREE routines, or such like as may be known to those skilled in the art. All servers, directories, files are preferably encompassed; servers, directories, as well as files may be selected by checking a box. Marked selections are then stored for monitoring, such as discussed above.

Trade secret classes are created (via custom VB functions, or the like or equivalent as will be known to those skilled in the art, such as HTML and Java coding equivalents to VB). The marked list from above, as modified by files suggested (or alternatively deselected) by a user as part of the Agent Monitoring System (AMS) process discussed below, is displayed. From here, selection and aggregation into classes proceeds, and input of trade secret attributes, type, date, value, etc. for later reports is set up, and permissions are assigned.

User classes are also created (via custom VB functions, or the like or equivalent as will be known to those skilled in the art, such as HTML and Java coding equivalents to VB). A network list of users is displayed, from which to select and aggregate into user classes, and permissions are assigned.

A rules comprises the identification of a trade secret with a user, (via custom VB functions, or the like, and the lists of trade secret classes and user classes from above are displayed and matched to create such rules. Permission assignment changes are permitted by authorized persons however.

Wrapper functions. A file name is received from the filter results function above. A check is made to see if the file name is located in a database of rules. If not, then all classes are checked. If still not located, then default rules are assumed. The file containing trade secret and view attributes is then encrypted, compressed, and zipped (if required), into a self-extracting exe called an .MMT (DataCloak) or other desired unique file extension, whereupon it is logged and sent to the requesting user.

### Agent Monitoring System (AMS)

A PC sensor agent that performs monitoring of the trade secret based on the wrapper resides on each user machine. The wrapper and contents are decoded and given to the PC sensor agent monitor. In addition, disk activity and file activity on the PC are also monitored by a well known Filemon function, and keyboard activity is optionally monitored by a well known keyboard monitor function such as PCACME. Report of all monitored activities is sent to the TSS described below.

When the user clicks on a .MMT file, a File Viewer is automatically run that decrypts the file, asks for password, shows warning, etc first, and then runs a conventional file viewer such as that provided by Adobe. The file can be displayed, printed or modified using Adobe, if Adobe is so configured on the system. All such activities are logged as described above.

Using an otherwise conventional Explorer type interface, a user may use a Make Trade Secret function as add-on to Explorer and so add check marks to a list of files to be treated as trade secrets, as discussed above. Necessary TS attributes are optionally prompted for. The file and attributes are sent in a message to an IP manager. Trade secrets may be removed in a like but reciprocal manner, where one of the prompted attributes is a reason for removal.

### Trade Secret System (TSS)

All logs from the above processes are collected for Accountability and Awareness. For Accountability, there are provided optionally a File Access report (by user, file, date, type, class, activities), a User report (by activities, file, type, class), a Value report (by trade secret type, file, user, class), a PC Agent report (by user, file, action, class, activities), and an External Publications cross-reference report. For Awareness, users and management alike can view (or enter) IP Policies, cross referenced by file and class, and a Share Policies function makes policies available on the web, to induce and promote employee compliance. Appropriate users can also view/enter IP Contracts, cross referenced by file and class.

A Secrecy Manager is provided preferably in the form of an Internet agent looking on the web for key word references that are linked to listed trade secrets that reports back with listings of suspected TS usage (in a manner like Web Ferret).

A Security Manager interfaces with workspace security and with e-mail security and logs all external activities.

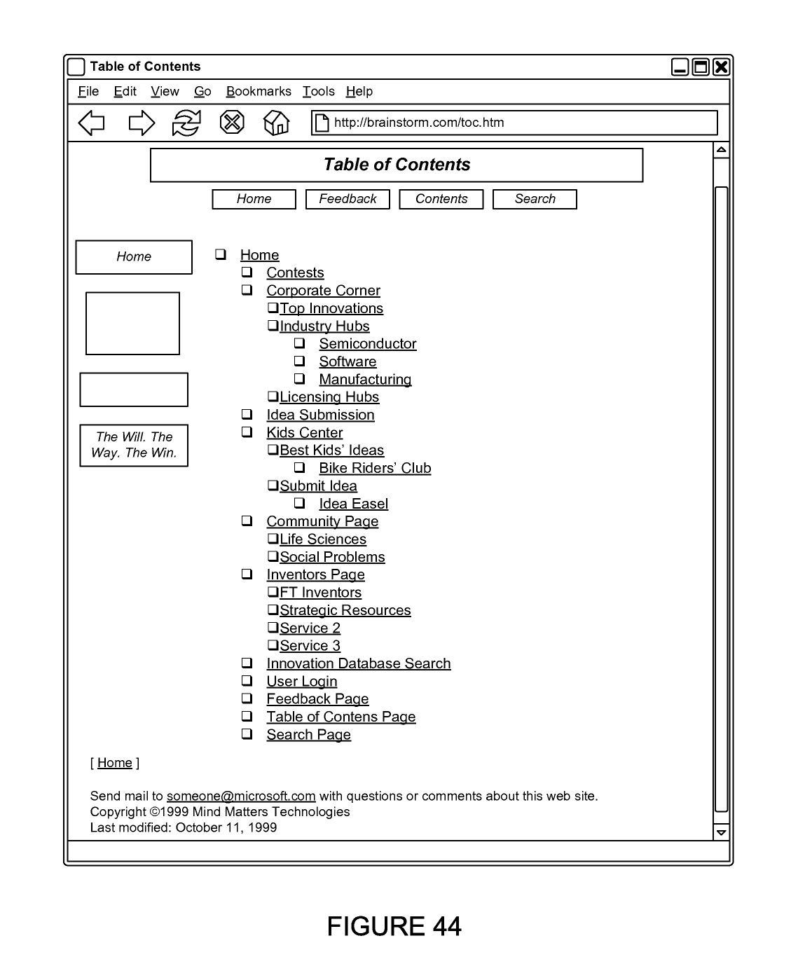

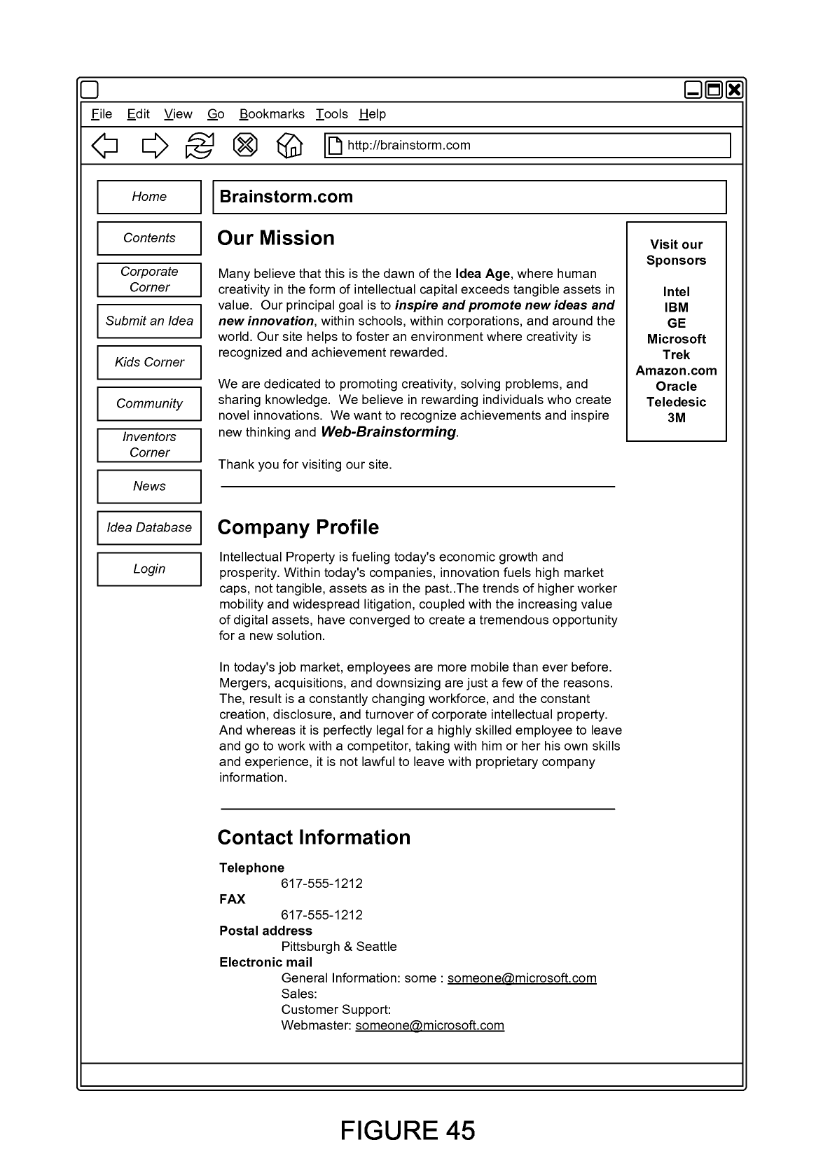

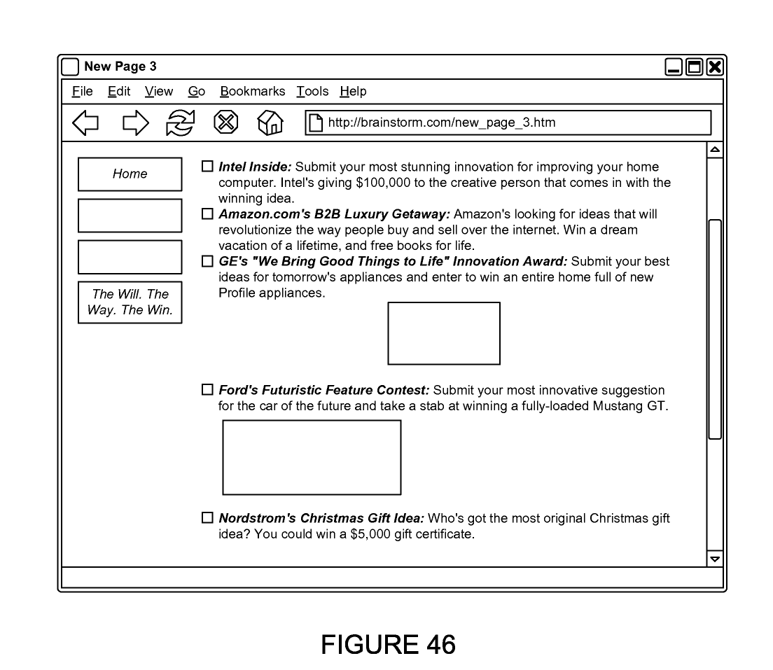

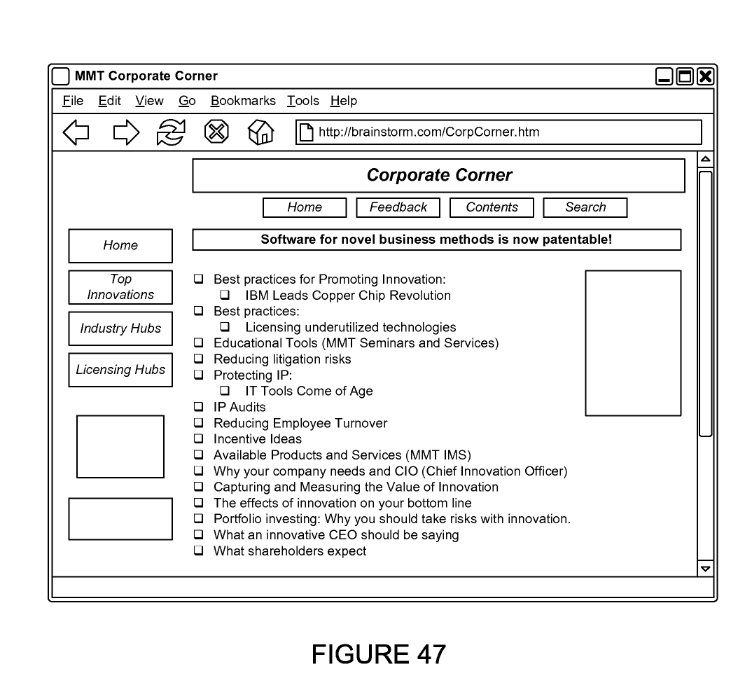

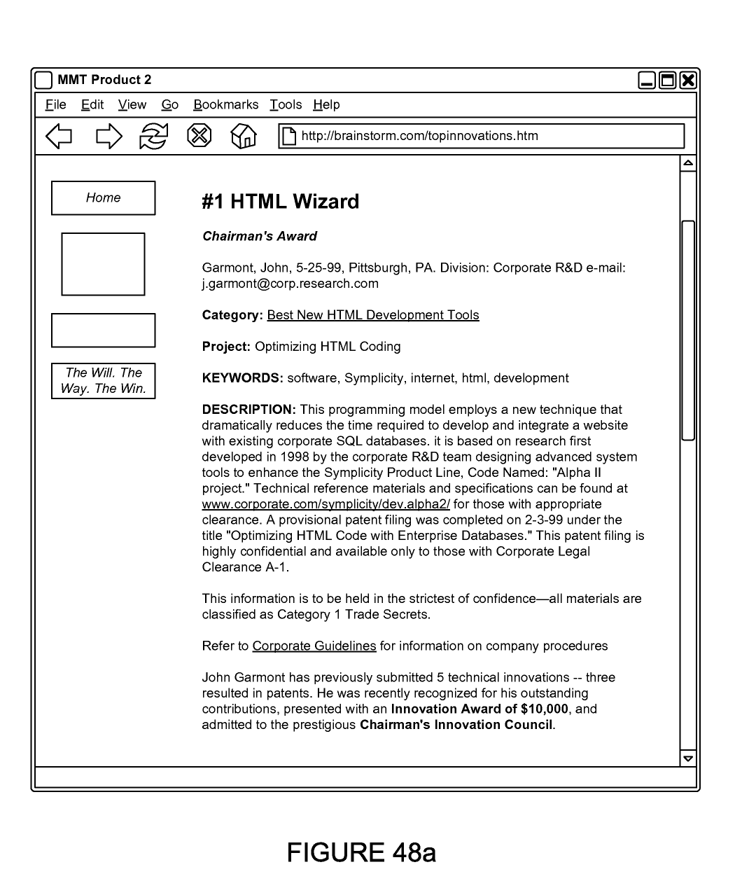

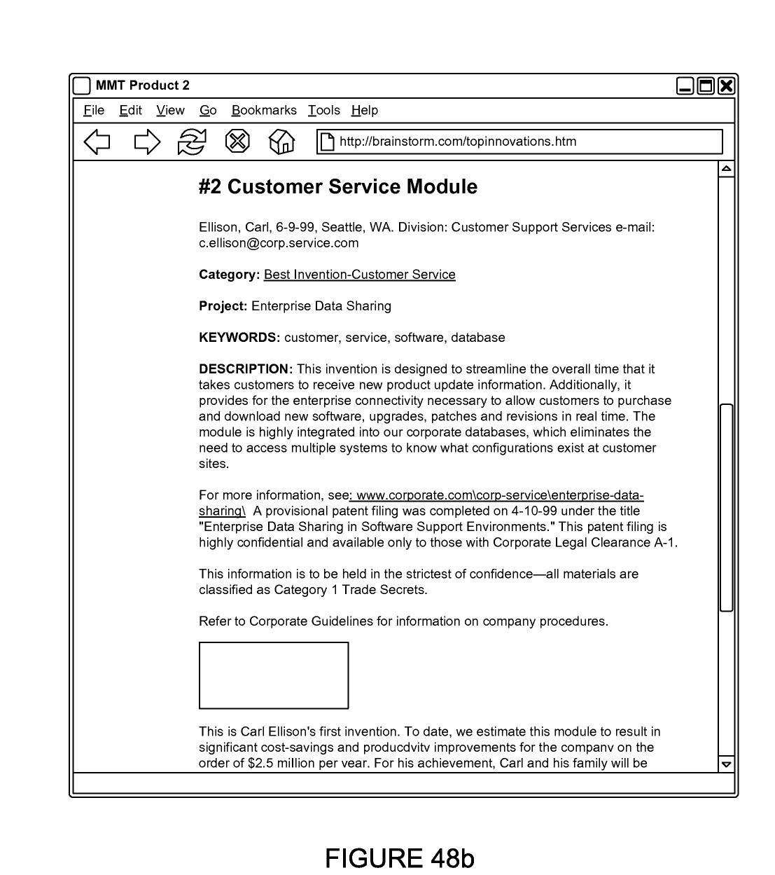

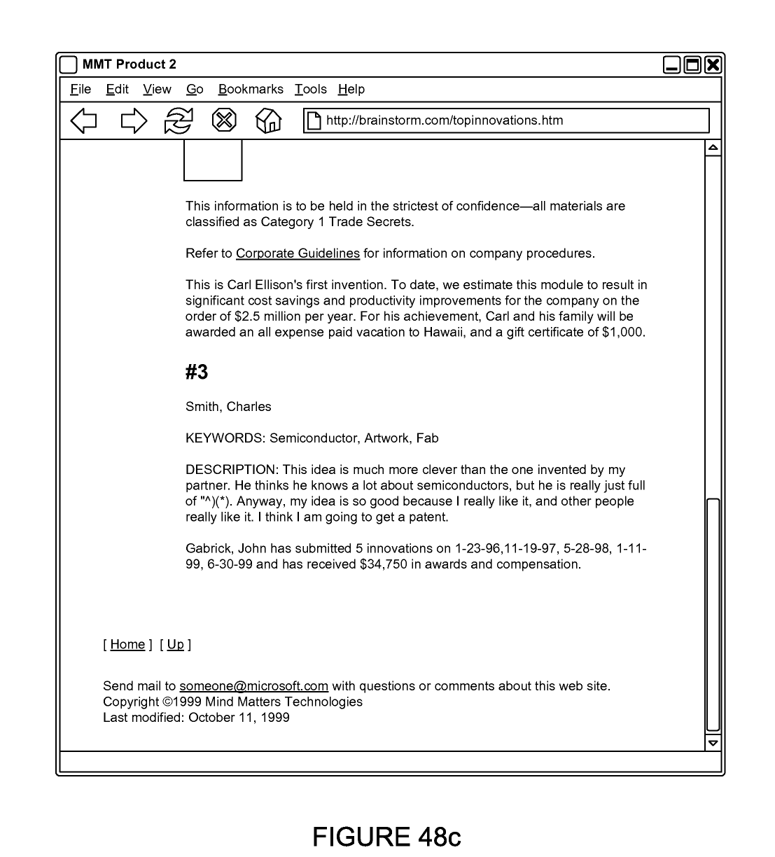

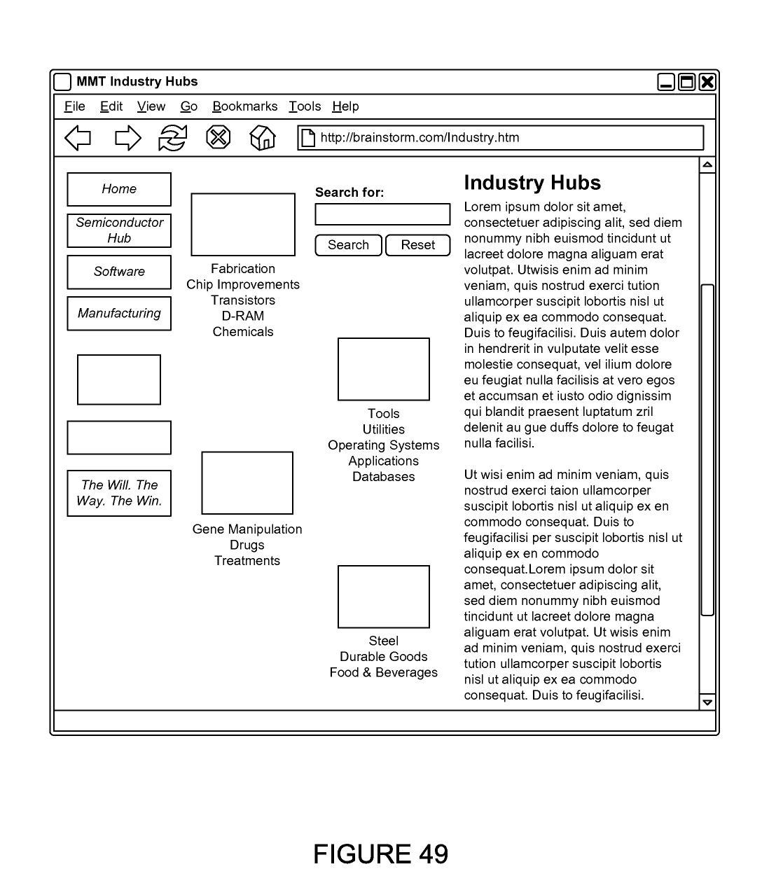

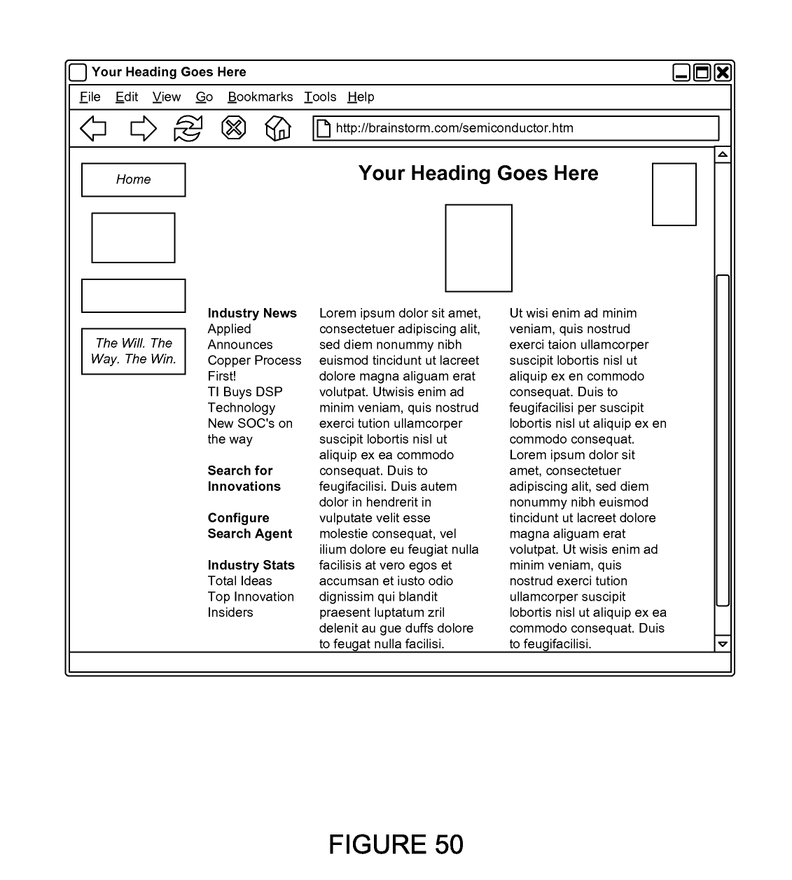

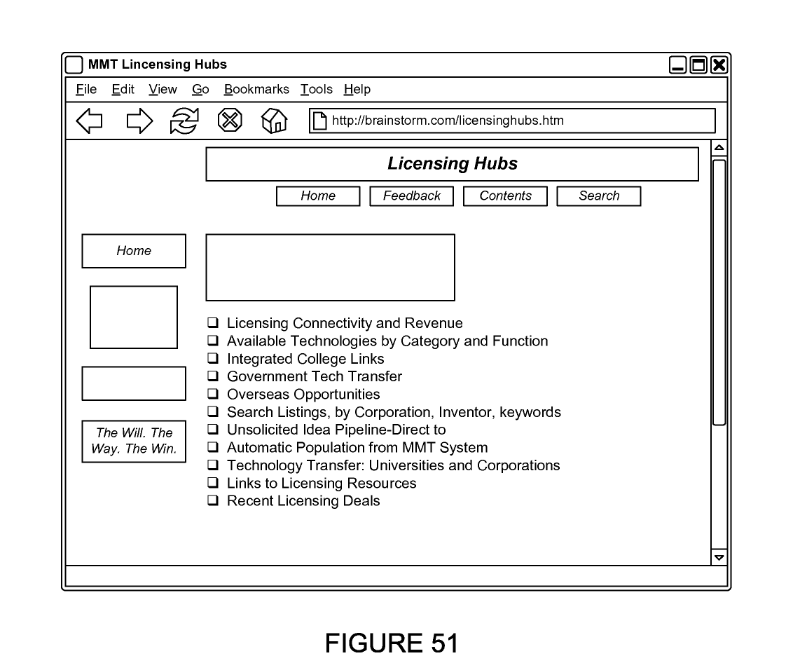

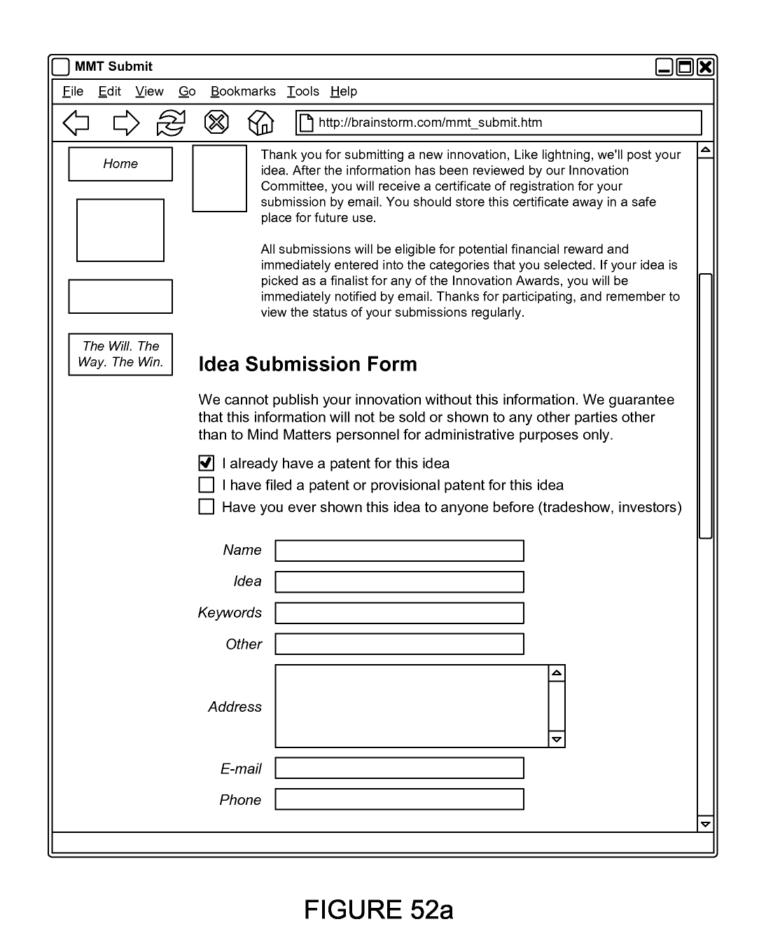

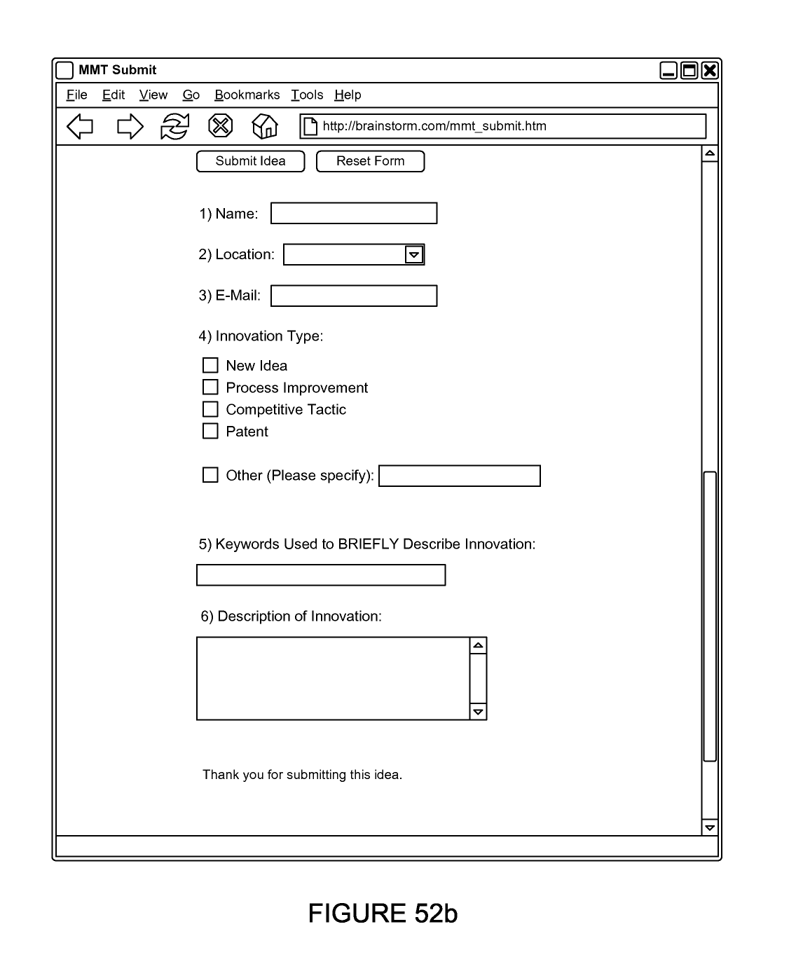

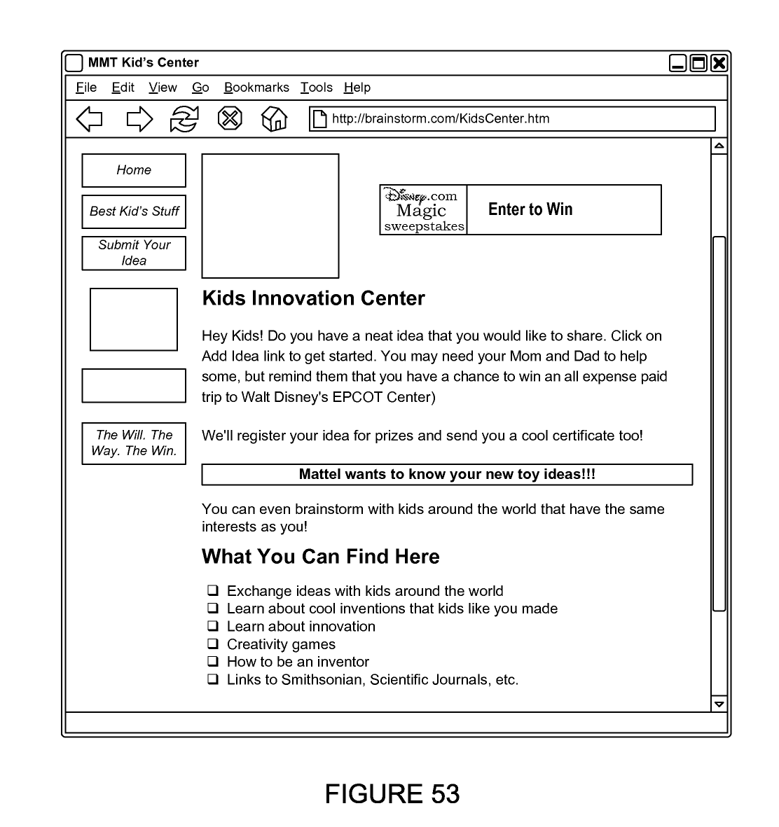

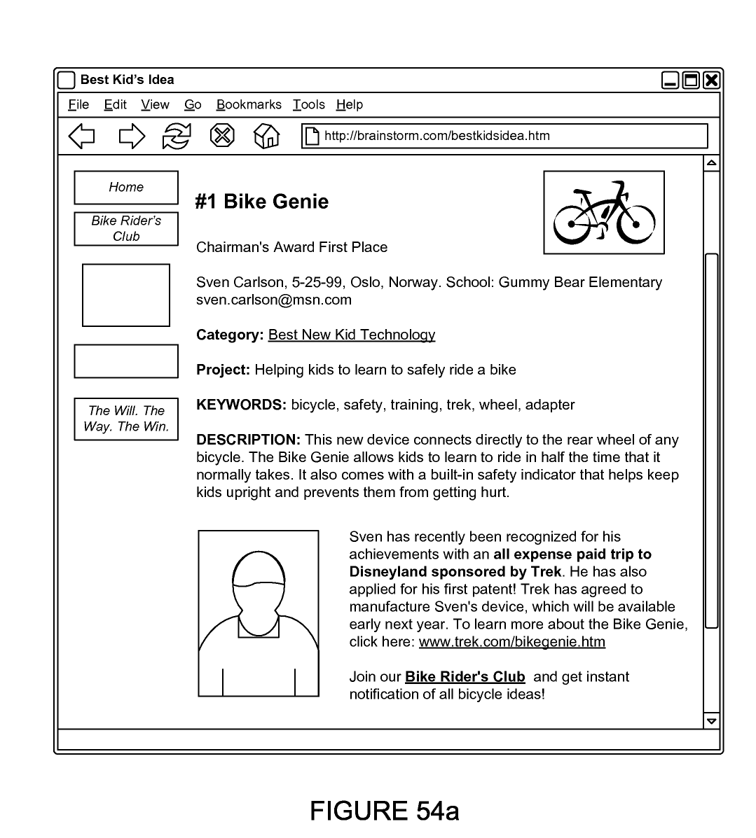

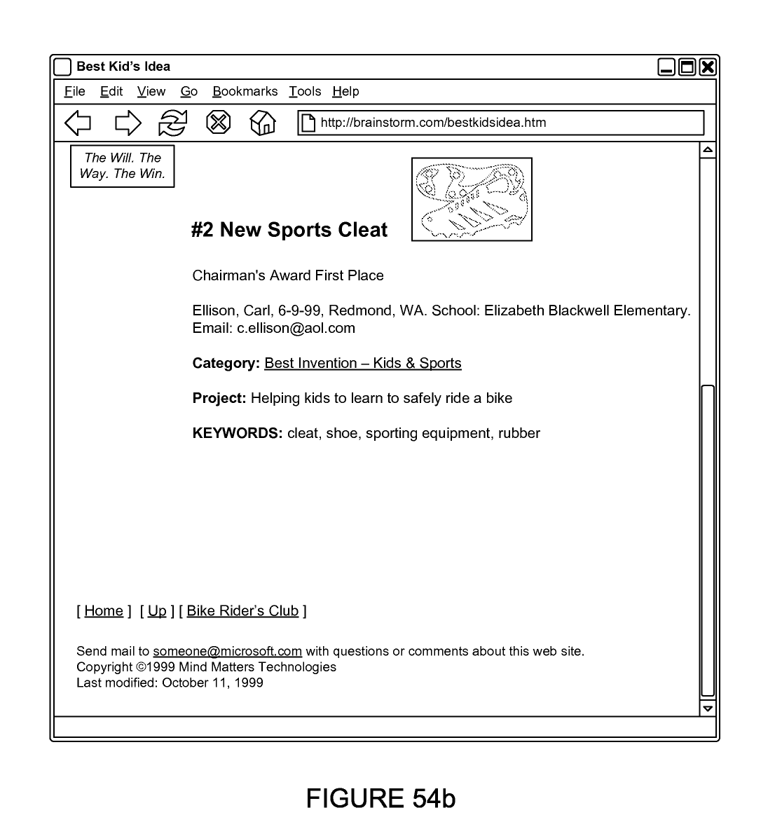

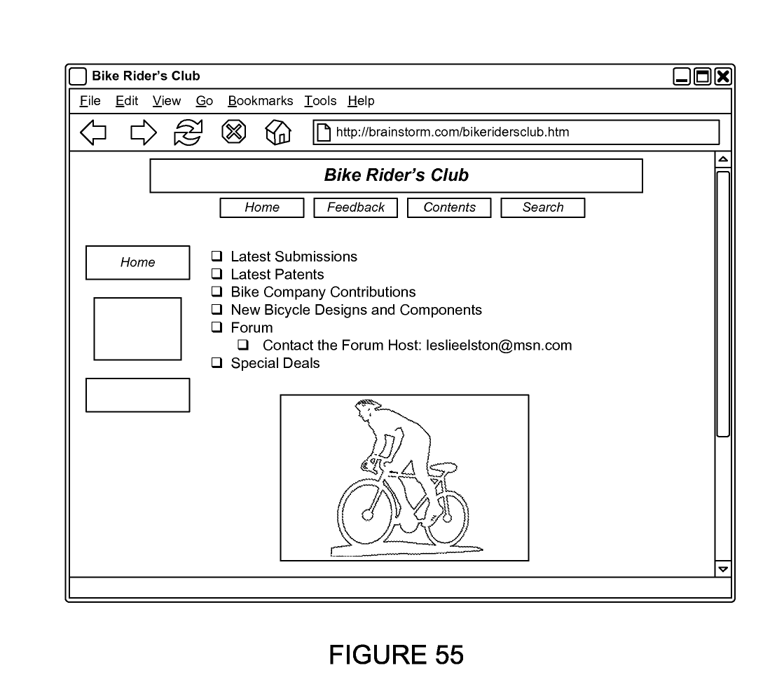

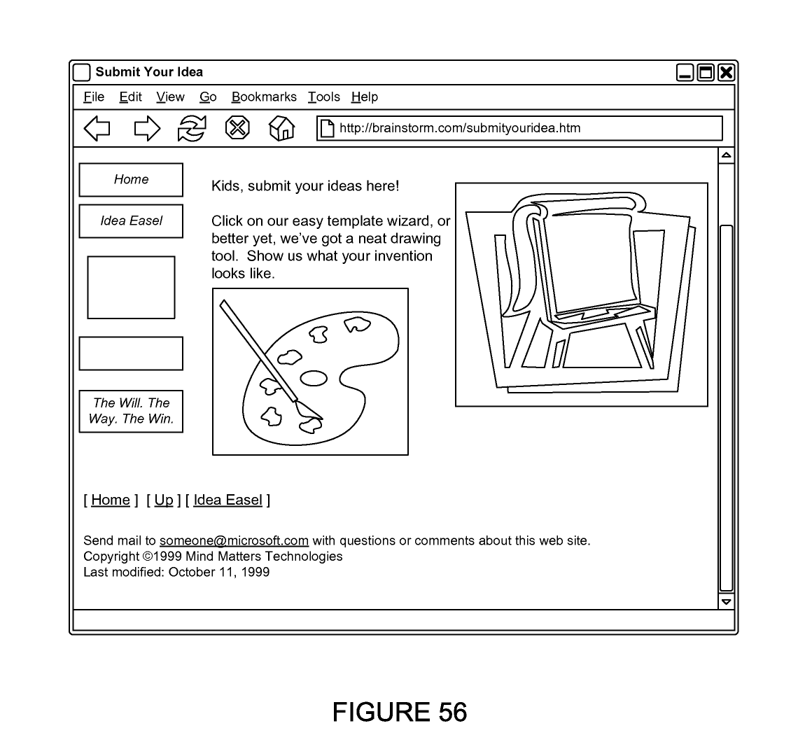

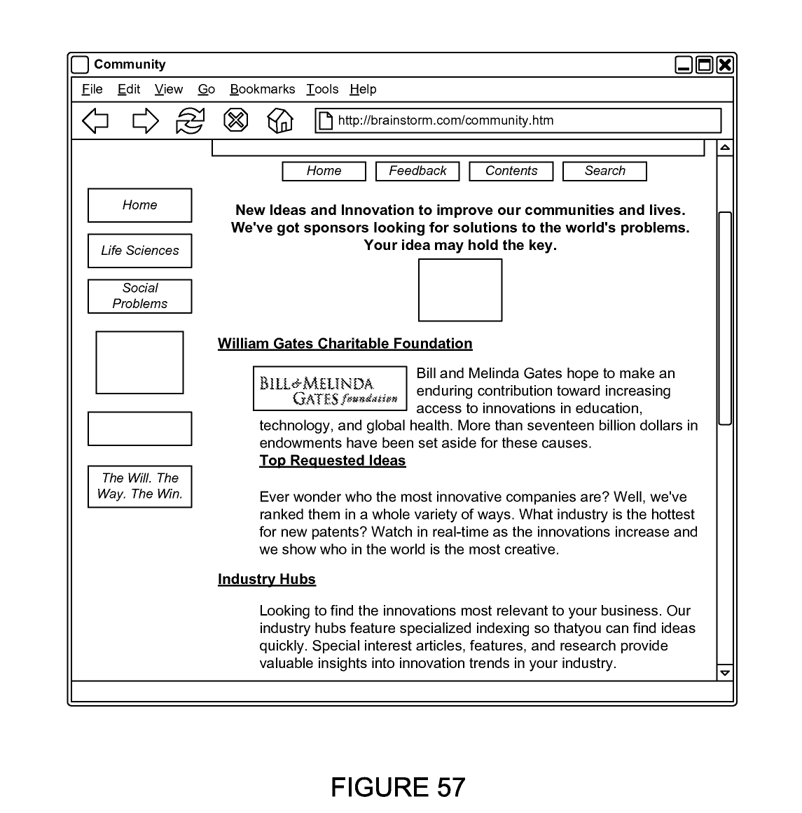

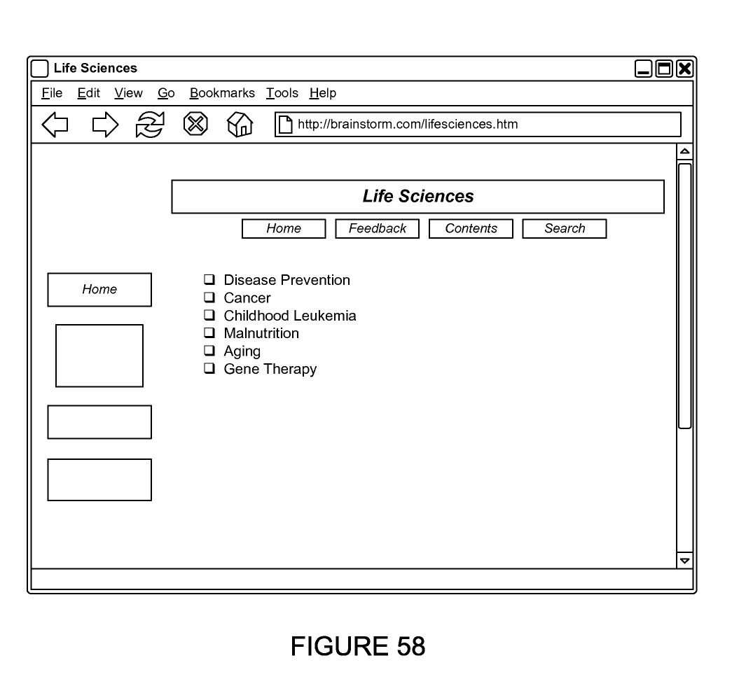

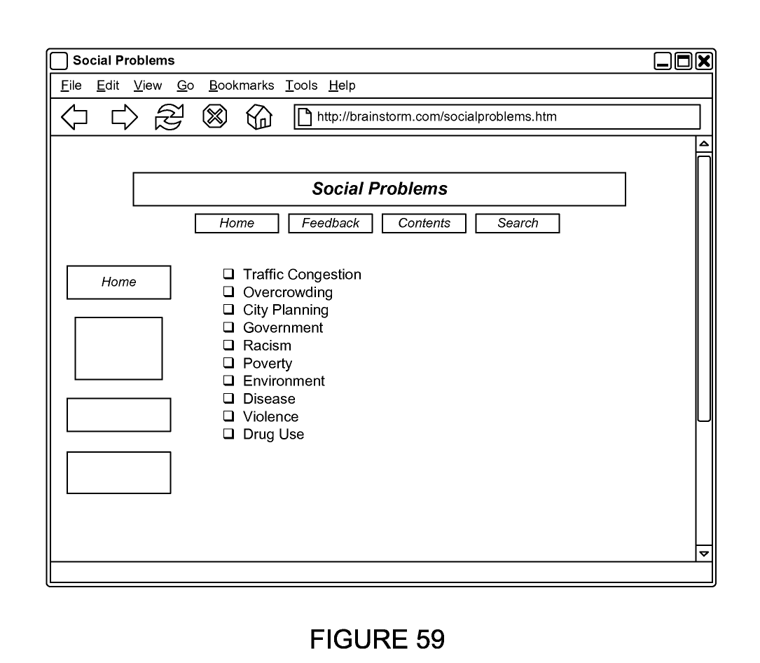

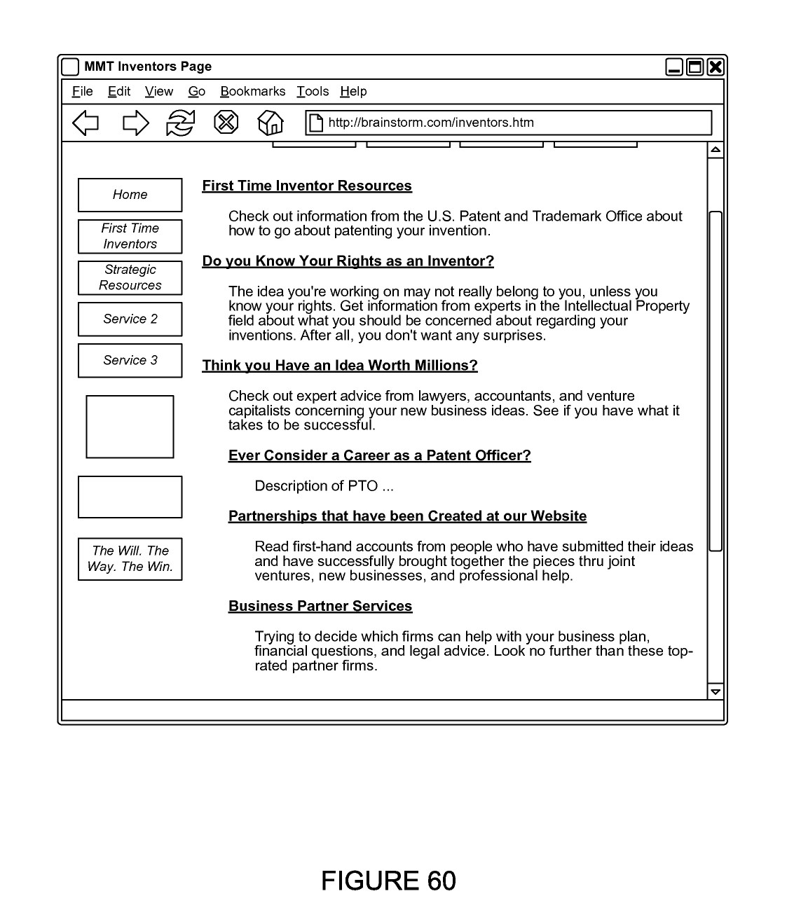

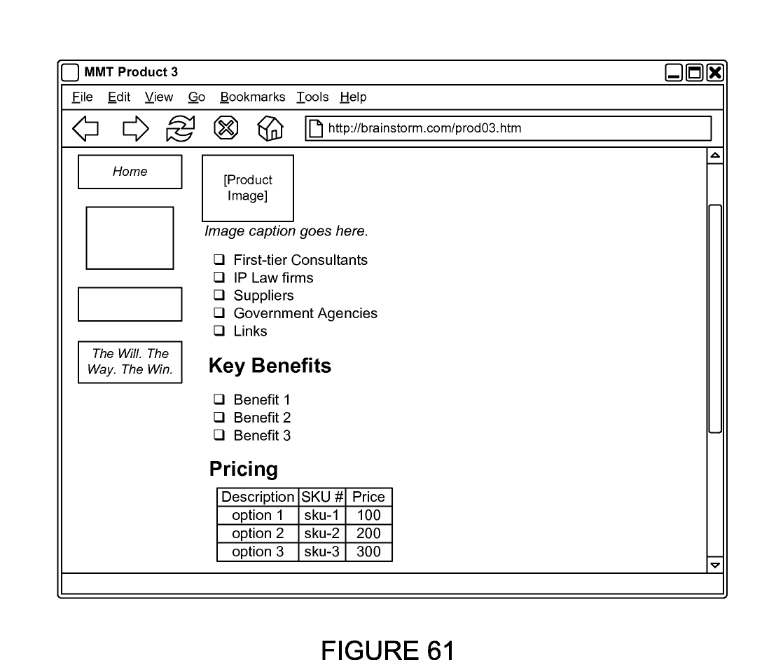

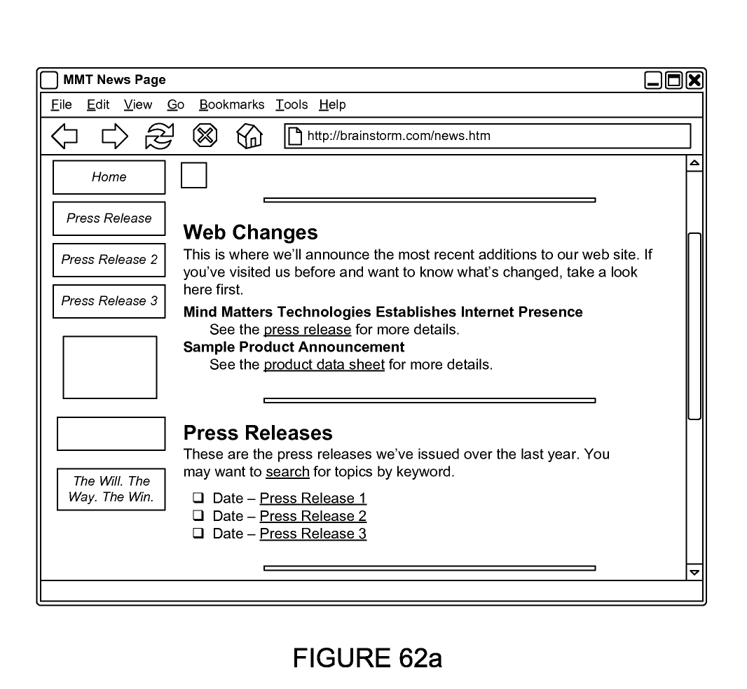

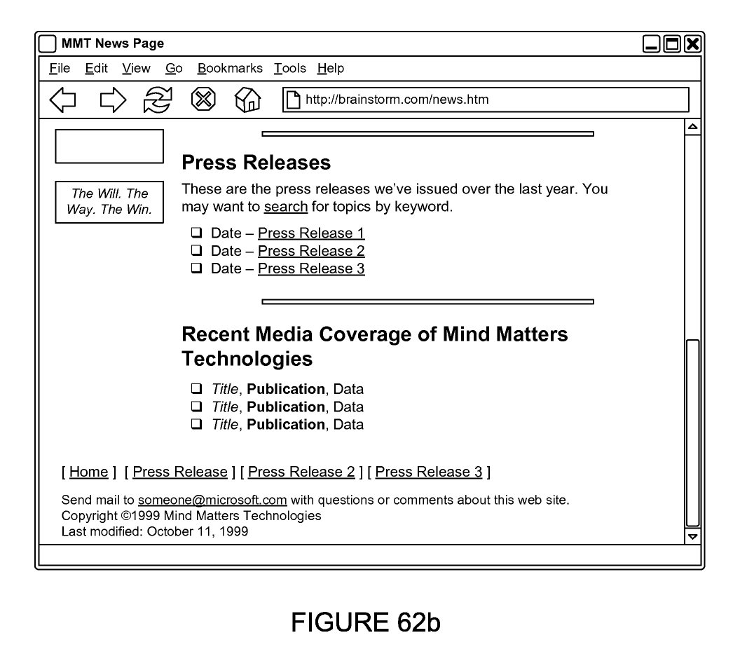

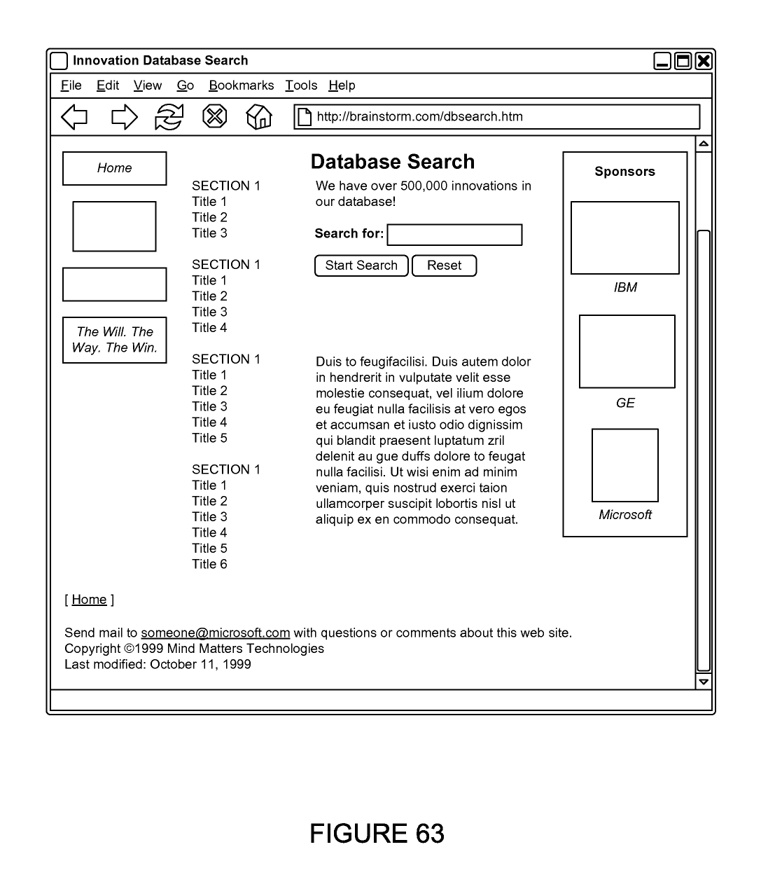

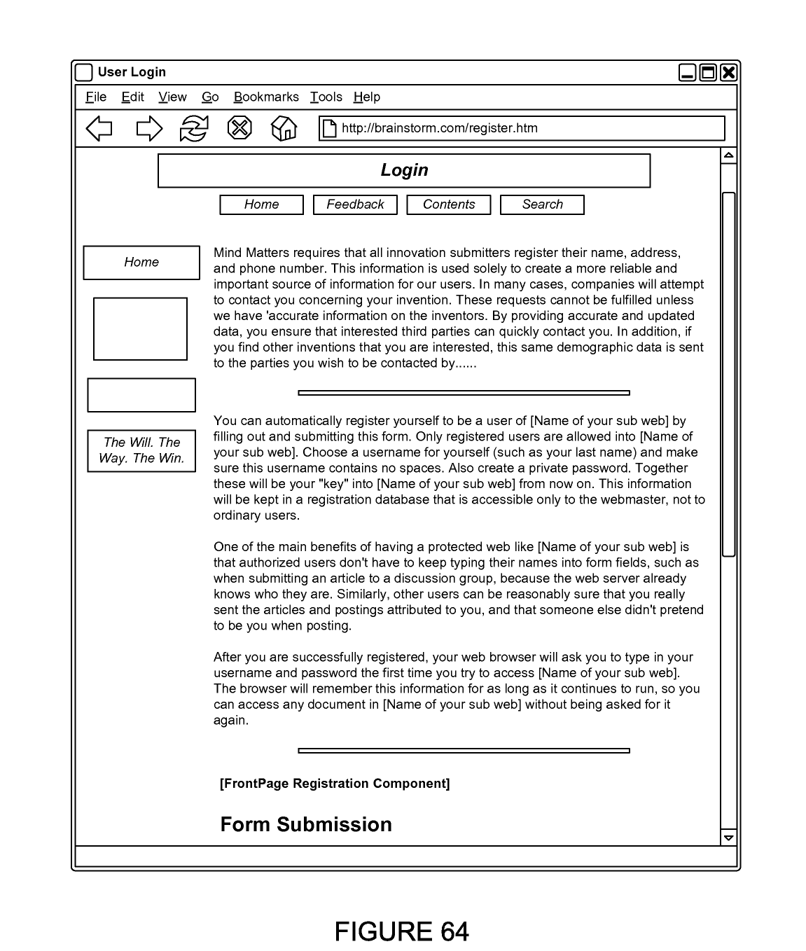

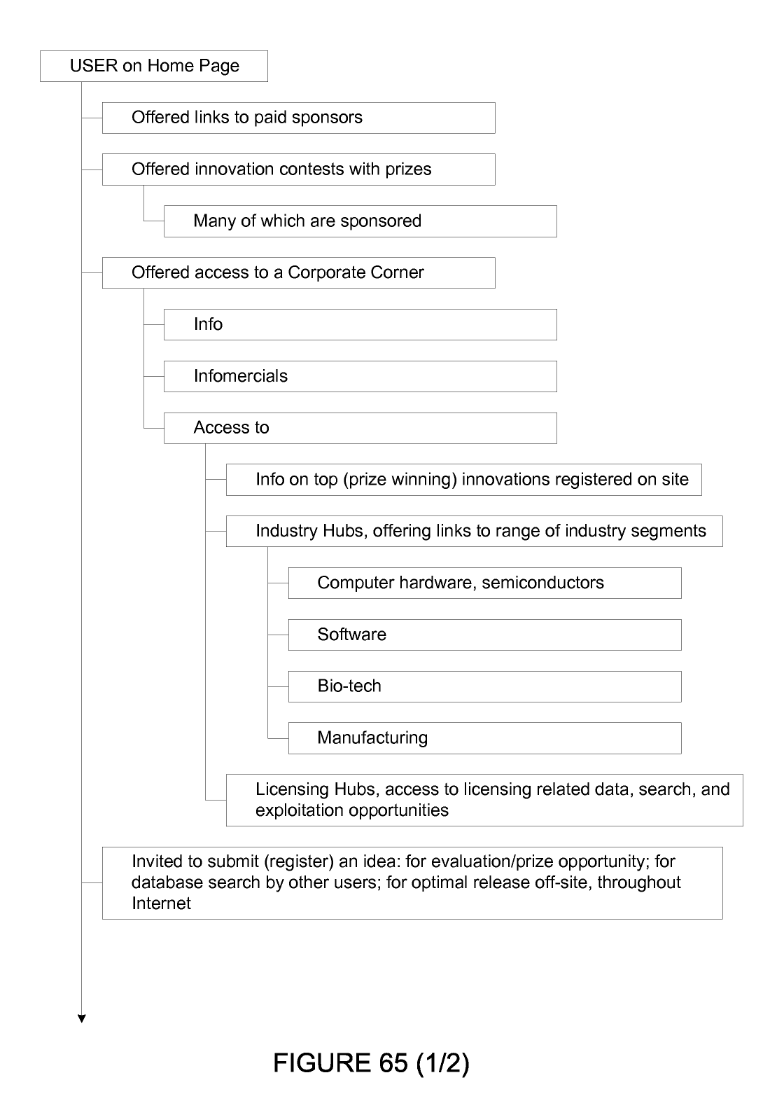

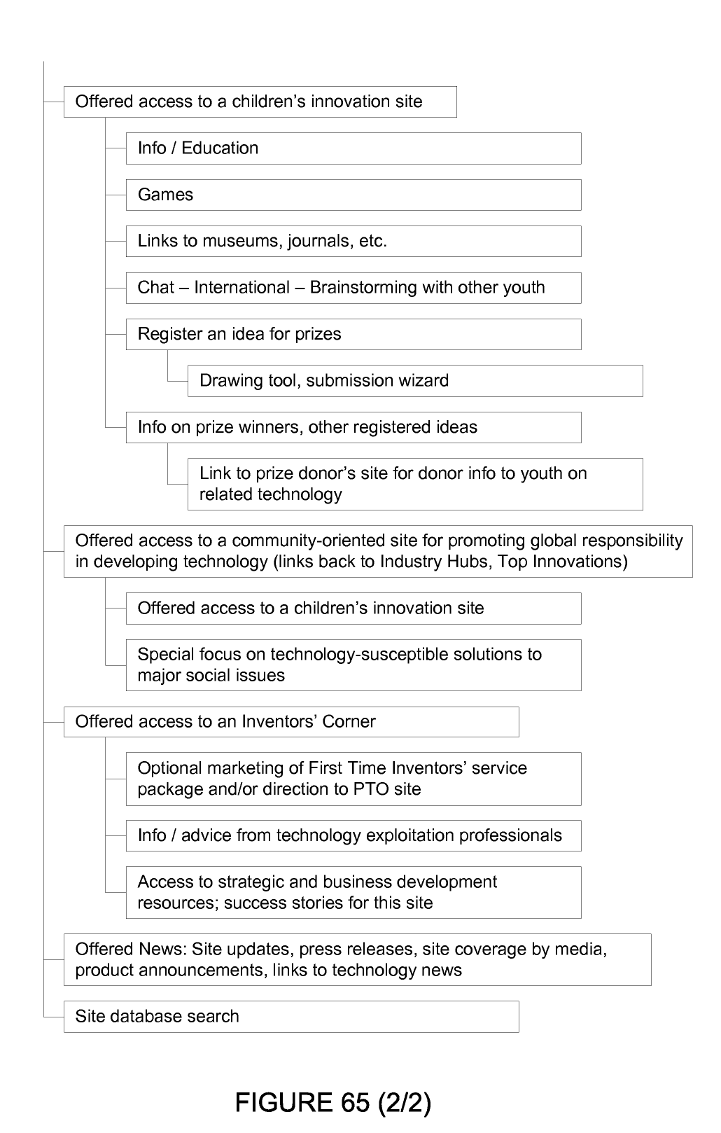

With respect to FIGS. 44-65, the drawings, containing as they do unusually large amounts of text compared to more conventional patent disclosures, constitute the preferred embodiment for carrying out the inventive intentions of this disclosure. It is presently believed that the means by which the various schemes herein disclosed, such as programming of web pages, back end databases, networking, internet programming, and the like are all well within the knowledge of those skilled in the computer and internet programming arts, and as such are not required to be recited in this disclosure.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A method of tracking an innovation, comprising:
determining one or more actions requested by a user with respect to stored information associated with the innovation;
determining an identification of the user; and
logging the one or more actions and the identification of the user.

2. The method of claim 1, wherein the one or more actions comprises accessing at least a portion of the stored information associated with the innovation.

3. The method of claim 1, wherein the one or more actions comprises viewing at least a portion of the stored information associated with the innovation.

4. The method of claim 1, wherein the one or more actions comprises printing at least a portion of the stored information associated with the innovation.

5. The method of claim 1, wherein the one or more actions comprises copying at least a portion of the stored information associated with the innovation.

6. The method of claim 1, wherein the one or more actions comprises modifying at least a portion of the stored information associated with the innovation.

7. The method of claim 1, wherein the one or more actions comprises downloading at least a portion of the stored information associated with the innovation.

8. The method of claim 1, wherein the one or more actions comprises a search.

9. The method of claim 1, wherein the stored information associated with the innovation comprises confidential information.

10. The method of claim 1, wherein the stored information associated with the innovation comprises a non-disclosure agreement.

11. The method of claim 1, wherein the tracking of the innovation is performed in real time.

12. A system for tracking an innovation, comprising a processor that executes instructions and thereby causes the processor to:
determine one or more actions requested by a user with respect to stored information associated with the innovation;
determine an identification of the user; and
log the one or more actions and the identification of the user.

13. The system of claim 12, wherein the one or more actions comprises accessing at least a portion of the stored information associated with the innovation.

14. The system of claim 12, wherein the one or more actions comprises viewing at least a portion of the stored information associated with the innovation.

15. The system of claim 12, wherein the one or more actions comprises printing at least a portion of the stored information associated with the innovation.

16. The system of claim 12, wherein the one or more actions comprises copying at least a portion of the stored information associated with the innovation.

17. The system of claim 12, wherein the one or more actions comprises modifying at least a portion of the stored information associated with the innovation.

18. The system of claim 12, wherein the one or more actions comprises downloading at least a portion of the stored information associated with the innovation.

19. The system of claim 12, wherein the one or more actions comprises a search.

20. The system of claim 12, wherein the stored information associated with the innovation comprises confidential information.

21. The system of claim 12, wherein the stored information associated with the innovation comprises a non-disclosure agreement.

22. A system for monitoring an innovation, comprising:
a database having stored information associated with the innovation; and
a processor to: perform an action requested by a user with respect to the stored information; determine an identity of the user; and create a record of the action and the identity of the user.

23. The system of claim 22, wherein the record comprises a date the action was performed.

24. The system of claim 22, wherein the processor is further to associate the record with the stored information.

25. A system for tracking an innovation, comprising:
means for determining one or more actions requested by a user with respect to stored information concerning the innovation;
means for determining an identification of the user; and
means for logging the one or more actions and the identification of the user.
